(19) United States
(12) Patent Application Publication
(10) Pub. No.: US 2022/0242622 A1
(43) Pub. Date: Aug. 4, 2022

(54) LID MEMBER AND ITS MANUFACTURING METHOD

(71) Applicant: KY7 INC., Tokyo (JP)

(72) Inventor: Akira TAKANO, Machida-shi (JP)

(73) Assignee: KY7 INC., Tokyo (JP)

(21) Appl. No.: 17/765,268

(22) PCT Filed: Aug. 17, 2020
(86) PCT No.: PCT/JP2020/031040

§ 371 Date: Mar. 30, 2022

(30) Foreign Application Priority Data
Nov. 1, 2019 (JP) 2019-200328
Nov. 8, 2019 (JP) 2019-203588
Nov. 22, 2019 (JP) 2019-211882
Nov. 25, 2019 (JP) 2019-212009
Jan. 10, 2020 (JP) 2020-012014
Jan. 31, 2020 (JP) 2020-025686
May 19, 2020 (JP) 2020-087772
Aug. 8, 2020 (JP) 2020-135463
Aug. 15, 2020 (JP) 2020-137162

(51) Int. Cl. B65D 43/16; A47K 10/42; B31D 1/00; B31D 5/02; B31D 5/04; B65D 83/08; B65D 65/46

(52) U.S. Cl. CPC B65D 43/162; A47K 10/421; B31D 1/005; A47K 2010/3266; B31D 5/04; B65D 83/0805; B65D 65/466; B31D 5/02

(57) ABSTRACT

A lid and substrate part made of pulp material are connected as one piece via hinge part and configured to be openable and closable, wherein the lid part is provided with a swell part and the substrate part is provided with a part for attaching to a package, a surrounding wall standing from the attaching part and a flange part formed between the surrounding wall and the outlet, wherein when the lid is closed the lid part contacts the flange part, when the closed lid state is maintained the swell part covers the surrounding wall in which a pressing force is applied to the flange part by the lid part, when retention of the closed lid state is removed, the pressing force by the lid part to the flange part is removed and a force to open the lid part is applied from the flange part onto the lid part.

### TECHNICAL FIELD

The invention relates to a lid member and its manufacturing method.

### BACKGROUND ART

Packages are conventionally known in which cleaning sheets such as wet sheets formed from substrate fabrics made of e.g. non-woven fabrics impregnated with chemical liquids are accommodated in e.g. a bag body or a box body. Generally, cleaning sheets are accommodated as a stack and are arranged so that they can be taken out of the opening part formed on e.g. the bag body. The opening part is normally closed by a lid member and is opened e.g. when the cleaning sheets are taken out.

As the lid member, for example, simple ones are known in which the opening part of the bag body etc. is opened and closed by a sealing member, as disclosed in the patent document 1 shown below. However, although the sealing member disclosed in the patent document 1 is made using a repeelable seal, it has a problem that its adhesion gradually becomes weaker as the sticking and the peeling are repeatedly performed, resulting in it adhering less to the bag body etc., leading to the lowering of the sealability. This sealing member also has a problem that, especially when it is used with a bag body, wrinkles tend to form around the opening part as the amount of the cleaning sheets accommodated in the bag body decreases, resulting in gaps forming between the sealing member and the bag body upon sticking the sealing member, making it difficult to maintain the sealability.

In order to solve such problems, recently, a lid member for a package made using a thermoplastic synthetic resin material such as polyethylene (PE) and polypropylene (PP), such as disclosed in patent document 2 shown below, is known. The lid member disclosed in patent document 2 is provided with a substrate part to be attached to the accommodated article, an opening part formed in the substrate part and a lid part to be opened and closed with respect to the substrate, wherein it is used by attaching to the package such that the opening part of the package and the opening part of the substrate part of the lid member are positioned at the same location. This lid member is constructed so that normally the lid part is closed and the lid part is openable when in use such as when taking out the cleaning sheets.

### CITATION LIST

### Patent Documents

Patent document 1: JP2016-016883
Patent document 2: JP utility model registration 3207763

### SUMMARY OF INVENTION

### Technical Problem

The lid member disclosed in the above-mentioned patent document 2 is made of plastic materials etc. and therefore has a problem that it is against the recent active efforts to address environmental issues. On the other hand, various biodegradable plastic materials are being developed which are said to be environmentally friendly, allowing to manufacture environmentally-friendly lid members by using the biodegradable plastic materials. However, biodegradable plastic materials are more expensive compared to the plastic materials conventionally used widely, and the increase in its used amount will lead to the increase in the manufacturing cost. Particularly, the lid member to be used for the above-mentioned packages etc. has an extremely large amount of circulation in the market. Thus, even when the increase in the manufacturing cost per piece of the lid member is small, the increase in the manufacturing cost for a large number of lid members will become enormous. Therefore, using expensive biodegradable plastic materials as lid members as means against environmental issues could not be regarded as realistic at this moment.

In order to solve these problems, using a paper material for the lid member can also be considered. However, unlike plastic materials, paper materials are difficult to shape freely, and thus have a problem that it is not easy to provide a lid member having a good sealability using paper materials at a low cost. In order to solve such problem, methods can be considered such as increasing the thickness of the paper, performing the shaping steps of the lid member in a plurality of steps, and joining separate members together. However, these methods have problems such as the structure of the lid member becoming complex leading to the increase in the raw material costs and the manufacturing costs, and the manufacturing steps increasing leading to a decrease in the manufacturing efficiency leading to the increase in the product costs.

The present invention has been made in view of these problems, and has as its objective to provide a lid member at a low cost in which paper materials are used, by which the sealability is sufficiently ensured when the lid is closed, which has a superior strength and is environmentally friendly, as well as to provide a manufacturing method of a lid member in which the manufacturing efficiency is increased while the quality of such lid member is maintained.

### Means of Solving the Problems

The inventor of the present application has made earnest investigation in view of the various problems of the prior art. As a consequence, it has been found that a lid member can be realized at low cost in which paper materials are used as the raw material in view of the environmental concerns, which has a good sealability like a lid member made of synthetic resin formed body, which has an excellent overall strength, whose shape does not easily change or decompose, and which has a good water resistance and a good chemical resistance.

Accordingly, the lid member according to the invention is summarized as:

(1) A lid member to be provided at an opening part of a package for preventing drying of contents accommodated in the package, characterized in that the lid member comprises a substrate part and a lid part configured to be openable and closable with respect to the substrate part, made of a paper material,

wherein the substrate part comprises
an attaching part for attaching to the package,
a standing wall standing from the attaching part and
an outlet comprising an opening surrounded by the standing wall, arranged for the contents to be taken out via the opening part,

wherein the lid part is configured such that, when the lid is closed, a contact part is formed between an inner wall of the lid part and an outer wall of the standing wall to close the outlet.

(2) A lid member to be provided at an opening part of a package for preventing drying of contents accommodated in the package, characterized in that the lid member comprises a substrate part and a lid part configured to be openable and closable with respect to the substrate part, made of a paper material,

wherein the substrate part comprises
an attaching part for attaching to the package,
a standing wall standing from the attaching part,
an outlet comprising an opening surrounded by the standing wall, located at a higher location than the opening part and
a part to be pressed positioned at an upper edge of the standing wall, arranged such that, when the lid is closed, the part to be pressed abuts against and is pressed by an inner surface of the lid part,

wherein when the lid is closed, the lid part is in contact with the part to be pressed, while the closed lid state is maintained, the lid part covers and closes the outlet while applying a pressing force onto the part to be pressed,

when the retention of the closed state is removed, the pressing force by the lid part to the part to be pressed is removed and a force to open the lid part is applied from the part to be pressed onto the lid part.

(3) The lid member according to (2), characterized in that a contact part is formed between an inner wall of the lid part and an outer wall of the standing wall, such that the lid part closes the outlet.

(4) The lid member according to (1) or (3), wherein the lid part comprises a swell part swelling outwardly from the lid part and

a contact part is formed between an inner surface of a side wall of the swell part and an outer surface of the standing wall, such that the lid part closes the outlet.

(5) The lid member according to (4), wherein the inner surface of the side wall of the swell part has a form which corresponds to the outer surface of the standing wall when the lid is closed.

(6) The lid member according to (4), wherein the standing wall and the side wall of the swell part are tapered towards the upper direction.

(7) The lid member according to (2), wherein the part to be pressed comprises a projecting part made of an upper end of the standing wall curved towards the outlet.

(8) The lid member according to (2), wherein the part to be pressed comprises a flange part projecting from an upper end part of the standing wall towards the outlet.

(9) The lid member according to (8), wherein the flange part is tilted.

(10) The lid member according to (4), wherein the swell part comprises a top wall connected to the standing side wall part and

the top wall is recessed from the peripheral part connected to the side wall part towards the inner direction.

(11) The lid member according to (1) or (2), comprising a closing means for maintaining the closed lid state between the lid part and the substrate part.

(12) The lid member according to (11), wherein the closing means is provided between an outer wall of the standing wall and an inner wall of the swell part.

(13) The lid member according to (1) or (3), comprising a closing means by a friction stress of the contact part between the lid part and the standing wall, for maintaining the closed lid state between the substrate part and the lid part.

The method for manufacturing the lid member according to the invention is summarized as:

(14) A method for manufacturing a lid member to be provided at an opening part of a package for preventing drying of contents accommodated in the package, comprising a substrate part and a lid part which is openable and closable with respect to the substrate part, made of a paper material, characterized in the process comprises:

step of punching, from a raw material comprising a paper material, a lid member forming body for making at least the lid part and the substrate part,

a pressing step of press-forming at least one of a lid part forming part which is to become the lid part and a substrate forming part which is to become the substrate part in the lid member,

wherein the pressing step involves deep draw forming the part of the lid member forming body located more inwardly than the peripheral part of the lid member forming body in a state in which the peripheral part of the lid member forming body is supported in a state in which it can be held but cannot be fixed.

(15) The method for manufacturing the lid member according to (14), wherein the lid member forming body comprises a hinge part forming body between the lid part forming part and the substrate forming part,

wherein the pressing step is performed after a folding part is formed in the hinge part forming body.

(16) The method for manufacturing the lid member according to (14), wherein the pressing step is performed after a moisturizing treatment is performed on the raw material.

(17) The method for manufacturing the lid member according to (14), wherein a closing means for maintaining a state in which the lid part is closed with respect to the substrate part is formed before the pressing step.

(18) The method for manufacturing the lid member according to (14), wherein after a lid member forming body provided with an opening as an outlet is formed, waterproofing treatment is performed on at least the edge part of the outlet of the lid member forming body in a state in which a plurality of said forming body are stacked.

### Effect of the Invention

In the lid member according to the invention, by the formation of a contact part between the outer wall of the standing wall standing from the attaching part of the substrate part and the inner wall of the lid part when the lid is closed, the sealability at the contact part between the standing wall and the inner wall of the lid part can be substantially increased, allowing to provide a lid member by which the closed lid state can be maintained with a high sealability when the lid is closed.

Also, the lid member according to the invention is configured such that the closed lid state is maintained while the lid part applies a pressing force onto the part to be pressed provided at the upper edge of the standing wall in the closed lid state, hence the sealability between the lid member and the substrate member while the closed lid state is maintained can be substantially increased, allowing to maintain the air tightness of the lid member and thus the air tightness of the package to which the lid member is attached. Further, when the retention of the closed lid state is removed, the lid part is subjected to a force from the part to be pressed in the direction of opening the lid. Thus the lid can be easily opened without having to perform a complex operation and its handling for opening the lid is improved.

Where it is desired that the user can open and close the lid part by one hand, the lid member according to the invention allows opening and closing of the lid part by an easy operation such as rotating the lid part in the lid closing direction by one hand. Therefore such lid members allow a sequence of actions of opening the lid part of the lid member attached to the package, taking out its contents and closing the lid part to be performed without stress, improving the user convenience. Also, the lid member according to the invention has a good sealability, and thus can prevent drying of the various contents such as for example wet sheets. Thus, the lid member according to the invention is provided which is a lid member made of environmentally friendly and low cost paper materials, which has a good sealability and can effectively prevent the drying of the accommodated contents, and which can reduce the nuisance of separating the package and the lid member at the time of disposal after use.

Also, according to the manufacturing method of the lid member according to the invention, an excellent lid member can be manufactured efficiently at low cost by press-forming.

### BRIEF DESCRIPTION OF DRAWINGS

FIG. 1 is an external perspective view showing an example of the first embodiment of the lid member according to the invention applied to a package.

FIG. 2 is an external perspective view of the lid member according to this embodiment.

FIG. 2(a) is an external perspective view of the lid member in its closed lid state and FIG. 2(b) is an external perspective view of the lid member in its open lid state.

FIG. 3 is an external view of the lid member according to this embodiment. FIG. 3(a) is a front view of the lid member and FIG. 3(b) is a side view of the lid member.

FIG. 4 is a sectional view of the lid member according to this embodiment in its closed lid state.

FIG. 5 is a sectional view of the lid member according to this embodiment in its open lid state.

FIG. 6 is an explanatory drawing to explain the manner of the non-wet treatment of the lid member according to this embodiment.

FIG. 7 is an explanatory drawing to explain the actions of the lid member according to this embodiment.

FIG. 8 is an explanatory drawing to explain the actions of the lid member according to this embodiment.

FIG. 9 is an explanatory drawing to explain the actions of the lid member according to this embodiment. FIG. 9(a) is a sectional view seen from the front side where the lid members are stacked and FIG. 9(b) is a sectional view seen from the side where the lid members are stacked.

FIG. 10 is an explanatory drawing to explain the first manufacturing method of the lid member according to the invention.

FIG. 11 is an explanatory drawing to explain the second manufacturing method of the lid member according to the invention.

FIG. 12 is an explanatory drawing to explain the third manufacturing method of the lid member according to the invention.

FIG. 13 is an explanatory drawing to explain the steps of deep draw forming the lid member forming body of the lid member according to the invention.

FIG. 14 is an explanatory drawing to explain the method for performing the anti-moisture treatment.

FIG. 15 is an explanatory drawing to explain the method for performing the non-wet treatment.

FIG. 16 is an explanatory drawing to explain the method for performing the non-wet treatment.

FIG. 17 is an explanatory drawing to explain the method for performing the non-wet treatment.

FIG. 18 is an explanatory drawing to explain the preferred embodiment of the lid member according to the invention.

FIG. 19 is an explanatory drawing to explain an alternative example of the flange part in the lid member according to the invention.

FIG. 20 is a sectional view showing a different embodiment of the lid member according to the invention.

FIG. 21 is an explanatory drawing showing the sectional view structure etc. of a further different embodiment of the lid member according to the invention.

FIG. 22 is a sectional view showing a further different embodiment of the lid member according to the invention.

FIG. 23 is an external perspective view showing a different embodiment of the lid member according to the invention, wherein FIG. 23(a) is a view showing its closed lid state and FIG. 23(b) is a view showing its open lid state.

FIG. 24 is a view of the lid member of the embodiment shown in FIG. 23, wherein FIG. 24(a) is a front view of the lid member and FIG. 24(b) is a side view of the lid member.

FIG. 25 is an external perspective view showing a different embodiment of the lid member according to the invention, wherein FIG. 25(a) is a view showing its closed lid state and FIG. 25(b) is a view showing its open lid state.

FIG. 26 is an explanatory drawing for explaining another embodiment of the closing means.

FIG. 27 is an explanatory drawing for explaining another embodiment of the closing means.

FIG. 28 is an explanatory drawing for explaining another embodiment of the closing means.

FIG. 29 is an explanatory drawing for explaining another embodiment of the closing means.

FIG. 30 is an explanatory drawing for explaining another embodiment of the closing means.

FIG. 31 is an explanatory drawing for explaining another embodiment of the closing means.

FIG. 32 is an explanatory drawing for explaining another embodiment of the closing means.

FIG. 33 is an explanatory drawing for explaining another embodiment of the closing means.

FIG. 34 is an explanatory drawing for explaining another embodiment of the closing means.

FIG. 35 is an explanatory drawing for explaining another embodiment of the closing means.

FIG. 36 is an explanatory drawing for explaining another embodiment of the closing means.

FIG. 37 is an explanatory drawing for explaining another embodiment of the closing means.

FIG. 38 is an explanatory drawing for explaining another embodiment of the closing means.

FIG. 39 is an explanatory drawing for explaining another embodiment of the closing means.

FIG. 40 is an explanatory drawing for explaining another embodiment of the closing means.

FIG. 41 is an explanatory drawing for explaining another embodiment of the closing means.

FIG. 42 is an explanatory drawing for explaining another embodiment of the closing means.

FIG. 43 is an explanatory drawing for explaining another embodiment of the closing means.

FIG. 44 is an explanatory drawing for explaining the method for making a locking part and a lock receiving part.

FIG. 45 is an explanatory drawing for explaining the method for making a locking part and a lock receiving part.

FIG. 46 is an explanatory drawing for explaining another embodiment of the closing means.

FIG. 47 is an explanatory drawing for explaining another embodiment of the closing means.

FIG. 48 is an explanatory drawing for explaining another embodiment of the closing means.

FIG. 49 is an explanatory drawing for explaining another embodiment of the closing means.

FIG. 50 is an explanatory drawing for explaining another embodiment of the closing means.

FIG. 51 is an explanatory drawing for explaining another embodiment of the closing means.

FIG. 52 is an explanatory drawing for explaining another embodiment of the closing means.

FIG. 53 is an explanatory drawing for explaining another embodiment of the closing means.

FIG. 54 is an explanatory drawing for explaining another embodiment of the closing means.

FIG. 55 is an explanatory drawing for explaining another embodiment of the closing means.

FIG. 56 is an explanatory drawing for explaining another embodiment of the closing means.

FIG. 57 is an explanatory drawing for explaining another embodiment of the closing means.

FIG. 58 is an explanatory drawing for explaining another embodiment of the closing means.

FIG. 59 is an explanatory drawing for explaining another embodiment of the closing means.

FIG. 60 is an explanatory drawing for explaining another embodiment of the closing means.

FIG. 61 is an explanatory drawing for explaining another embodiment of the closing means.

FIG. 62 is an explanatory drawing for explaining another embodiment of the closing means.

FIG. 63 is an explanatory drawing for explaining another embodiment of the closing means.

FIG. 64 is an explanatory drawing for explaining another embodiment of the closing means.

FIG. 65 is an explanatory drawing for explaining another embodiment of the closing means.

FIG. 66 is an explanatory drawing for explaining another embodiment of the closing means.

FIG. 67 is an explanatory drawing for explaining another embodiment of the closing means.

FIG. 68 is an explanatory drawing for explaining another embodiment of the lid member.

FIG. 69 is an explanatory drawing for explaining another embodiment of the lid member.

FIG. 70 is an explanatory drawing for explaining another embodiment of the lid member.

FIG. 71 is an explanatory drawing for explaining another embodiment of the lid member.

FIG. 72 is an explanatory drawing for explaining another embodiment of the lid member.

FIG. 73 is an explanatory drawing for explaining another embodiment of the lid member.

FIG. 74 is an explanatory drawing for explaining another embodiment of the lid member.

FIG. 75 is an explanatory drawing for explaining another embodiment of the lid member.

FIG. 76 is an explanatory drawing showing an example wherein the lid member according to the present invention is applied as a lid of a container.

### DESCRIPTION OF EMBODIMENTS

A first embodiment of the lid member according to the invention is explained in detail using drawings. It is noted that in the present specification, explanations are given using an example in which the subject to which the lid member is used is various packages, more in particular packages accommodating cleaning products such as cleaning sheets such as wet tissues, thus using an example in which the lid member according to the invention is applied to such package. However, the subject to which the lid member can be applied is not limited to such packages accommodating cleaning products. The contents of the package may be cleaning products and cleaning goods of the wet-type as mentioned above as well as the so-called dry type. The accommodating article for accommodating contents in a package may be a bag body or a box body or any other type as long as it can accommodate contents.

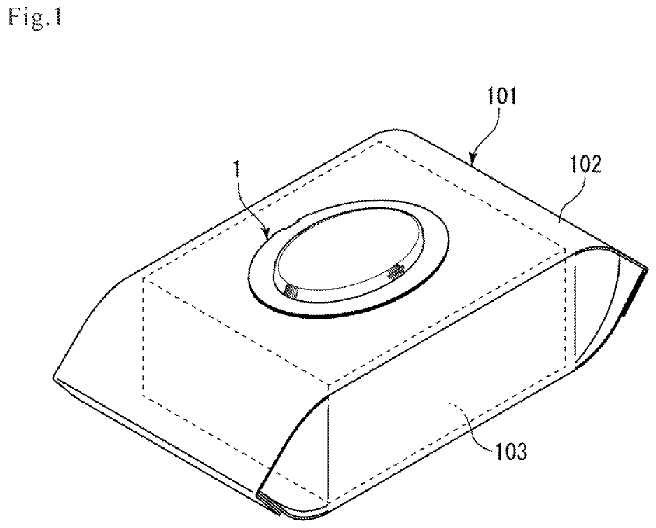

As shown in FIG. 1, the lid member 1 according to the invention is intended for e.g. preventing drying of the cleaning sheets (including a stacked body 103 in which a plurality of cleaning sheets are stacked) which are the contents accommodated in the package 101, and is provided joined to the opening part (not shown) of the package 101. As the method of joining, conventionally known joining methods can be freely applied such as joining by various adhesives such as hot melt; joining by heat sealing; ultrasonic bonding; high frequency bonding; low frequency bonding and joining by heat fusion.

The package 101 comprises a bag body 102 as the accommodating article and a stacked body 103, wherein the stacked body 103 is accommodated inside the bag body 102. The bag body 102 is provided with an opening part (not shown). The opening part is, before use, closed off by a seal body (not shown) made of a film or a sheet having an air tightness. It is opened when the user removes the seal body upon use. The bag body 102 is formed as a bag having a pillow shape wherein the edges of e.g. a plastic sheet or film having air tightness are sealed by e.g. heat sealing. The bag body 102 is made of air tight materials, and is made of e.g. a laminate having two layers structure of an inner layer and an outer layer. As the inner layer, for example, a laminate of one or more of polyethylene, polypropylene, polyester, polyamide, vinyl chloride, vinylidene chloride and cellophane, or a composite where an aluminum foil is further laminated to it, is used. As the outer layer, polyethylene terephthalate (PET) etc. is used. In the present specification, explanations are given using an example where the bag body 102 is constructed of 2 layers of an inner layer and an outer layer as mentioned above. However, the construction of the bag body 102 is not limited to those described above, and may be a multi-layer comprising three or more layers, or a mono layer consisting of only one layer. As the material used for the inner layer and the outer layer, it is not limited to those mentioned above, and other materials may be freely selected and used.

The stacked body 103 is made of a plurality of stacked cleaning sheets. The cleaning sheet is a sheet article made of a substrate fabric made e.g. of a non-woven fabric impregnated with chemical liquids etc. The stacking method and the folding method of the cleaning sheets as well as the stacking method for making the stacked body 103 using the cleaning sheets can be freely selected and applied from various known methods. The stacked body 103 may be the wet-type stacked body mentioned above as well as the dry-type stacked body where a substrate fabric is not impregnated with chemical liquids etc.

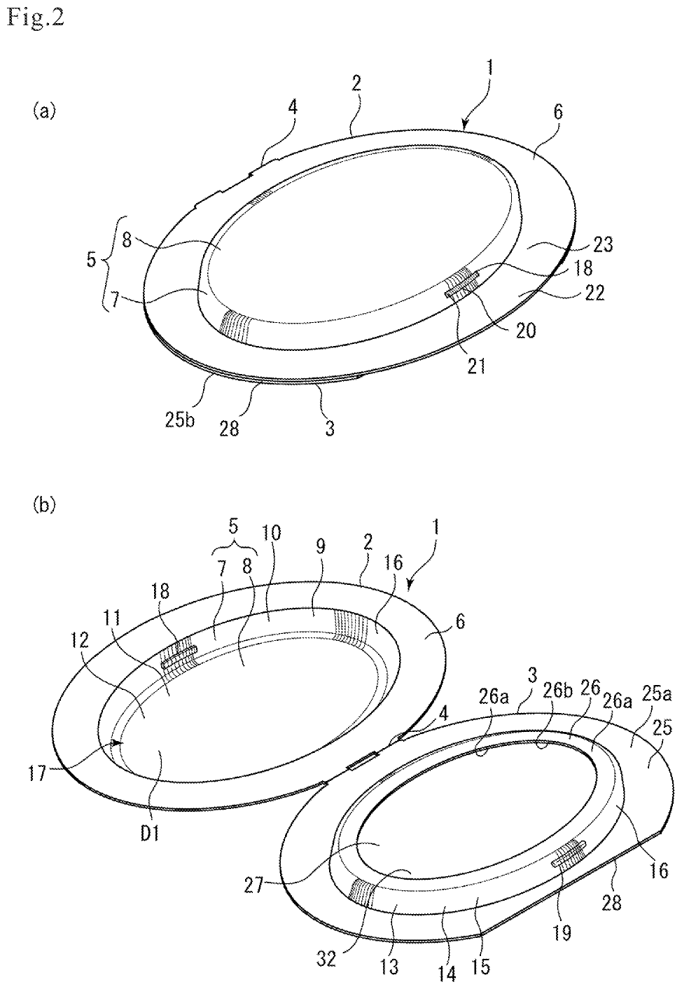

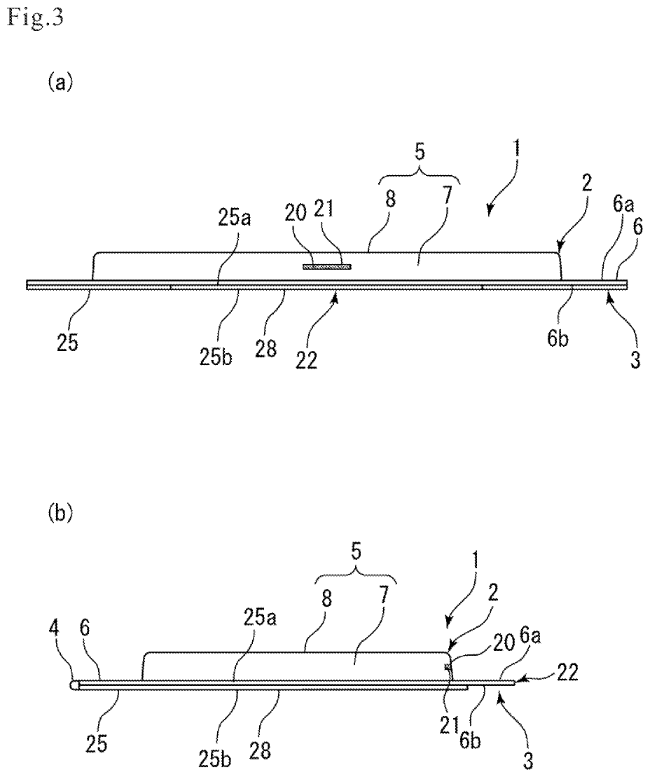

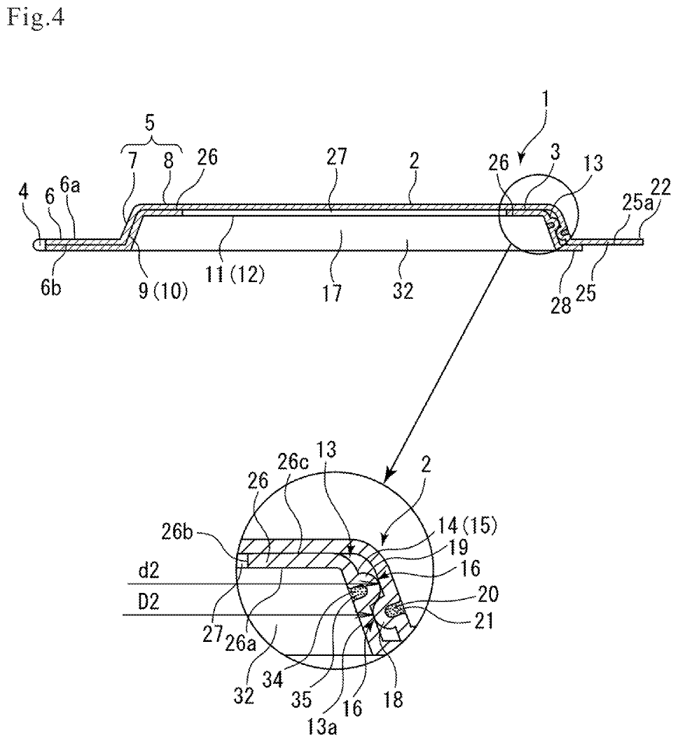

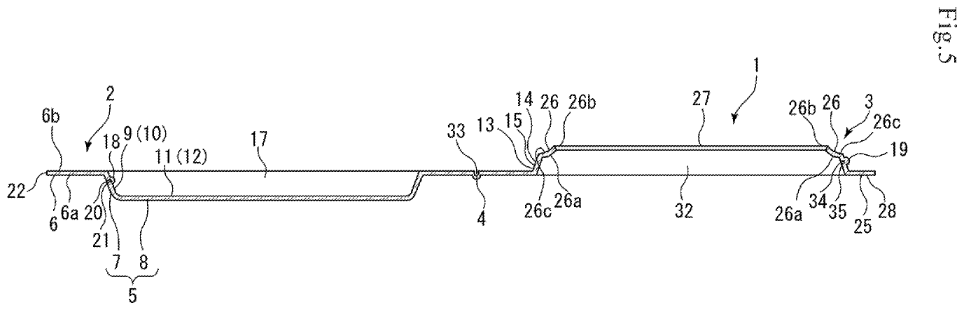

Next, the construction of the lid member 1 is explained based on FIG. 2 to FIG. 5. FIG. 2 is an external perspective view showing the outer appearance of the lid member 1 according to this embodiment. FIG. 2(a) shows the closed lid state and FIG. 2(b) shows the open lid state. FIG. 3 is an external view of the lid member 1. FIG. 3(a) is a front view of the lid member 1 and FIG. 3(b) is a side view of the lid member 1. FIG. 4 is a sectional view of the lid member 1 in its closed lid state and FIG. 5 is a sectional view of the lid member 1 in its open lid state.

The lid member 1 is provided with a lid part 2, a substate part 3 and a hinge part 4, wherein the lid part 2 and the substrate part 3 are connected as one piece via the hinge part 4, and is arranged to allow opening and closing of the lid. In FIG. 2, an example is shown in which these lid part 2, the substrate part 3 and the hinge part 4 are formed as one piece. However, the lid part 2 and the substrate part 3 as separate bodies may be connected into one piece via the hinge part 4. It is also possible that the hinge part 4 is formed as one piece with one of the lid part 2 and the substrate part 3, and this hinge part 4 is connected to the other one of the lid part 2 and the substrate part 3, so that the lid part 2 and the substrate part 3 are connected as one piece via the hinge part 4. Further, it is also possible that each of the lid part 2 and the substrate part 3 is formed as one piece with a hinge part forming part, wherein the hinge part forming part of the lid part 2 and the hinge part forming part of the substrate part 3 are joined to form the hinge part 4, and the lid part 2 and the substrate part 3 are connected in one piece via the hinge part 4. From the perspective of the ease of manufacture etc. of the lid member 1, it is preferable with the lid member 1 that the lid part 2, the substrate part 3 and the hinge part 4 are formed as one piece. As shown in FIG. 2 etc., the lid member 1 in the present specification has an oval shape and the explanations are given using this embodiment, but the shape of the lid member 1 is not limited to an oval shape, and may have other shapes such as a circular shape or a polygon or various other known shapes.

The lid member 1 of the present invention is made of a pulp material and can be obtained by forming the lid part 2, the substrate part 3 and the hinge part 4 from a pulp raw material as one piece. In the lid member 1 of the present invention, when the lid part 2 and the substrate part 3 as separate bodies are connected in one piece via the hinge part 4, not all of them has to be made of a pulp material. However in this case, it is preferable that at least the lid part 2 and the substrate part 3 are made of pulp materials.

The pulp material mainly comprises pulps such as wood pulp, non-wood pulp and old paper pulp, and preferably comprises 50% or more, more preferably 70% or more, even more preferably 80% or more of pulp, and particularly preferably is made of 100% of pulp. As the material aside from pulps in the pulp material, non-pulp natural fibers, synthetic fibers and recycled fibers can be listed. As the pulp material, a so-called paper obtained by making a net from a slurry of a pulp fiber material, drying or pressure drying it and making it into a sheet; a so-called pulp air laid obtained by stacking a spread fiber material such as a crushed pulp etc. by an air flow and fixing the stacked fibers by a binder; a stack made by stacking a plurality of these; as well as a composite material of a paper or a pulp airlaid and another material such as a resin material such as a film of a synthetic resin or a natural resin and a non-woven of a resin fiber, a metal material such as an aluminum foil or a wood material such as a wood foil. In the case of a composite material, it is preferred that it comprises at least 50% of pulp.

As the pulp for the pulp material, use can be made of coniferous pulps such as red pine, Sakhalin fir, yezo spruce, Douglas fir, hemlock, spruce, etc.; broadleaf pulps such as beech, oak, birch, eucalyptus, poplar, alder, etc.; wood pulps such as a mixture of coniferous pulps and broadleaf pulps; non-wood pulps such as kenaf, bagasse pulp, bamboo pulp, serial pulp, straw pulp, abaca pulp, cotton pulp; and waste paper pulp. The crushed pulp may be one that is obtained by crushing a raw material sheet made of pulp fibers by a crusher.

A paper material is made of an aggregation of many fibers. Coniferous pulps have a longer fiber length compared to broadleaf pulps also after crushing. Accordingly, a paper material using a crushed pulp obtained from coniferous pulps have an enhanced entanglement of the fibers and accordingly an increased strength. A paper material is made of fibers having a liquid permeability, preferably fibers having pulp paper or pulp as the main raw material. The fibers used in the paper material have a pulp content of preferably at least 50%. When the paper material is made of fibers having a pulp content of at least 50%, the overall flexibility of the paper material is increased and the production efficiency during manufacturing is increased. By choosing a high pulp content, the lid member made of the paper material becomes more easily degradable in water, soil or air, thereby reducing the environmental load and increasing environmental friendliness.

Regarding the pulp material for making the lid member 1, when the lid member 1 is made by stacking a plurality of layers, the thickness and the material etc. of each of the layers used may be the same or different. As the pulp material, it is preferred to use a cardboard having a weight per unit of 300 g/m² to 1000 g/m², preferably a cardboard having a weight per unit of 400 g/m² to 900 g/m². The paper material which is a paper type material used as the pulp type material may consist of one cardboard or a stack having the above weight per unit made by sticking together a plurality of cardboards each having a weight per unit of 200 g/m² to 500 g/m². When a cardboard is used as the pulp material, if the weight per unit of the cardboard is less than 300 g/m², it becomes difficult to have a sufficient rigidly and if the weight per unit of the cardboard is more than 1000 g/m², the cost of the raw material increases and the manufacturing cost increases. Additionally, when manufacturing the lid member 1, it becomes difficult to perform various processing on the cardboard such as opening holes and folding.

The lid member 1 may be made by punching or pressing etc. a pulp material. By pressing, the overall strength of the lid member 1 made of a pulp material can be obtained. When it is made by sticking together a plurality of thin paper materials and pressing them, the direction to which the paper fibers are oriented may be arranged to be in a direction generally along the in-plane direction, which further increases the strength of the paper material.

As the pulp material used for the lid member 1, it is preferred to use a waterproof paper such as a coated paper on which a coat layer has already been provided, or a pulp material on which a coat layer has been provided on one side or both sides, or a coated paper etc. on which a further coat layer has been provided on one side or both sides to further increase waterproofness. The coat layer for improving the waterproofness may be provided on one side of the pulp material. However, from the perspective of increasing the durability of the pulp material against liquid such as water and maintaining the strength and increasing the durability of the lid member 1 made from this material, it is preferred to provide the coat layer for improving the waterproofness on both sides.

The coat layer may e.g. be made by adhering a film or applying a coating agent. The film forming the coat layer may be a film made of e.g. polystyrene, olefin resins such as polyethylene and polypropylene, polyethylene terephthalate, polyurethane, polyvinyl chloride cyanoacrylate, epoxy resin, acrylic resin such as polyacrylic acid and polymethacrylic acid, nylon, polycarbonate; polycaprolactone, polyhydroxyalkanoate, polyhydroxybutyrate, polylactic acid and starch-based resins such as esterified starch, cellulose acetate, polyethylene succinate, polyvinyl alcohol, polyglycolic acid, chitosan/cellulose/starch, poly (hydroxybutyrate/hydroxyhexanoate), poly (butylene succinate/adipate), poly (butylene succinate/carbonate)), poly (ethylene terephthalate/succinate), poly (butylene adipate/terephthalate), poly (tetramethylene adipate/terephthalate) and other naturally degradable resins and mixtures of naturally degradable resins; mixtures of naturally degradable biomass resin and naturally degradable biomass resin; fluorine resin, silicone resin, ultraviolet curable resin, ethylene-vinyl acetate copolymer, ethylene-vinyl alcohol copolymer, ethylene-propylene copolymer, ethylene-propylene-butadiene copolymer, acrylic-styrene copolymer, styrene-butadiene copolymer, acrylonitrile-butadiene-styrene copolymer etc., a copolymer of the monomers constituting the above resins, natural resin, paraffin, gelatin, cellophane, polymethylpentene, etc. Among these, naturally degradable resin films made e.g. of naturally degradable resins, naturally degradable biomass resin and natural resins are preferred and those having a high hydrophobicity are more preferred.

The coating agent for forming a coat layer may be a coating agent comprising a solution or a dispersion of the above synthetic resins, naturally degradable resins, naturally degradable biomass resins, natural resins, and natural polymers such as pine tar, lacquer, amber, gelatin, casein, tortoiseshell, chitin, chitosan, oysters and gum; and various ink such as aqueous inks.

The method for applying the coating agent may be spray coat, roll coat (reverse roll coat, forward rotation roll coat, etc.), knife coat, die coat, slot orifice coat, air doctor coat, kiss coat, blade coat, cast coat, spin coat, extrusion coat, hot melt coat, offset coat etc. Flexographic coat, gravure coat, screen coat and offset coat are preferred, and gravure coat and flexographic coat are more preferred. When forming a coat layer by applying a coating agent, from the aspect of the waterproofness and recyclability of the lid member 1, the applied amount of the coating agent is preferably 2 g/m² to 30 g/m² and more preferably 4 g/m² to 20 g/m² in terms of a solid content.

The film for forming the coat layer may be a monolayer film or a multilayer film. Also as for the coating agent, it is possible to apply one type as well as apply 2 or more types over each other. For the film and the coating agent, it is preferred to use a biodegradable resin and a biodegradable resin mixture such as starch type resin and polylactic acid resin and, which reduces the environmental load. The use of poly(tetramethyleneadipate/terephthalate) etc. also results in biodegradability if its content is about 40%. The term “biodegradable” in the present specification is meant as degradable in air, in soil or in water by microorganisms, UV and climate change etc. By using those with biodegradability for the lid member 1, the environmental load can be substantially reduced. Particularly, since the lid member 1 has generally an extremely large amount of circulation in the market, making the lid member 1 by a biodegradable material substantially reduces the environmental load and the degree of contribution to environmental problems becomes enormous.

As shown in FIG. 2, the lid part 2 is configured to be openable and closeable with respect to the substrate part 3. This lid part 2 is provided with a swell part 5 and an outer circumference part 6, wherein the outer circumference part 6 is formed at the outer circumference of the swell part 5, surrounding the swell part 5. The swell part 5 and the outer circumference part 6 may be formed as one piece by press forming and fold forming the forming body for forming the lid member 1.

The swell part 5 comprises a side wall part 7 and a top cover part 8. The side wall part 7 and the top cover part 8 are formed as one piece together with the outer circumference part 6 when the lid part 2 is formed by press forming. The side wall part 7 has one end which is formed continuously with the outer circumference part 6 and another end which is formed continuously with the top cover part 8, and is configured to stand upwardly between the outer circumference part 6 and the top cover part 8. The side wall part 7 is tilted to be tapered upwardly such that its size (diameter) closer to the top cover part 8 located at an upper position is smaller than its size (diameter) closer to the outer circumference part 6 located at a lower position. For example, as shown in FIG. 2 etc., the side wall part 7 is tapered from the lower side close to the circumferential part 6 towards the upper part close to the top cover part 8. In FIG. 2 etc., the side wall part 7 is formed to be generally tapered, but the manner in which it is tapered is not limited to this. For example, the side wall part 7 may be formed such that it is curved from the lower part to the upper part and the overall side wall part 7 is tapered. It may also be formed stepwise so that the side wall part 7 is generally tapered from the lower part to the upper part. It can also be formed in different ways so that the side wall part 7 is generally tapered.

The side wall part 7 is not limited to it being tapered over its whole part. It can be formed such that only a part of the side wall part 7 is tapered from the lower part to the upper part, or the majority of the side wall part 7 is tapered from the lower part to the upper part and only a part of the side wall part 7 is not tapered. Further, when the side wall part 7 is tapered as described above, the taper angle does not have to be a constant angle from the lower part to the upper part. The taper angle may be freely changed at predetermined locations between the lower part to the upper part. It may also be formed to have a shape other than these.

The top cover part 8 is a lid-like member formed at the upper edge of the side wall part 7. As described above, the top cover part 8 is preferably formed as one piece with the side wall part 7 by press forming etc., but it may be formed as a separate body from the side wall member 7. As shown in FIG. 2, in this embodiment, the top cover 8 has a planar shape.

In the swell part 5, the side wall part 7 comprises an inner wall surface 10 at the inner wall 9 constituting the inner wall of the side wall part 7 (hereinafter, reference to the inner wall 9 includes reference to the inner wall surface 10). The swell part 5 is formed such that the top wall 11 connected to the side wall part 7 constitutes the inner wall of the top cover 8, wherein the top wall 11 comprises a top surface 12. The inner wall 9 is configured so that it can, when the lid is closed, contact the outer wall 14 and the outer wall surface 15 of the surrounding wall 13 provided in the substrate part 3. It is noted that the contact between the inner wall 9 (inner wall surface 10) and the outer surface 14 (outer wall surface 15) includes situations where the inner wall surface 10 and the outer wall surface 15 are in a total contact as well as situations where the inner wall 9 and the outer wall 14 are in a partial contact. Herein, the inner wall 9 and the outer wall 14 being “in a total contact” means that the inner wall surface 10 of the inner wall 9 and the outer wall surface 15 of the outer wall 14 are totally in a plane contact. The inner wall 9 and the outer wall 14 being “in a partial contact” means that the inner wall 9 and the outer wall 14 are not totally in a plane contact but the inner wall 9 and the outer wall 14 are in a partial contact with each other. It is noted that there are various manners of the partial contact, for example a manner in which the inner wall 9 and the outer wall 14 are partially in a plane contact, a line contact or a point contact, a manner in which the contact is made by protrusions from the inner wall 9 and the outer wall 14 (for example the first protrusion part 18 and the second protrusion part 19 as shown in FIG. 2 etc.), and other manners.

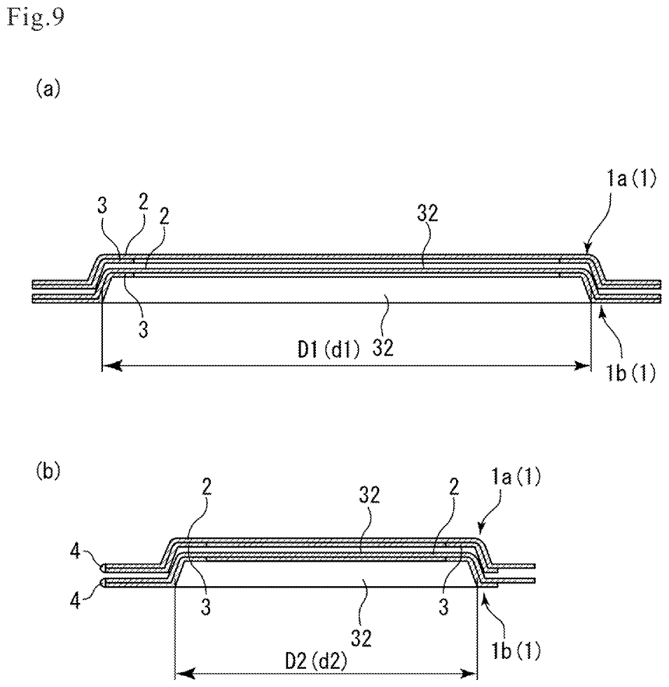

As shown in FIG. 2 etc., the inner wall 9 of the swell part 5 of the lid part 2 and the outer wall 14 of the surrounding wall 13 of the substrate part 3 are formed to have similar shapes such that the inner wall 9 goes along the outer wall 14, wherein when the lid part 2 is closed with respect to the substrate part 3, the inner wall 9 of the swell part 5 fits on the outer wall 14 of the surrounding wall 13. In other words, as shown in FIG. 9 (a) and FIG. 9 (b), at a location in the swell part 5 and the surrounding wall 13 of a given height in the height direction, wherein the inner diameter of the major axis of the inner wall 9 of the swell part 5 is termed D1 and the inner diameter of the minor axis of the inner wall 9 of the swell part 5 is termed D2 and the inner diameter of the major axis of the outer wall 14 of the surrounding wall 13 is termed d1 and the inner diameter of the minor axis of the inner wall 9 of the swell part 5 is termed d2, it is preferable that the relationship between D1 (or D2) and d1 (or d2) is substantially the same or D1 (or D2) is larger than d1 (or d2) (i.e. D1>d1 (in case of D2 and d2, D2>d2). Then the inner wall 9 of the swell part 5 and the outer wall of the surrounding wall 13 would contact each other closely and increase the sealability. From the perspective of improving the sealability between the lid part 2 and the substrate part 3 when the lid is closed, it is preferable that the above-described relationship between D1 and d1 and D2 and d2 is D1=d1 and D2=d2, i.e. D1 and d1 are equal and D2 and d2 are equal. By arranging the relationship between the inner wall 9 of the swell part 5 and the outer wall 14 of the surrounding wall 13 as described above, a contact part 16 is formed between the inner wall 9 of the swell part 5 and the outer wall 14 of the surrounding wall 13 so that they can have a total contact. This allows the lid part 2 to close the outlet 27, and improves the sealability of the lid part 2 and the substrate part 3, i.e. the sealability of the lid member 1 in the closed lid state. It is noted that also when the inner wall 9 and the outer wall 14 are in a partial contact, the inner wall 9 and the outer wall 14 are in contact in a state having a sealability and thus the sealability between the lid part 2 and the substrate part 3, i.e. the sealability of the lid member 1 in the closed lid state, is improved.

Like in the lid member 1 shown in FIG. 2 to FIG. 5, when the inner wall 9 and the outer wall 14 in the lid part 2 and the substrate part 3 are in a partial contact, D2 is the dimension up to the protruded edge where the first protrusion part 18 protrudes inwardly in the lid part 2 and d2 is the dimension up to the protruded edge where the second protrusion part 19 protrudes outwardly in the lid part 3. D2 and d2 are arranged such that d2≤D2. Thus, also when the inner wall 9 of the lid member 2 and the outer wall 14 of the substrate 3 are in a partial contact, the sealability when the lid is closed is improved.

In the lid part 2, in the part surrounded by the inner wall surface 10 and the top surface 12, a space 17 is formed in which the surrounding wall 13 of the substrate part 3 is accommodated in the closed lid state, as shown in FIG. 4. The size of the space 17 may be selected freely as long as it can accommodate the surrounding wall 13 of the substrate 3 in the closed lid state. However, it is preferable from the perspective of improving the sealability in the closed lid state that the volume of the space 17 has a size that can enclose the surrounding wall 13 in the closed lid state, and it is preferable to configure the contact area of the inner wall 9 and the outer wall 14 to be large in this state.

Regarding the inner wall 9 of the swell part 5 of the lid part 2, preferably the overlapping part which overlaps with the outer wall 14 of the surrounding wall 13 is applied with a coating agent having water resistance and is subjected to measures for increasing friction force. The measures for increasing friction force may be a measure which can increase the friction force occurring between the inner wall 9 and the inner wall 14 upon closing the lid at least at the overlapping part of the inner wall 9 and the outer wall 14. For example, this may be done by arranging at least one of the inner wall surface 10 of the inner wall 9 and the outer wall surface 15 of the outer wall 14 to be a non-glossy surface by forming micro roughness on its surface etc. In this case, by arranging at least one of the inner wall surface 10 and the outer wall surface 15 to be a non-glossy surface, the friction resistance between the inner wall surface 10 and the outer wall surface 15 can be increased, thereby further increasing the sealability of the lid member 2 when the lid is closed.

Making a non-glossy surface as the friction increasing measure is preferably applied to the whole of the lid member 1. However, it is preferred that at least one of the swell part 5 of the lid member 2 and the surrounding wall 13 of the substrate 3 is a non-glossy surface. Also, it is preferred that in the swell part 5 and the surrounding wall 13, at least the outer wall part 15 of the outer wall 14 of the surrounding wall 13 and the inner wall surface 10 of the inner wall 9 of the side wall part 7 of the swell part 5 are a non-glossy surface. Also, it is preferred that in the swell part 5 and the surrounding wall 13, at least one of the inner wall surface 10 of the inner wall 9 and the outer wall part 15 of the outer wall 14 is a non-glossy surface.

The part of the inner wall 9 of the side wall part 7 opposing the hinge part 4 of the lid part 2 is provided with a first protrusion part 18 which is a closing means for maintaining the closed lid state, and the surrounding wall 13 of the substrate part 3 is provided with a second protrusion part 19 which can engage with the first protrusion part 18. The first protrusion part 18 is provided at a location where it can engage vertically with the second protrusion part 19 in the closed lid state to maintain the closed lid state by the lid part 2. In the side wall part 7, a first recess part 20 is provided at the location of the outer wall surface corresponding to the first protrusion part 18. In the first recess 20, a reinforcement material 21 is provided by methods such as application, and by providing such reinforcement material 21, the strength and the durability of the first protrusion part 18 against the repeated opening and closing is improved. As the reinforcement material 21, known ones may be freely used, for example an adhesive using a thermosetting resin material or a thermoplastic resin material. As the reinforcement material 21, it is preferred to use hot melt adhesive etc. from the viewpoint of increasing the strength of the first protrusion part 18, increasing durability for repeated opening and closing and lowering the manufacturing costs. For the reinforcement material 21, it is preferred to add fillers to the various adhesives mentioned above for increasing the strength of the first protrusion part 18 and the second protrusion part 19. Fillers may be selected from known ones, in particular those that are about 100 μm to 10 nm which may be spherical, needle-shaped, fiberous, platelike, amorphous-shaped may be used. Fillers may e.g. be calcium carbonate, magnesium oxide, calcium oxide, talc, silica, clay, titanium oxide, zinc oxide, iron oxide, potassium titanate, mica, glass beads, zeolite, activated clay, alumina, aluminum powder, iron powder, glass balloon, shirasu balloon, carbon black, etc.

The outer circumference part 6 is formed to surround the swell part 5 at the outer circumference of the side wall part 7 of the swell part 5. The outer circumference part 6 is formed as a flange extending outwardly with respect to the swell part 5, and is formed to be able to maintain the overall strength of the lid part 2 and improve the sealabilty by abutting against the attaching part 25 of the substrate 3 in the closed lid state. The length of the outward extension of the outer circumference part 6 may be freely selected. The outer circumference part 6 is formed together with the swell part 5 when the lid part 2 is subjected to press forming or deep draw forming such as deep draw press forming. As shown in FIG. 2 etc., the outer circumference part 6 is formed to be continuous with the hinge part 4 and is provided with a holding part 22 for opening and closing the lid member 2 at the location opposite to the part continuous with the hinge part 4.

The substrate part 3 is formed as one piece with the lid part 2 via the hinge part 4, and the lid part 2 is configured to be opened and closed from upwards. The substrate part 3 is provided with the attaching part 25 for attaching to the package 101; the surrounding wall 13 standing from the attaching part 25; and the flange part 26 formed as a part to be pressed and the outlet 27 at a location higher than the attaching part 25 and higher than the surrounding wall 13. The upper side 25a of the attaching part 25 is arranged such that it opposes the back side 6b of the outer circumference part 6 of the lid part 2 in the closed lid state. The lower side of the attaching part 25 is the attaching side 28 to attach to the bag body 102.

The surrounding wall 13 and the flange part 26 may be formed as one piece with the attaching part 25 by deep draw forming or press forming etc. The surrounding wall 13 is formed so that its size closer to the flange part 26 located in an upper part is smaller than its size closer to the attaching part 25 located in a lower part. For example, as shown in FIG. 2 etc., the surrounding wall 13 is tapered from the lower part closer to the attaching part 25 towards the upper part closer to the flange part 26. The surrounding wall 13 is not limited to a straight taper shape but may be a curved taper shape. The surrounding wall 13 may be formed to be tapered in a stepwise-manner. The tapered shape of the surrounding wall 13 may be freely selected. The surrounding wall 13 may be generally tapered while having a shape different from those above. The surrounding wall 13 may be partly tapered.

It is preferred that the outlet 27 is formed as an opening at the upper end of the surrounding wall 13 as shown in the present embodiment from the viewpoint of ensuring a large volume of the accommodating part 32 formed at the location surrounded by the inner side wall 13a of the surrounding wall 13 and the back side 26a of the flange part 26. Since the flange part 26 projects towards the outlet 27, the overall strength around the outlet 27 can be improved by the surrounding wall 13 and the flange 26; the substrate part 3 is less easy to deform when the contents such as wet sheets in the bag body 102 are taken out; and when the lid part 2 is repeatedly opened and closed, the sealability between the flange part 26 and the top wall 11 and the sealability between the outer wall 14 of the surrounding wall 13 and the inner wall 9 of the swell part 5 are maintained in the closed lid state.

Regarding the flange part 26, it is preferred that the inner circumference 26b of the flange part 26 has been subjected to anti-moisture treatment. By the anti-moisture treatment, it can be prevented that the chemical liquid and the chemical agent etc. in the cleaning sheet etc. go inside the paper material from the inner circumference 26b etc. of the flange part 26 and soften the paper material and make it more breakable, allowing it to have a durability to withstand a repeated use for a long period of time.

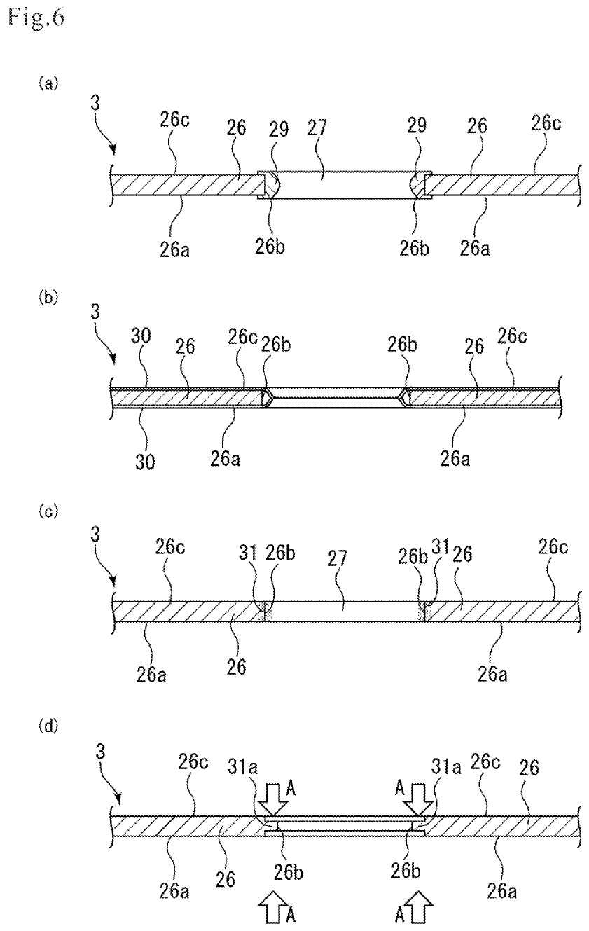

As the anti-moisturization treatment, for example, as shown in FIG. 6(a), a protecting member 29 may be provided so as to cover the whole circumference of the inner circumference 26b of the flange part 26. As shown in FIG. 6(b), the inner circumference 26b of the flange part 26 can also be protected by laminating a film member 30 on at least one side of the flange part 26 (in FIG. 6(b), both the front side 26c and the back side 26a of the flange part 26), and joining these film member 30 at a position more inward than the inner circumference 26b. Thereby the inner circumference 26b of the flange part 26 can be protected. Also, as shown in FIG. 6(c), the inner circumference 26b of the flange part 26 may be applied with a coating agent 31 to be impregnated thereby or coated by a coating agent 31. As shown in FIG. 6(d), the inner circumference 26b of the flange part 26 may be compressed from the A direction of FIG. 6(d) to form a compressed part 31a, increasing the fiber density of the paper material of the inner circumference 26b so that it will be more difficult for the chemical liquid and other liquids to be impregnated therein. Among these, the coating treatment by a coating agent 31 is preferred as the anti-moisture treatment can be performed at a low cost. The film member and the coating agent used in the anti-moisture treatment as mentioned above may be the same as those used for making a coating layer on the paper material.

As shown in FIG. 6, when the inner circumference 26b is subjected to an anti-moisture treatment, this can be done not only by providing the protecting member 29 and the film member 30 etc. inside the inner circumference 26b or impregnating the inner circumference 26b of the flange part 26 with a coating agent, but also by forming a film to be positioned inside the inner circumference 26b to surround the overall inner circumference 26b. When the friction force between the inner circumference 26b and the cleaning sheet is increased by so performing the anti-moisture treatment, when the content such as the cleaning sheets is taken out, it can be taken out while a part of the cleaning sheet contacts it, generating a resistance force in the opposite direction from the direction to which the cleaning sheet is taken out. Accordingly, it is easy for the user to insert the finger and hold the cleaning sheet, the cleaning sheet is given a resistance force effective when the user takes out the cleaning sheet and the cleaning sheets accommodated in the bag body 102 as a stacked body 103 can be taken out separately. The above described manners regarding the inner circumference 26b of the outlet 27 may be used alone or in combination. For example, a compressed part 31a may be formed as well as a coating agent may be applied, or other manners may be combined.

As shown in FIG. 5, the flange part 26 extends diagonally upwardly from the edge of the surrounding wall 13 in the direction towards the outlet 27. It contacts the top wall 12 of the lid part 2 when the lid is closed, and when the closed lid state is maintained, the state is maintained in which the pressuring force is applied by the lid member 2. When the retention of the closed lid state of the lid member 2 is removed, the flange part 26 applies a force for restoring the flange part 26 which has been pressed to the state before it was pressed, in the direction for opening the lid part 2.

The accommodating part 32 can be used as a space for already positioning a part of the cleaning sheets accommodated in the bag body 102 (for example the tip of the cleaning sheet to be taken out next) close to the outlet 27. The presence of the accommodating part 32 allows easy closing of the lid without having to move the edge of the remaining sheet taken out from the package 101 back to the inside of the package, and makes it easy to take out the cleaning sheet when using it next time.

The hinge part 4 is formed between the lid part 2 and the substrate part 3 as one piece. A folding part 33 is formed in the hinge part 4, and the lid member 1 may be folded at the folding part 33. In other words, the lid part 2 can open and close with respect to the substrate part 3 with the folding part 33 being the fulcrum. The size and the shape of the hinge part 4 may be freely determined, and the manner in which the folding part 33 is formed may be freely selected from known methods such as press forming. In FIG. 2 etc., an opening is formed at the location of the hinge part 4 at which the folding part 33 is formed. However, whether to form such an opening and the size and the shape of the opening when forming such an opening may be freely determined.

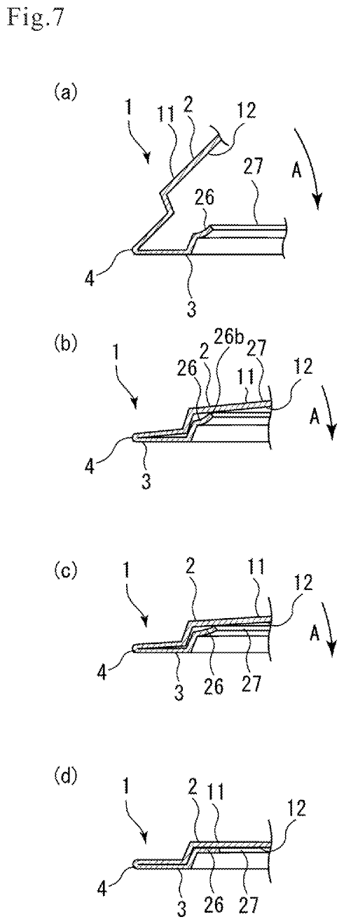

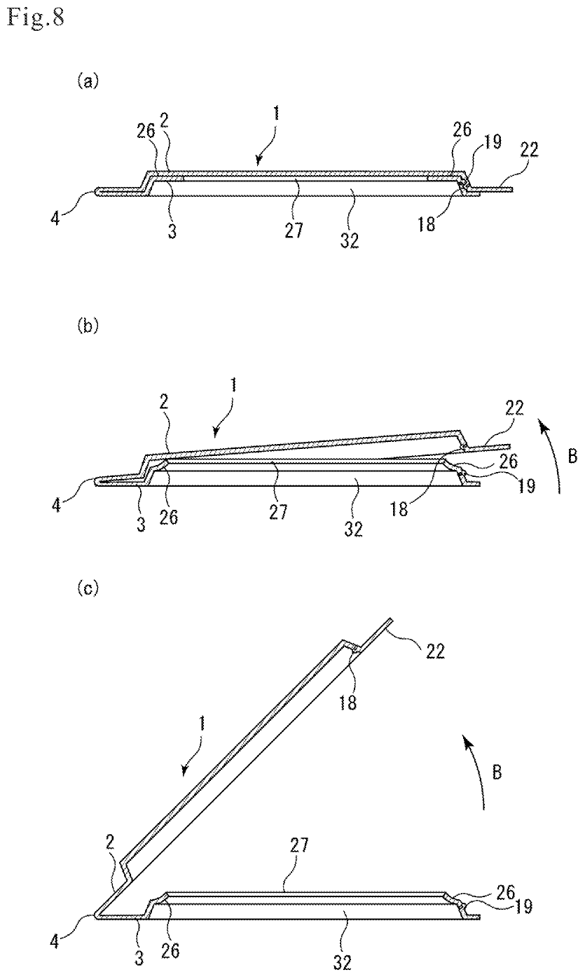

Next, the actions of the lid member 1 of the present invention are explained. First, the actions of the lid member 1 in the opening and closing actions are explained based on FIG. 7 and FIG. 8. FIG. 7(a) shows the state in which the lid member 2 is open and the outlet 27 is in an open state. The user can insert his fingers in the outlet 27 and grab a part of the cleaning sheet (not shown) to take it out of the bag body 102.

Next, when the user rotates the lid part 2 in the closing direction (direction A in FIG. 7(a)), in the direction that the lid part 2 closes with the hinge part 4 as the fulcrum, the inner side (top surface 12) of the top wall 11 of the lid part 2 abuts against the flange part 26. When the user rotates the lid part 2 further in the closing direction (direction A in FIG. 7(b)), the flange part 26 abutting against the top surface 12 as shown in FIGS. 7(b), (c) is gradually pressed and results in a closed lid state as shown in FIG. 7(d). In this state, a restoration force is applied to the flange part 26 for restoring its original shape in the open lid state, in the direction of pushing up the top surface 12. Accordingly, while the closed lid state is maintained by the engagement between the first protrusion part 18 and the second protrusion part 19, the state is maintained wherein the repulsion force from the flange part 26 to the top surface 12 against the pressing is maintained, thereby increasing the adhesion between the inner surface of the lid part and the flange part 26, increasing the sealability.

When it is in the closed lid state in this manner, the back side of the lid part 2 and/or the front side of the substrate part 3, in particular the inner surface 10 of the inner wall 9 of the swell part 5 of the lid part 2 and the outer wall surface 15 of the surrounding wall 13 of the substrate part 3, may be made into a non-glossy surface, thereby increasing the friction between the lid part 2 and the substrate part 3 in its closed lid state. Accordingly, the sealability of the lid part 2 and the substrate part 3 when the lid member 1 is in the closed state may be further increased. Accordingly, in the package 101 to which the lid member 1 of the present invention is attached, even after the opening part of the bag body 102 is opened, when the lid member 1 is in the closed lid state, the drying of the cleaning sheets by the evaporation of the chemical liquids etc. impregnated in the cleaning sheets inside the bag body 102 can be substantially reduced, allowing to keep the cleaning sheets for use for a long period of time.

Further, the lid part 1 has an increased sealability with time after manufacturing. The reason for this is to be considered to be that the water originally contained in the paper material forming the lid member 1 expands inside and the paper material expands, increasing the adhesion between the swell part 5 of the lid member 2 and the surrounding wall 13 of the substrate part 3. Accordingly, it becomes possible to accommodate the cleaning sheets in a good state in the bag body 102 to be used by the user for a long period of time.

As shown also in FIG. 7, by pressing the lid part 2 in the A direction of FIG. 7 when the lid is open, the lid member 1 can be closed and this closed lid state may be maintained. The lid member 1 is arranged so that the closed lid state can be maintained by the engagement of the first protrusion part 18 and the second protrusion part 19. Accordingly, the user can close the lid by a one-touch operation using one hand.

Next, the actions of opening the lid part 2 maintaining the closed lid state of the lid member 1 is explained based on FIG. 8. As shown in FIG. 8(a), when the lid member 1 maintains the closed lid state, the flange part 26 is pressed by the lid part 2 and a force is applied to restore against the pressing force, which results in the flange part 26 closely abutting against the top surface 12. Accordingly, the air tightness of the lid member 1 is kept well.

Here, when the user holds the holding part 22 and releases the engagement of the first extrusion 18 and the second extrusion 19, the lid part 2 is pressed in the B direction in FIG. 8(b) by the restoring force of the flange part 26, thereby rotating in the lid opening direction with the hinge part 4 as the fulcrum. In this state, the flange part 26 is in the state before the pressing force is applied. The lid part 2 rotates in the open lid direction until this location by the restoring force of the flange part 26. Subsequently, the user can hold the holding part 22 and further rotate the lid part 2 in the B direction in FIG. 8(c) to open the lid until the state where the cleaning sheet can be easily taken out from the outlet 27.

Accordingly, with the lid member 1, the lid part 2 in the closed lid state can be brought to the open state just by releasing the engagement of the first protrusion part 18 and the second protrusion part 19, so according to the lid member 1, the lid opening action can be performed without hassle and stress.

Normally, in the lid member 1, before the stacked body 103 accommodated in the bag body 102 is used up, the opening and closing actions shown in FIGS. 7(a) to 7(d) and FIGS. 8(a) to 8(c) are repeatedly performed. The first recess part 20 corresponding to the first protrusion part 18 is reinforced by the reinforcing member 21 and the second recess part 21 corresponding to the second protrusion part 19 is reinforced by the reinforcing member 35. Accordingly, the repeated opening and closing actions do not break the first protrusion part 18 and the second protrusion part 19 and the engagement does not become weaker, allowing to maintain the good sealability for a long period of time, allowing to easily use the cleaning sheets accommodated in the bag body 102 until the end.

As described above, the lid member 1 is made by a paper material. Accordingly, this lid member 1 can greatly contribute also from the perspective of the measures and considerations for the environmental problems which have become of interest especially in recent years, and its recyclability is excellent so that it can reduce the cumbersomeness and trouble felt by the user upon discarding it.

When the bag body 102 to which the lid member 1 is attached is made of plastic sheets and films etc., the bag body 102 easily gets wrinkled as the cleaning sheets accommodated in the bag body 102 decrease. However, by already joining the lid member 1 according to the invention to the bag body 102, the ease of taking out the cleaning sheet and the sealability of the bag body 102 can be maintained at their initial states even when the remainder of the accommodated cleaning sheets becomes less.

Since the surrounding wall 13 and the side wall 7 of the swell part 5 are tapered in this lid member 1, as shown in FIG. 9, a plurality of the members can be stored and transported by stacking them in the vertical direction, substantially increasing the stackability during transportation and storage. As shown in FIGS. 9(a) and 9(b), when stacking a plurality of the lid members 1, the swell part 5 of another lid member 1b goes into the space in which the accommodating part 32 of the lid member 1a is formed, and the swell part 5 of another lid member (not shown in FIG. 9) goes into the space in which the accommodating part 32 of this lid member 1b is formed and so on, thus allowing a plurality of lid members 1 to be stacked in a small space. In this case, since the side wall 7 of the swell part 5 and the side wall of the surrounding wall 13 are tapered, the height of the stack made by stacking a plurality of lid members 1 is approximately equal to the sum of the height of the swell part 5 at the top and the paper thicknesses of the lid parts 2 and the paper thicknesses of the substrate parts 3 of the lid members 1 stacked below it. When the stackability is poor, the stacked height of the lid members 1 becomes the sum height of the height of the swell part 5 and the paper thickness of the lid member 1 times the number of the lid members 1, requiring a very large space. Accordingly, by the lid member 1 described above, many lid members 1 may be accommodated in a limited space, substantially improving the stackability, allowing transportation of more lid members in one transportation, substantially reducing the transportation costs.

Next, for the manufacturing method of the lid member 1 according to the invention, explanations are given for the cases where the lid part 2, the substrate 3 and the hinge part 4 are formed as one piece. The lid member 1 according to the invention may be manufactured via the step of making from a raw material made of a pulp material a forming body for forming the lid part (punching step), the step of supporting the peripheral part of the forming body of the lid member in a state in which the peripheral part is holdable but not fixable (supporting step) and the step of deep draw forming the part of the lid member forming body located more inwardly than the peripheral part of the lid member forming body to form at least the surrounding wall (deep drawing step). The punching step is a step wherein the forming member of the lid member is formed from the raw material along the outline in which the lid part 2, the substrate part 3 and the hinge part 4 in the lid member 1 are continuous. The part corresponding to the outlet 27 can be provided in the form of an opening in this step or the part corresponding to the outlet part 27 can be formed after the punching step. In the deep drawing step, at least the part corresponding to the surrounding wall 13 of the substrate part 3 is formed by deep draw forming, and when the swell part 5 is formed in the lid part 2, the swell part 5 may be formed in this deep drawing step. Before the deep drawing step, a closing means for maintaining the state in which the lid part 2 is closed with respect to the substrate part 3 may be formed. This closing means may be applied with a reinforcement coating agent. Further, after an opening corresponding to the outlet 27 is formed, waterproofing treatment may be performed on the part comprising the outlet edge part. Before the deep drawing step, a folding part 33 may be made in the hinge part forming part by pressing. If the folding is performed to the hinge part forming part before the deep drawing step, it becomes possible to prevent breakage of the portions around the hinge part 4 and the outlet 27 during the deep drawing. If the waterproofing treatment is performed after the part corresponding to the outlet is formed, the anti-moisture treatment may be performed on a large number of lid members, allowing efficient manufacturing of the lid member 1 having a good resistance to moisture etc. as described above, allowing substantially increasing the manufacturing efficiency of the lid member 1.

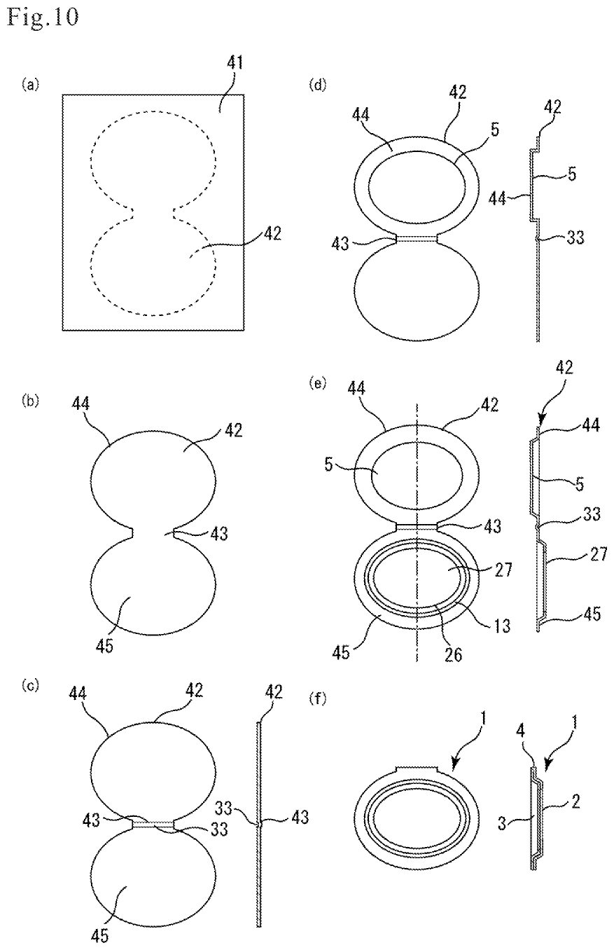

As shown in FIG. 10(a), in the punching step, the lid member forming body 42, from which the lid member 1 is to be formed, is formed from the raw material 41. This punching step may be performed by known methods using a punching die of e.g. so-called Vic types and Thomson types. FIG. 10(c) shows the lid part material forming body 42 wherein the folding part 33 is formed by pressing at the hinge forming part 43 which is to become the hinge part 4 of the lid member 1. Next, the lid part 2 and the substrate part 3 are formed from the lid member forming body 42. The lid part 2 and the substrate part 3 may be formed simultaneously in one step but may be formed separately. In FIG. 10(d), first the lid part 2 comprising the swell part 5 is formed. Subsequently, as shown in FIG. 10(e), the surrounding wall 13 is press formed and the substrate part 3 is formed. In the example shown in FIG. 10, the outlet 27 is formed by punching etc. at the same time as the step for forming the substrate part 3 or after said step. Finally, the folding is performed at the folding member 33, obtaining the lid member 1 (FIG. 10(f)).

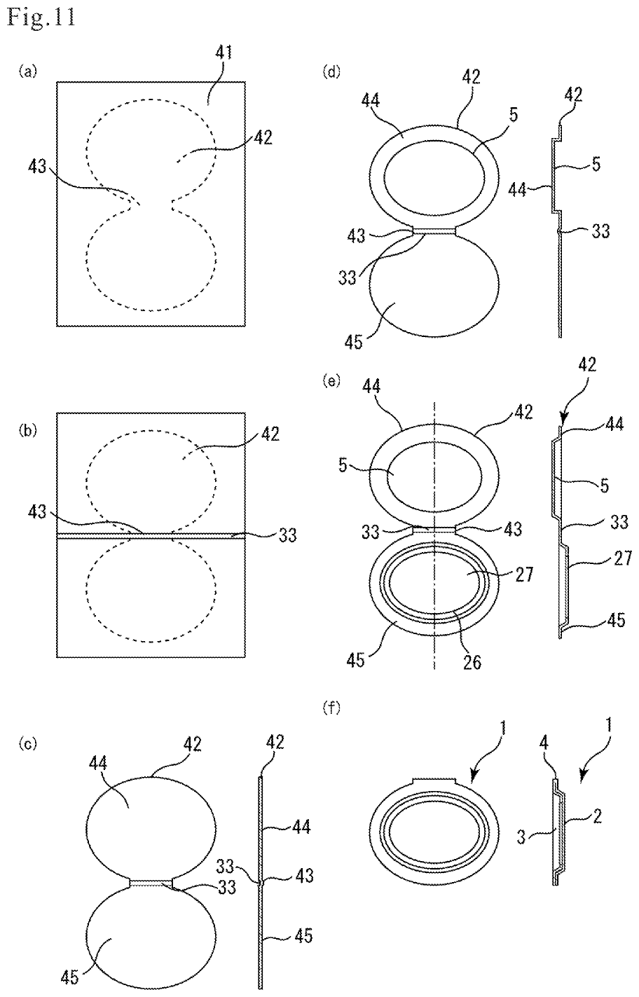

As shown in FIG. 11, another manufacturing method of the lid member 1 involves, on the raw material 41 for obtaining the lid member forming body 42 (FIG. 11(a)), first forming the folding part 33 in the hinge part forming part 43 by pressing (FIG. 11(b)), then punching the lid member forming body 42 (FIG. 11(c)). Then, in the same way as in the method shown above, the lid part 2 comprising the swell part 5 is formed in the lid member forming body 42 (FIG. 11(d)), then the substrate part 4 comprising the surrounding wall 13 is press formed and the outlet 27 is provided (FIG. 11(e)), and finally folding is performed at the folding part 33 to obtain the lid member 1 (FIG. 11(f)).

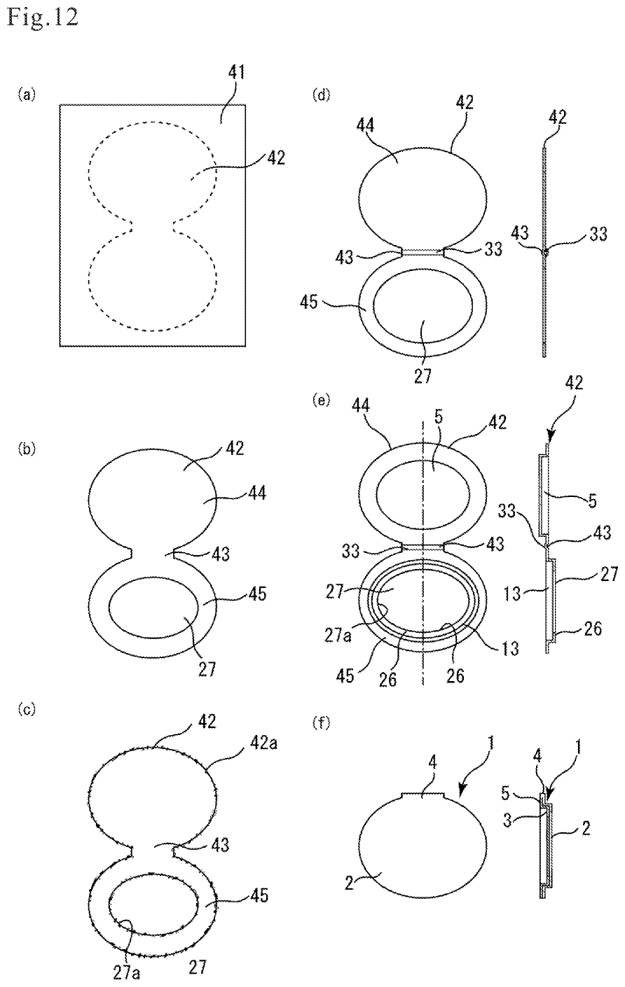

Further, another manufacturing method shown in FIG. 12 involves punching the lid member forming body 42 from the raw material 41 (FIG. 12(a)) and forming the outlet 27 in the substrate part forming part 45 by punching etc. (FIG. 12(b)). In this method, the punching of the outline of the lid member forming body 42 and the punching of the outlet forming part may be performed simultaneously or separately. The outlet 27 may be formed in the raw material 41 followed by punching the lid member forming body 42 or the lid member forming body 42 may be punched followed by forming the outlet 27. Next, non-wet treatment is performed on the lid member forming body 42 provided with the outlet 27. The non-wet treatment is performed at least on the outer circumference part 42a of the lid member forming body 42 and the circumferential part 27a (the part which becomes the inner circumference 26b of the flange part 26 described above when formed into the lid member 1) of the outlet 27. The method for the non-wet treatment is described later. Next, on the lid member forming body 42, the folding part 33 is formed by pressing in the hinge part forming body 43 which is to become the hinge part 4 of the lid member 1 (FIG. 12(d)), followed by forming the lid part 2 and the substrate part 3 in the lid part forming body 42 simultaneously or separately (FIG. 12(e)), and finally folding in the folding part 33, to obtain the lid member 1 (FIG. 12(f)).

In the steps explained in relation to FIGS. 10 to 12, when forming the swell part 5 and the surrounding wall 13 by pressing, it is preferred that drawing is performed in a state in which the parts surrounding the part for forming the swell part 5 and the part for forming the surrounding wall 13 are supported in a state which is not holdable but not fixable. More specifically, as explained below, it is preferably performed such that, during the forming step, the pressing force for pressing the swell part 5 and the surrounding wall 13 and the pressing force holding its surrounding area are different, preferably the pressing force holding its surrounding area is smaller than the pressing force for pressing the swell part 5 and the surrounding wall 13.

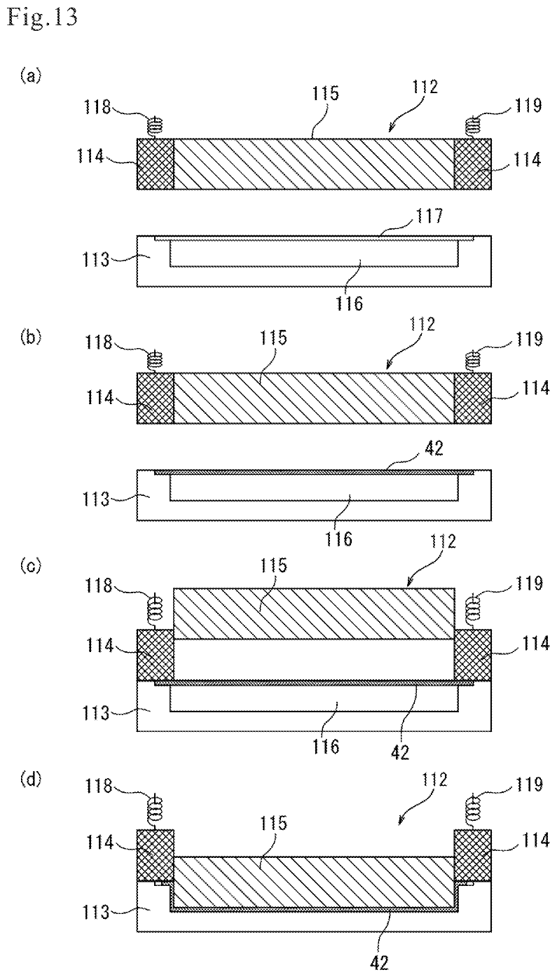

FIG. 13 shows an explanatory drawing for explaining the steps etc. in the manufacturing of the lid member 1 in which the lid member forming body 42 is e.g. deep draw pressed for the formation of the swell part 5 from the lid part forming part 44 and the surrounding wall 13 from the substrate part forming part 45. First, as shown in FIG. 13(a) etc., when manufacturing the lid member 1 by the above-described manufacturing method, deep draw pressing is performed using a die 112. This die 112 comprises a first die 113, a second die 114 and a third die 115. The first die 113 comprises a lower recess part 116 for forming the swell part 5 and the surrounding wall 13 in the lid part forming part 44 and the substrate part forming part 45 of the lid member forming part 42 during the deep draw pressing and a placing part 117 for placing the lid part forming part 44 and the substrate part forming part 45 of the lid member forming part 42. The second die 114 and the third die 115 are located at higher locations with respect to the first die 113 and they are each arranged to be separately operable. The second die 114 is provided with springs 118, 119 which are elastic members. The springs 118, 119 are provided for the purpose of adjusting the pressing force during the pressing.

For forming the lid member 1 using the die 112 configured in this manner, the lid member forming body 42 is first placed on the placing part 117 as shown in FIG. 13(b). Then, as shown in FIG. 13(c), the peripheral part of the lid member forming body 42 is pressed by the second die 114 to support the lid member forming body 42. Here, the pressing force of the second die 114 is adjusted using springs 118, 119, specifically the second die 114 is arranged so that it presses at a weaker force than the pressing force applied by the third die during the deep draw pressing as shown in FIG. 13(d). Thus, by adjusting the pressing force by the springs 118, 119, the state of “supporting in a state which can hold but cannot fix” can be achieved. Then, as shown in FIG. 13(d), the lid member forming body 42 is pressed by the third die 115. Accordingly, by preforming the press forming in a state where the periphery of the part to be pressed is supported in a state in which it can be held but cannot be fixed, deep draw forming of the swell part 5 and the surrounding wall 13 can be performed to form a good lid member 1 without cracks being formed in the lid member 1. In addition to what has been described above, by deep draw forming the swell part 5 and the surrounding wall 13 etc. after forming the folding part 33, it becomes possible to prevent cracking and breaking when forming the lid member 1.

Accordingly, the risk of the lid part forming body 42 breaking when the swell part 5 and the surrounding wall 13 are press formed can be substantially reduced and the risk of wrinkle formation in the outer circumference part 6 and the attaching part 25 formed after press forming the swell part 5 and the surrounding wall 13 as well as in the side wall part 7 and top part 8 of the swell part 5 and the flange part 26. Accordingly, by pressing the parts that are to become the outer circumference part 6 and the attaching part 25 by such pressing force, the appearance of the lid member 1 after pressing will be good and the air tightness of the lid member 1 becomes better.

It is noted that the respective steps explained in relation to FIG. 10 to FIG. 12 may be successively performed in one die or successively performed in a plurality of dies. The manner of pressing etc. during pressing may be freely selected from known methods.

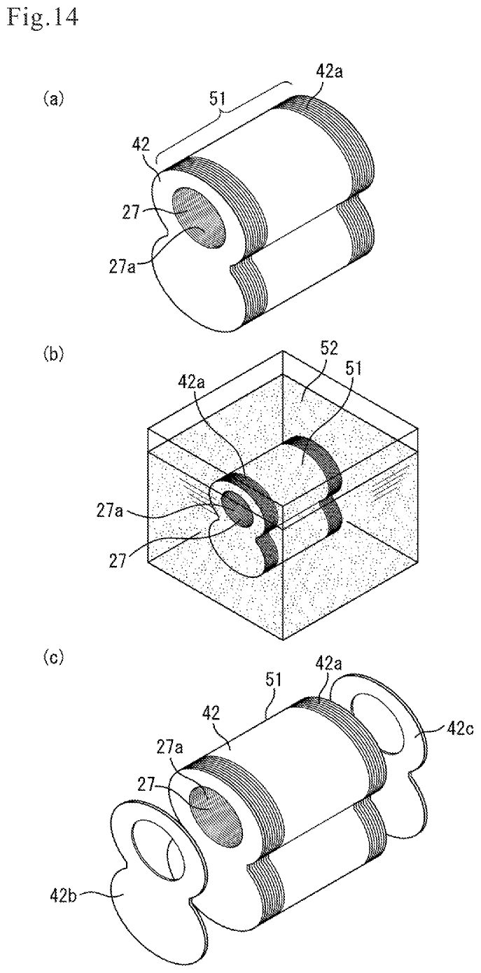

Next, the method of non-wet treatment described using FIG. 12(c) is described using FIG. 14. First, as shown in FIG. 14(a), a lid member laminate body 51 is formed in which a plurality (for example 500 pieces) of lid member forming bodies 42 comprising the outlets 27 are stacked. Each of the lid member forming bodies 42 constituting the lid member laminate body 51 is formed e.g. by sequentially lining up or stacking what has been formed by punching the raw material 41. The lid part laminate body 51 may be formed by clamping each of the lid member forming bodies 42 (in FIG. 14(a), the clamping body for clamping the lid member forming body 42 is omitted). The thus formed lid member laminate body 51 is immersed in a coating agent 52 as shown in FIG. 14(b). By immersing the lid member laminate body 51 in the coating agent 52, this coating liquid (solution) is impregnated in or applied to the circumferential part 27a forming the opening part 27 in each of the lid member forming bodies 42 constituting the lid member laminate body 51 and the outer circumferential parts 42a of the lid member forming bodies 42. After a predetermined time of immersing in the coating agent 52, the lid member laminate body 51 is taken out of the coating agent 52 and dried etc. After the steps up to FIG. 14(b) are performed, as shown in FIG. 14(c), the lid member forming body 42b on the front surface side and the lid member forming body 42c on the back side are removed from the lid member forming bodies 42 constituting the lid member laminate body 51. The removal of the lid member forming body 42b on the front side and the lid member forming body 42c on the back side may be performed manually or somehow be automated. The reason for removing the lid member forming bodies 42b, 42c is that, since the lid member forming bodies 42b, 42c were located on the front surface side and the back surface side, when it is dipped in the coating agent 52 described above, not only the circumference part 27a and the outer circumference part 42a but also the front side and the back side of the lid member forming member 42 are applied with the coating agent 52.

Since this non-wet treatment is a treatment for impregnating the coating agent 52 described above in the circumference part 27a and the outer circumference part 42a, using a lid member forming member 42 in which its front side and the back side are also applied with the coating agent 52 is not preferable since there will be fluctuation in the quality of the lid member 1. Accordingly, if the lid member forming bodies 42b, 42c are removed as described above and the remaining lid member forming bodies 42 are used, lid member forming bodies 42 can be obtained in which the coating agent 52 is impregnated and applied only to the surrounding part 27a and the outer circumference part 42a, avoiding fluctuation in the quality of the lid member 1 and allowing to provide a lid member 1 having a stable quality. By performing the non-wet treatment in this way, it becomes possible to perform the non-wet treatment to a large number of lid member forming bodies 42, enormously increasing the processing efficiency. Finally, as shown in FIG. 14(c), the lid member laminate body 51 is taken apart to obtain each of the lid member forming bodies 42, and each of the lid member forming bodies 42 is subjected to pressing etc. to obtain a lid member 1. According to such non-wet treatment method, a large number of lid member forming bodies 42 may be processed at once, substantially increasing the manufacturing efficiency of the lid member 1 as well as the quality and the liquid resistance of the manufactured lid member 1. In this example, the explanation was given using an example in which the lid member forming body 42b at the front side and the lid member forming body 42c at the back side are removed. However, if the coating agent is not applied to the front side of the lid member forming body 42b and the back side of the lid member forming body 42c and the coating agent can be applied in the same manner as the lid member forming bodies present between the lid member forming body 42b and the lid member forming body 42c, the step shown in FIG. 14(c) may be omitted.

Accordingly, according to the manufacturing method of the lid member 1 according to the present invention, the manufacturing efficiency of the manufacturing of the lid member 1 may be hugely increased and when deep draw forming the swell part 5 and the surrounding wall 13 etc., generation of the cracks and wrinkles in the obtained lid member can be prevented, thus allowing easy manufacturing of the superior lid member 1.

The method of the non-wet treatment mentioned above has been explained using an example in which the lid member laminate body 51 is dipped in the coating agent 52. However, the non-wet treatment method may be performed in other ways, for example a coating agent may be applied one by one on the circumference part 27a of the outlet 27 and the outer circumferential part 42a of the lid member forming body 42. The application method may be known methods such as applying with a brush or applying using a coater.

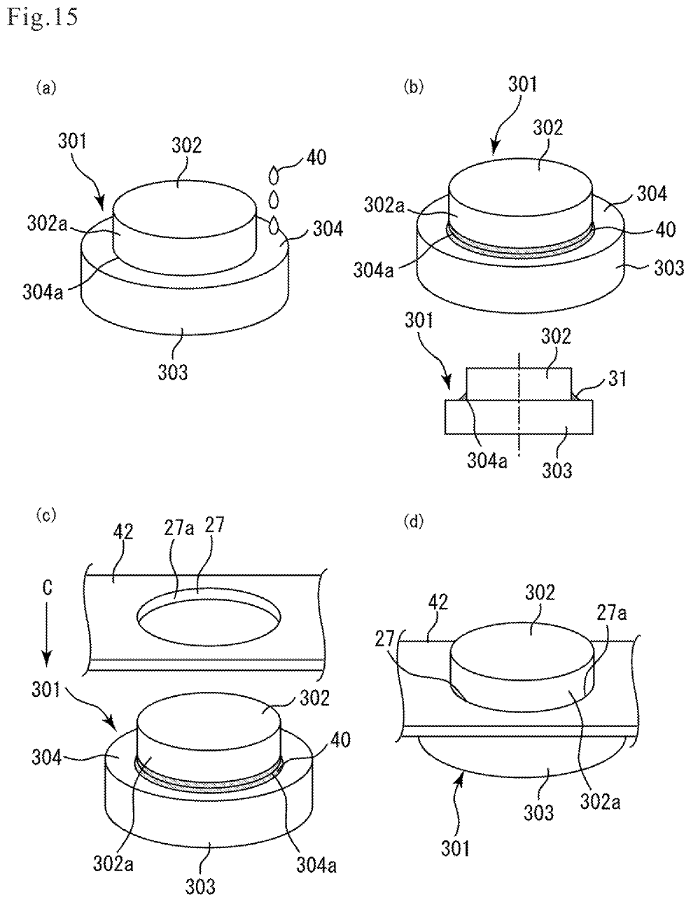

Next, shown in FIGS. 15 to 17 is a different impregnation method of the coating agent on the circumference part 27a (also referred as the opening edge part) of the outlet 27. In this impregnation method, the coating agent is impregnated one by one in the circumferential part 27a of the outlet 27. Shown in FIG. 15(a) is a jig 301, wherein the jig comprises an upper part 302 and a lower part 303 formed as one piece, wherein the upper part 302 is smaller than the lower part 303. The shape of the upper part 302 is formed to be the same shape as the outlet 27 to be formed in the substrate part 3 of the lid member 1. The upper part 30 is arranged to have substantially the same size as the outlet 27 so that it can be inserted in the outlet 27. The lower part 303 is formed to be larger than the upper part 302, and a flat part 304 is formed at the location where the upper part 302 is not formed. At the border part between the side 302a of the upper part 302 and the flat part 304, a corner part 304a is formed.

A coating agent 40 is dropped on the jig 301 on the flat part 304 of the lower part 303 close to the corner part 304a. Then, the coating agent 40 dropped on the flat part 304 remains at the corner part 304a by surface tension. Dropping of the coating agent 40 is performed such that an appropriate amount is dropped so that the whole circumference of the corner part 304a is surrounded by it. By dropping the coating agent 40 this way, the coating agent 40 attaches to the corner part 304a. After the coating agent 40 is dropped to be provided over the whole circumference of the corner part 304a, as shown in FIG. 15(c), the lid member forming body 42 (in FIG. 15(c), for the convenience of explanation, the lid member forming body 42 is formed as a plate, but the shape of the body 42 may be as explained above or another shape. If the outlet 27 has been made before the lid member forming body 42 has been punched from the raw material 41, the lid member forming body 42 will be as shown in FIG. 15(c)) is moved in the C direction in the figure from a location far from the jig 301 to a location neighboring the jig 301 (in FIG. 15(c), the lid member forming body 42 is moved downwards from above the jig 301), and it is moved in the C direction until the back side of the lid member forming body 42 contacts the flat part 304. When the lid member forming body 42 contacts the flat part 304, the coating agent 40 that was accumulated at the corner part 304a is efficiently impregnated in the circumference part 27a of the outlet 27 and is applied to the circumference part 27a. At the circumference part 27a, when the coating agent is so applied, it is impregnated in the lid member forming body 42 and thereafter is applied on the surface of the surrounding part 27a. By applying the coating agent 40 by impregnation in the circumference part 27a of the outlet 27 in this way, when the lid member 1 is formed, it can be prevented that the surrounding part 27a (also referred to as an inner circumference 26b of the flange part 26 in the lid member 1) is impregnated with various liquids during use and weaken the material constituting the lid member 1. By applying the coating agent 40 on the surrounding part 27a by this method, the coating agent 40 may be applied to the whole circumference of the surrounding part 27a. Accordingly, in the circumference part 27a, there will be no unevenness in the impregnation and the application of the coating agent 40, preventing liquids from impregnating from specific locations and weakening the material forming the lid member 1 and lowering the overall strength of the lid member 1.

When the coating agent 40 is impregnated and thereafter the temperature is increased to cure the coating agent, the heating is preferably done up to the temperature at which the applied coating agent cures to form a film (here referred as film formation temperature). This is because if the heating is not done up to the film formation temperature, it becomes difficult to form a stable film and it becomes difficult to prevent liquids from impregnating into the circumference part 27a during use and weakening the material forming the lid member 1 by the impregnation of liquid and lowering the overall strength of the lid member 1. The coating agent 40 herein used may be selected from known ones and the materials mentioned as the coating agents and coat agents in the present specification may be freely used. For example, specifically, polyurethane, polyvinyl alcohol (PVA), EVA may be used, and those which do not have properties of film formation may also be used, such as silicone, fluorine, various oils and paraffines.

The coating agent 40 herein used may be a mixture of a plurality of types or of one type. Further, the application of the coating agent may be performed once or multiple times. When the coating agent 40 is applied multiple times, the types of the coating agent 40 may be changed every time or the same coating agent 40 may be used multiple times. It can be freely determined. The method for heating the coating agent 40 may e.g. be dry heating using a heater or heating by infrared. Further, known methods may be freely selected, such as electromagnetic wave and ultrasound wave.

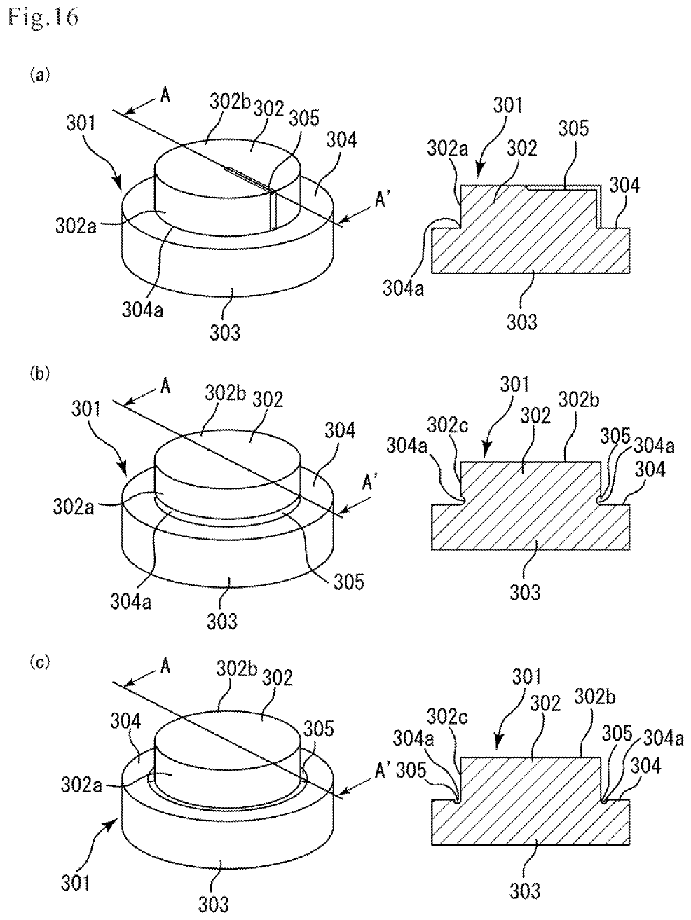

It is preferred that the jig 301 has a shape wherein when the coating agent 40 is dropped the dropped coating agent 40 tends to stay at the corner part 304a. For example, as shown in FIG. 16(a), it can be configured such that a groove shaped guiding passage 305 is provided in the flat part 302b and the side 302a of the upper part 302, thereby the coating agent 40 dropped in the guiding passage 305 tends to stay in the corner part 304a via the guiding passage 305. Shown in FIG. 16(b) is an embodiment in which a guiding passage 305 is provided in the corner 304a at the inner diameter side of the side 302a of the upper part 302. In other words, in this embodiment, the guiding passage 305 is provided in the corner part 304a. Also the guiding passage 305 in such location allows the coating agent 40 to stay in the corner part 304a. When the guiding passage 305 is provided in this corner part 304a, it becomes possible to store more coating agent 40, allowing to impregnate and apply the coating agent 40 to the surrounding part 27a of the opening part 27 in the lid member forming body 42 more easily. As shown in FIG. 16(c), the jig 301 is provided with a guiding passage 305 in the flat part 304 of the lower part 303 at the location close to the side 302 of the upper part 302, more specifically the location neighboring the side 302a. In this embodiment shown in FIG. 16(c), the groove forming the guiding passage 305 is provided in the flat part 304. Providing the guiding passage 305 in such location to store the coating agent 40 in the corner part 304a also makes it easy to store the coating agent 40. Since it becomes possible to store more coating agent 40 in the corner part 304a, it becomes possible to impregnate and apply the coating agent to the surrounding part 27a of the opening part 27 in the lid member forming body 42 more easily. Regarding the constructions of the jig 301 described using FIG. 16, each embodiment may be individually applied or the embodiments described above may be used in combination.

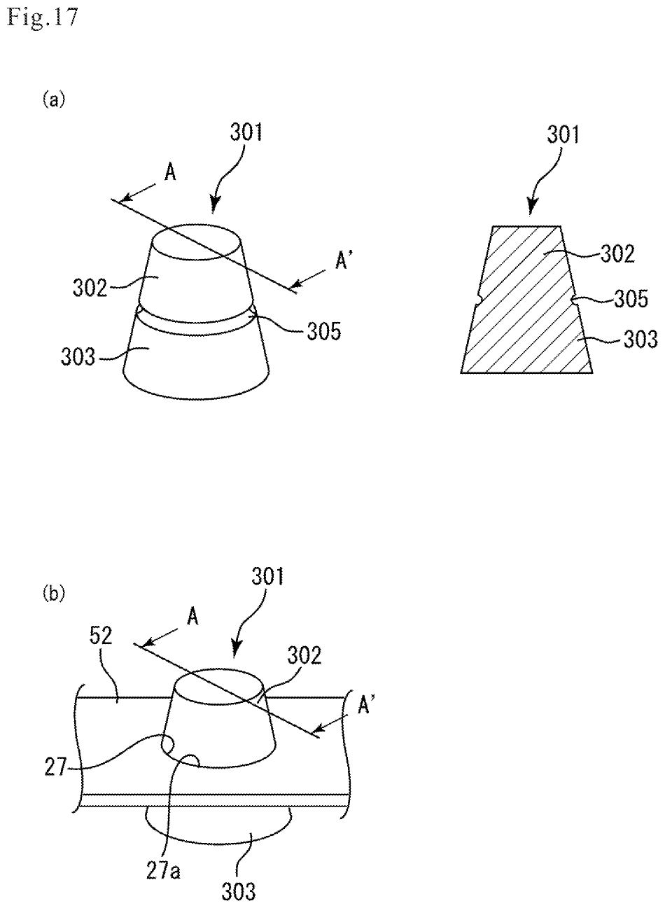

As shown in FIG. 17, the jig 301 may also be truncated cone shaped. This jig 301 has a truncated cone shape in which one end (upper end in FIG. 17) has an outer diameter which is smaller than the diameter of the outlet 27 and the other end (lower end in FIG. 17) has an outer diameter which is larger than the diameter of the outlet 27, wherein between the one end and the other end is a location at which the outer diameter of the jig 301 and the diameter of the outlet 27 are the same. In the jig 301 having a truncated cone shape, a guiding passage 305 is provided at the intermediate part at which the outer diameter of the jig 301 and the diameter of the outlet 27 are the same, and the upper part 302 and the lower part 303 are formed having the guiding passage 305 as their border. The location at which the guiding passage 305 is formed is the location at which the outer diameter of the jig 301 at the location at which the guiding passage 305 is formed is the same as the diameter of the outlet 27 of the lid member forming body 42. Accordingly, as the jig 301 is inserted into the outlet 27 of the lid member forming body 42, the insertion is smooth since the outer diameter of the jig 301 is smaller than the diameter of the outlet 27 when inserting. Herein, as the jig 301 has a truncated cone shape and the outer diameter successively increases, there is a location at which the diameter of the outlet 27 and the outer diameter of the jig 301 are the same. The guiding passage 305 is provided at this location. The guiding passage 305 is formed as a groove on the side 301a of the jig 301. By the outlet 27 fitting in the guiding passage 305, the coating agent 40 stored in the guiding passage 305 is impregnated in the surrounding part 27a of the outlet 27 and is applied there. This way of applying the application agent 40 also allows applying the coating agent 40 homogeneously and easily on the surrounding part 27a of the outlet 27 of the lid member forming body 42.

The manner of the non-wet treatment was herein explained using figures, but the above description merely shows examples of the method of the non-wet treatment and may be suitably varied within the gist of the present invention. For example, when the above-mentioned coating agent or coat agent are applied to the outer wall 14 of the surrounding wall 13 and the inner wall 9 of the swell part 5 as described above, the coating agent or coat agent may be applied to at least a part of it or the coating agent or coat agent may be applied over the whole circumference. The above-described coating agent or coat agent may be suitably applied not only on the above-mentioned parts but also to other parts of the lid member 1. In the cases where a locking part and a lock receiving part described later are provided as a closing means, when e.g. a hot melt adhesive is arbitrarily selected and used, not only the degree of the friction resistance but also the viscosity of the adhesive itself may be adjusted. Accordingly, the manufacturing efficiency of the lid member 1 can be substantially increased and also the tightness of the manufactured lid member 1 when the lid is closed can be improved. When the coating agent 40 is applied to the surrounding part 27a of the outlet 27, the method for applying the coating agent 40 by the jig may be as described above, or the dipping by other ways than described above, or spray coating or an application by a coater or a method using a sponge or a brush. Other manners may be freely selected and used.

When the lid member 1 is manufactured by the above-mentioned method, pressing the raw material 41 beforehand is preferable since the coating agent sits better on the front surface and/or the back surface of the raw material 41. When the lid member forming member 42 is pressed in the manufacturing of the lid member 1, the pressing may be performed once or the pressing may be performed multiple times stepwise. By pressing in this manner, the processibility of the lid member forming body 42 can be increased. In manufacturing the lid member 1, the lid member forming body 42 may be made to have a moisturized state (a moist state achieved by a predetermined amount of a liquid) beforehand and then be pressed etc., which is preferred since the processibility of the lid member is increased.

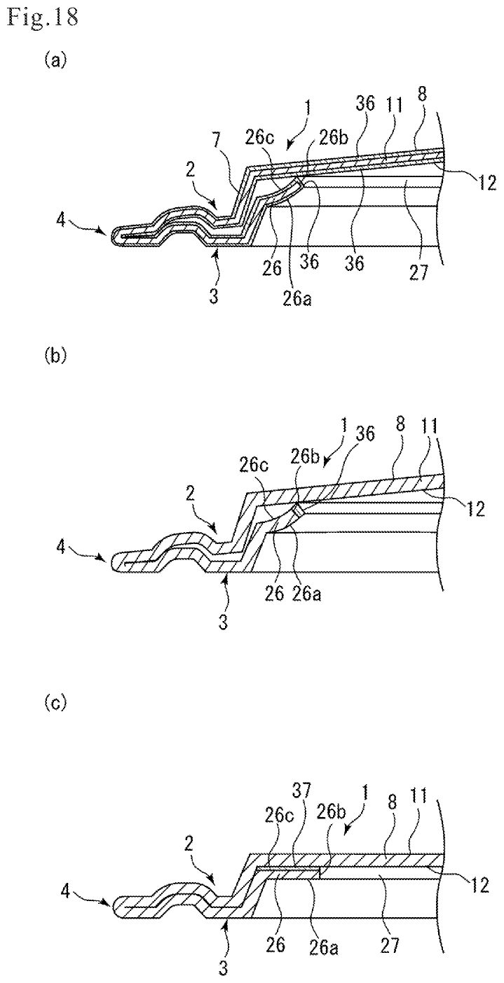

Next, a more preferred embodiment of the lid member 1 according to the invention is described. FIG. 18(a) shows an embodiment of the lid member 1 in which the lid part 2, the substrate part 3 and the hinge part 4 are subjected to a non-wet treatment. In this embodiment, the top side 12 of the top wall 11 of the lid part 2 and the surface 26c and the inner circumference 26b of the flange part 26b are subjected to a non-wet treatment. Specifically, by forming a coating film 36 by applying the above-described coating agent, the non-wet treatment is performed. In this case, the coating film 36 is formed to cover the overall paper material, thus the coating film 36 on the top surface 12 and the coating film 36 on the inner circumference 26b of the flange part 26 contact each other when the lid is closed. In this case, since the coating films 36 contact each other, even when micro roughness is present at the edge of the inner circumference 26b, the micro roughness may be smoothened to a certain extent by the formation of the coating film 36. Accordingly, the sealability of the top surface 12 of the lid part 2 and the inner circumference 26b of the flange part 26 of the substrate part 3 can be improved, improving the overall airtightness of the lid member 1.

FIG. 18(b) shows an example in which only the inner circumference 26b of the flange part 26 is provided with the coating film 36. In this case, the top surface of the lid part 2 and the coating film 36 formed on the inner circumference 26b of the flange part 26 of the substrate part 3 contact each other when the lid is closed. Accordingly, this embodiment also improves the overall airtightness of the lid member 1.

Next, FIG. 18(c) shows an example wherein a self-adhesive layer 37 is provided by applying a coating agent having a self-adhesivity (or self-stickiness) between the surface 26c of the flange part 26 and the top surface 12 of the lid part 2 contacting with said part. The formation of the self-adhesive layer 37 in this way improves the sealability of the lid part 2 when the lid is closed. When this self-adhesive layer 37 is formed, the pressure when the lid part 2 is pressed results in a state in which the lid part 2 and the substrate part 3 are closed, and can maintain the closed lid state. Accordingly, this may have a function as the closing means as an alternative to the engagement of the first protrusion part 18 and the second protrusion part 19 as described above, or the self-adhesion layer 37 can be provided in addition to the engagement of the first protrusion part 18 and the second protrusion part 19 to more strongly maintain the closed lid state. The self-adhesive for providing the self-adhesion layer 37 shows an adhesion property which adheres by pressure only between the self-adhesives but do not adhere to other materials. Accordingly, it is necessary to provide the self-adhesion layer 37 on both the surface 26c of the flange part 26 and the part of the top surface 12 which contacts the surface 26c of the flange 26.

The self-adhesion layer 37 may be made e.g. of latex such as natural rubber latex and a mixture of natural rubber latex and synthetic resin emulsion. The synthetic resin emulsion may e.g. be vinyl acetate emulsion or an acrylic emulsion such as polyacrylate, polymethacrylate and an acrylic copolymer. Providing such self-adhesion layer 37 can further increase the air tightness between the lid part 2 and the substrate part 3 when the lid is closed. The self-adhesion layer 37 can be repeatedly sealed and peeled off for a long period of time. In FIG. 18(c), the self-adhesion layer 37 is arranged such that it is positioned between the surface 26c of the flange part 26 and the top surface 12 when the lid is closed, but the self-adhesion layer 37 may be provided at another part where the lid part 2 and the substrate part 3 contact each other when the lid is closed.

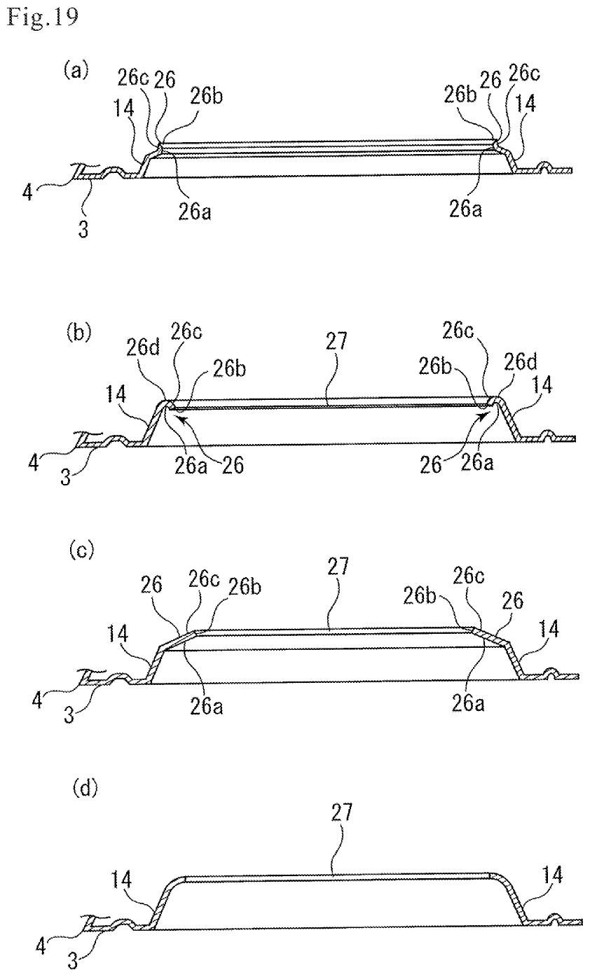

FIG. 19 shows another embodiment of the part to be pressed in the substrate part 3. As described above, the part to be pressed is to be arranged such that it receives a pressing force from the lid part 2 when the lid is closed and the state in which it receives a pressing force is maintained when the closed lid state is maintained. In particular, when the part to be pressed is arranged as a flange part 26, this flange part 26 may be arranged, aside from the above-described manner, as shown in FIG. 19(a). In this case, instead of arranging the inner circumference 26b of the flange part 26 to be oriented in the direction of the radial center, the flange part 26 may be folded such that the inner circumference 26b is oriented in the direction of the radial center and upwardly. As shown in FIG. 19(b), the upper end part 26d may be formed into a rounded form such that the inner circumference 26b is positioned lower than the upper end part 26d. As shown in FIG. 19(c), the flange part 26 may be sloped to be linearly tapered from the surrounding wall 13 in the direction of the outlet 27. Further, as shown in FIG. 19(d), the part to be pressed may be formed as a projecting part made by bending the upper end part of the surrounding wall such that the upper end part comes into contact with the top wall 12 when the lid is closed. It is possible to obtain the effects as described above also by arranging the surrounding wall 13 in this manner. It is noted that in these examples, the outlet 27 is shown to be in the upper part or the upper end part of the surrounding wall 13, but this is not limiting. For example, the outlet 27 may be formed as an opening in the lower part or the lower end part of the surrounding wall 13 or in other positions.

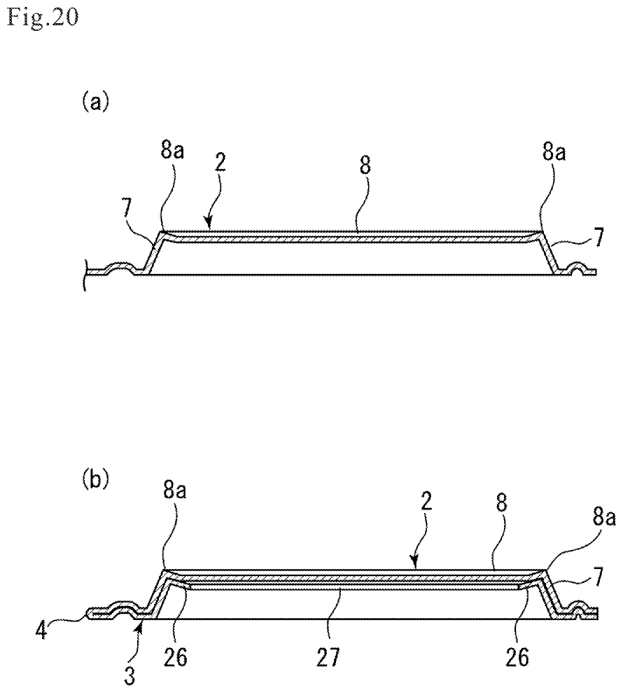

FIG. 20 shows a variation of the lid part 2. The lid part 2 shown in FIG. 20 is an embodiment in which the top wall 11 recesses from the circumference part which is connected to the side wall part 7 towards the inner direction. In other words, the top cover part 8 is provided at a lower location than the upper end part of the side wall part 7 and an annular ridge part 8a is provided at the connection part between the top cover part 8 and the side wall part 7. By arranging the top cover part 8 to be positioned at a lower location than the upper end part of the side wall part 7, a greater pressing force will be applied to the flange part 26 when the lid is closed and thus the adhesion between the lid part 2 and the flange part 26 is increased. When the annular ridge part 8a is provided, the overall strength of the swell part 5 is increased and the strain and the deformation etc. of the lid part 2 when the lid part 2 is opened and closed can be prevented.

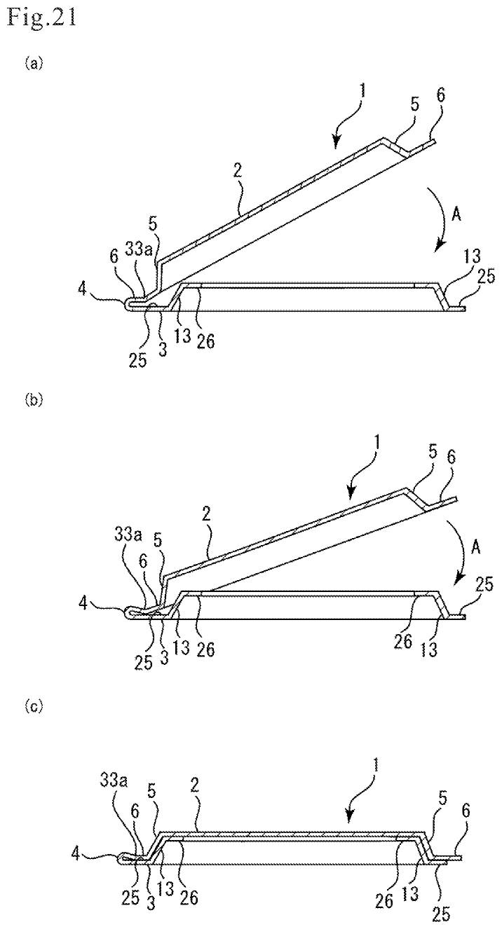

FIG. 21 shows yet another variation of the lid part 2. The lid par 2 shown in FIG. 21 comprises a bending part 33a on part of the outer circumference part 6 close to the hinge part 4. The location at which the bending part 33a is formed may be anywhere on the outer circumference part 6 close to the hinge part 4. By providing the bending part 33a, when the lid part 2 is rotated from the open lid state shown in FIG. 21(a) in the A direction in the figure, by rotating the lid part 2 with the hinge part 4 being the fulcrum, the bending part 33a first abuts against the surface 25a of the attaching part 25 of the substrate 3 as shown in FIG. 21(b). Then, when the lid part 2 is further rotated from the state of FIG. 21(b) in the A direction of the figure, the lid part 2 rotates in the A direction of the figure with the bending part 33a being the fulcrum, resulting in the closed state as shown in FIG. 21(c).

By closing the lid in this manner, as also shown in FIG. 21(c), a gap is formed between the lid part 2 and the substrate part 3 in the part from the hinge part 4 to the bending part 33a, whereas in the part from the bending part 33a to the swell part 5, the outer circumference part 6 of the lid part 2 and the attaching part 25 of the substrate 3 can be adhered. By adhering this part, the swell part 5 of the lid part 2 and the surrounding wall 13 can be adhered more strongly, and also the top wall 11 of the lid part 2 and the flange part 26 of the substrate part 3 can be adhered more strongly. Accordingly, the overall sealability of the lid member 1 can be further increased.

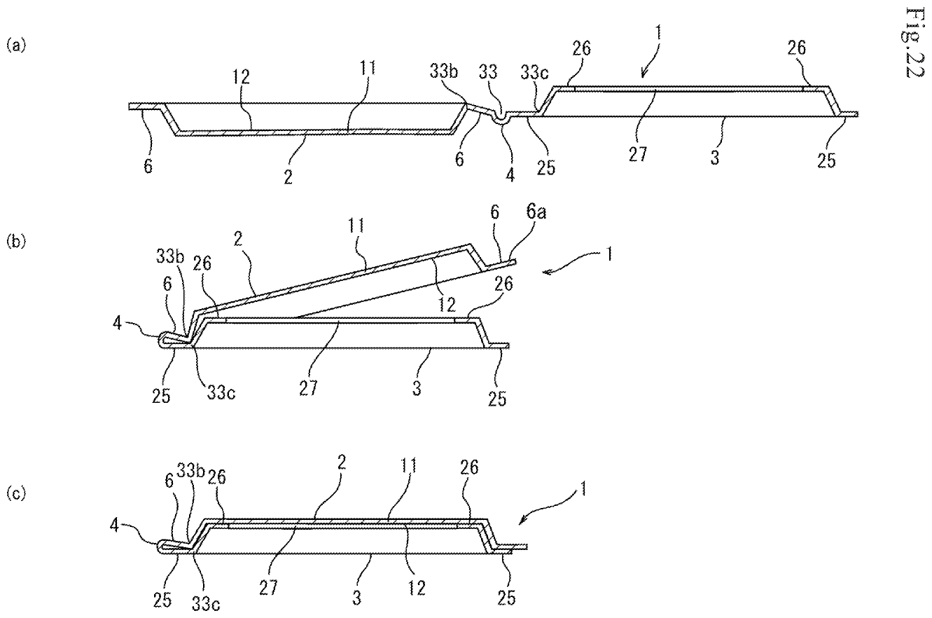

FIG. 22 shows another variation of the lid part 2. The lid part 2 is arranged such that the part of the outer circumference part 6 close to the hinge part 4 has an overall tilt angle. In other words, when the lid part 2 is open as shown in FIG. 22 (a), the part of the outer circumference part 6 close to the hinge part 4 is not configured to be parallel with the attaching part 25 of the substrate part 3, and the outer circumference part 6 is configured such that a predetermined angle is formed between the outer circumference part 6 and the attaching part 25. A convex angle part 33b is formed at the border between the outer circumference part 6 and the swell part 5. When the lid part 2 is rotated in the direction of the lid closure and the lid part 2 is rotated up to the location shown in FIG. 22(b), the convex angle part 33b of the lid part 2 abuts against the concave angle part 33c at the border between the attaching part 25 of the substrate part 3 and the surrounding wall 13. In this way, in the state where the convex angle part 33b abuts against the concave angle part 33c, the lid part 2 is not completely closed and is located at a position higher than the substrate part 3.

When the lid part 2 is rotated further in the lid closing direction from the state shown in FIG. 22(b), the lid part 2 rotates in the lid closing direction wherein the point at which the convex angle part 33b and the concave angle part 33c abut against each other is the fulcrum. In this case, the lid part 2 would close while the swell part 5 and the surrounding wall 13 are adhered to each other. When the lid part 2 is completely closed as shown in FIG. 22(c), the lid is closed in a state where the top surface 12 is adhered more strongly to the flange part 26. Accordingly, the lid member 1 in this example allows increasing the overall sealability of the lid member 1 when the lid is closed even further.

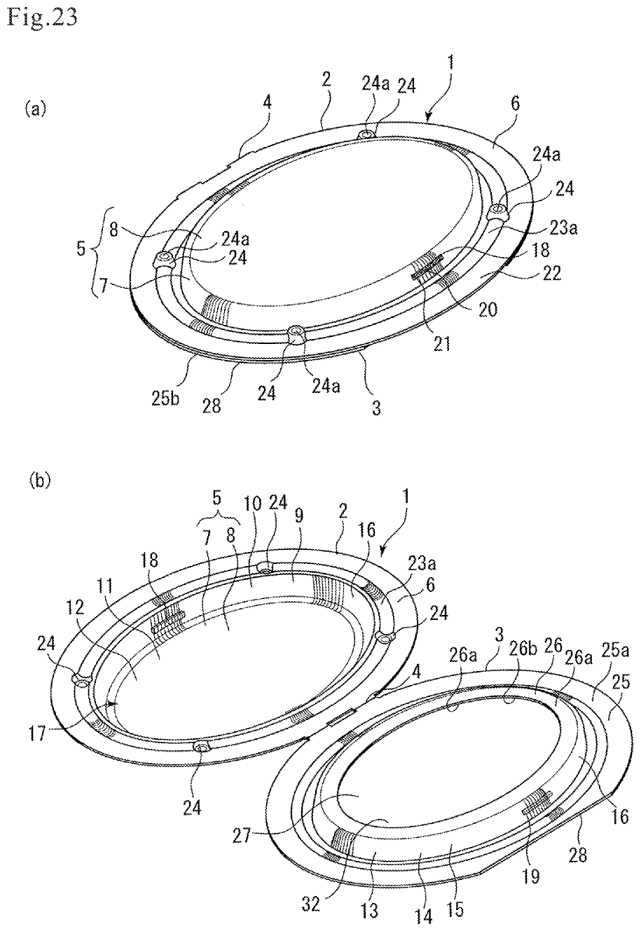

FIG. 23 shows a variation of the lid member 1. In the lid member shown in FIG. 23, the outer circumference part 6 of the lid member 2 is provided with a lid part reinforcement rib 23a along the circumference of the swell part 5 and further the reinforcement rib 23a is provided with a protrusion part 24. On the other hand, the substrate part 3 is provided with a substrate part reinforcement rib 23b. The lid part reinforcement rib 23a is arranged such that it rises by a predetermined height upwardly from the outer circumferential part surface 6a of the outer circumference part 6. This lid part reinforcement rib 23a is arranged to surround the outer circumference part 6 at the outer circumferential part surface 6a. By forming the lid part reinforcement rib 23a, the strength of the outer circumference part 6 of the lid part 2 can be substantially increased and the durability of the lid part 2 in relation to the opening and closing actions can be substantially increased. On the outer circumference part 6, four protrusion parts 24 are provided at the locations where the lid part reinforcement ribs 23a are formed. These protrusion parts 24 increase the strength of the outer circumference part 6 and the durability of the lid part 2 together with the lid part reinforcement rib 23a, as well as improve the stackability when a plurality of the lid members 1 are stacked during the transportation of the lid member 1, as described below.

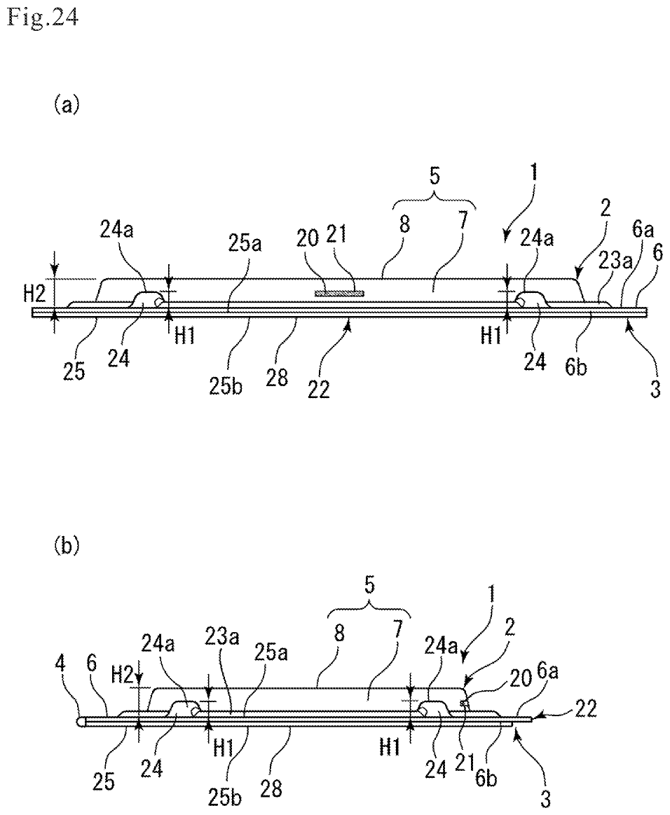

As shown in FIGS. 24(a) and (b), these four protrusion parts 24 are arranged such that they have a protrusion height H1 and have the same protrusion heights. The protrusion heights H1 of these protrusion parts 24 are arranged such that they are of a smaller height than the protrusion height H2 of the side wall part 7. By arranging the heights of the protrusion parts 24 to be H1 and the same, when a plurality of the lid members 1 are stacked, wobbling and shaking among the lid members 1 and collapsing may be prevented and it becomes possible to stack a plurality of the lid members 1 in a stable condition. In this example using FIGS. 23, 24, explanations have been given using an example wherein the protrusion parts 24 are positioned at four locations. However, the positioning of the protrusion parts 24 is not limited to four locations. The locations at which the protrusion parts 24 are positioned are not limited to the manner in the example described above.

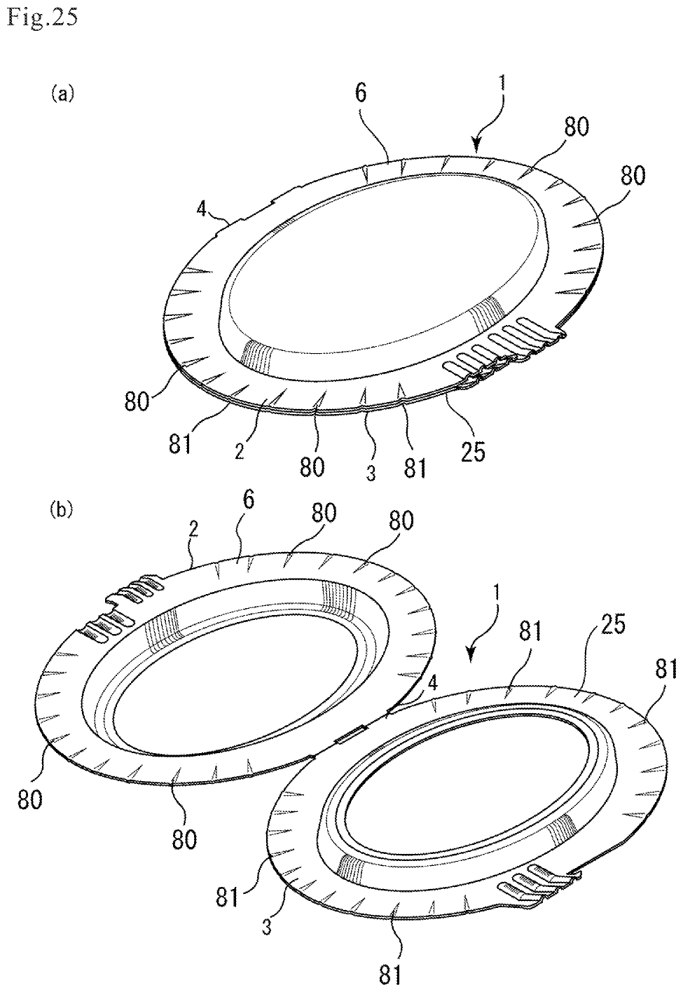

FIG. 25 shows another variation of the lid member 1. FIG. 25(a) shows the lid member 1 in a closed lid state and FIG. 25(b) shows the lid member 1 in an open lid state. In this lid member 1, protrusion ribs 80 are provided on the outer circumference 6 of the lid part 2 and protrusion ribs 81 are provided on the attaching part 25 of the substrate part 3. These protrusion ribs 80, 81 are formed to extend radially from the center parts of the lid part 2 and the substrate part 3 in the direction of the outer circumferential part. These protrusion ribs 80, 81 are provided at predetermined intervals in the circumferential direction of the outer circumference part 6 and the attaching part 25. As shown in FIG. 25(a), the protrusion ribs 80 and the protrusion ribs 81 are arranged to overlap with each other when the lid is closed.

By providing the protrusion ribs 80, 81 on the outer circumference part 6 and the attaching part 25 in this way, the strength of the outer circumference part 6 and the attaching part 25 can be substantially increased. Also, by providing the protrusion ribs 80, 81 in this way, the occurrence of the wrinkles which tend to form in the outer circumference part 6 and the attaching part 25 when making the lid member 1 can be reduced. In other words, the lid member 1 is arranged so that the parts which can become wrinkled which tend to occur when making the lid member 1 are already formed as the protrusion ribs 80, 81. Accordingly, these protrusion ribs 80, 81 may have the function as the parts in which wrinkles are intensively formed. Accordingly, by providing the protrusion ribs 80, 81, the occurrence of the wrinkles where the protrusion ribs 80, 81 are not formed can be reduced.

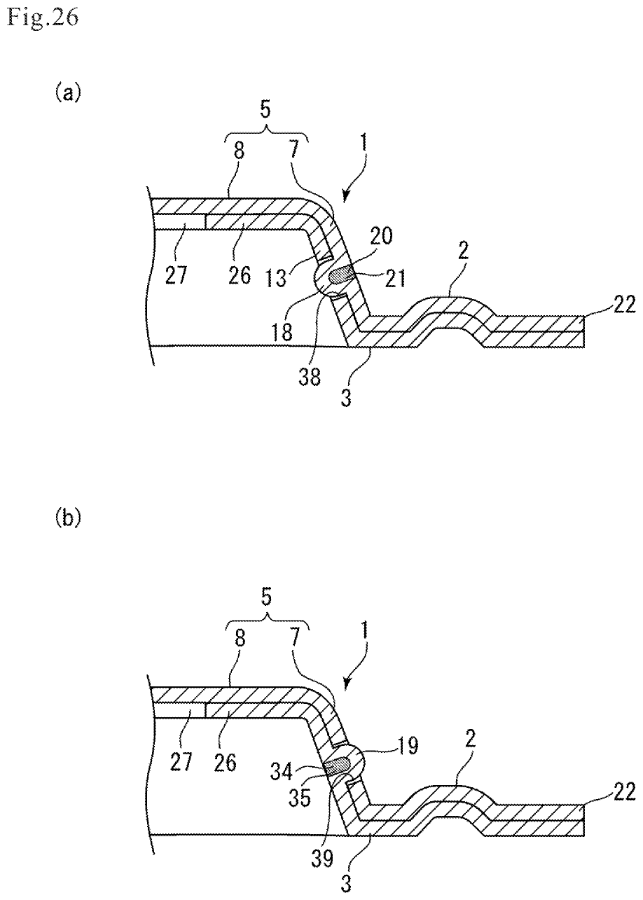

Next, the closing means is explained using figures where appropriate. The closing means is for maintaining the closed lid state of the lid part 2 and the substrate part 3. This closing means may be those using the friction stress at the contact part 16 between the outer wall 14 of the surrounding wall 13 and the inner wall 9 of the swell part 5 as described above, or in the manner as explained below using figures. FIG. 26 shows the engagement between the protrusion part and the recess part between the side wall of the swell part 5 and the side wall of the surrounding wall 13. In the embodiment shown in FIG. 26(a), a first protrusion part 18 protruding in the direction of the surrounding wall 13 is formed on the side wall part 7 of the swell part 5 of the lid part 2, and a hole 38 which engages with the first protrusion part 18 is formed on the surrounding wall 13 of the substrate part 3. The closed lid state is maintained by the engagement between the first protrusion part 18 and the hole 38 when the lid is closed. On the recess part (first recess part 20) on the back side (outer surface side of the side wall part 7 of the swell part 5) of the first extrusion part 18, a reinforcement member 21 may be provided as necessary in order to increase the strength of the first protrusion part 18.

In the embodiment shown in FIG. 26(b), as opposed to the embodiment of FIG. 26(a), a hole 39 is provided at the side wall part 7 of the swell part 5 of the lid part 2 and a second protrusion part 19 is provided at the surrounding wall 13 of the substrate part 3, and the closed lid state is maintained by the engagement between the second protrusion part 19 and the hole 39 when the lid is closed. In this case, a reinforcement member 35 is provided in the recess part (second recess part 34) of the back side of the second protrusion part 19 (inner surface side of the surrounding wall 13) as necessary in order to increase the strength of the second protrusion part 19.

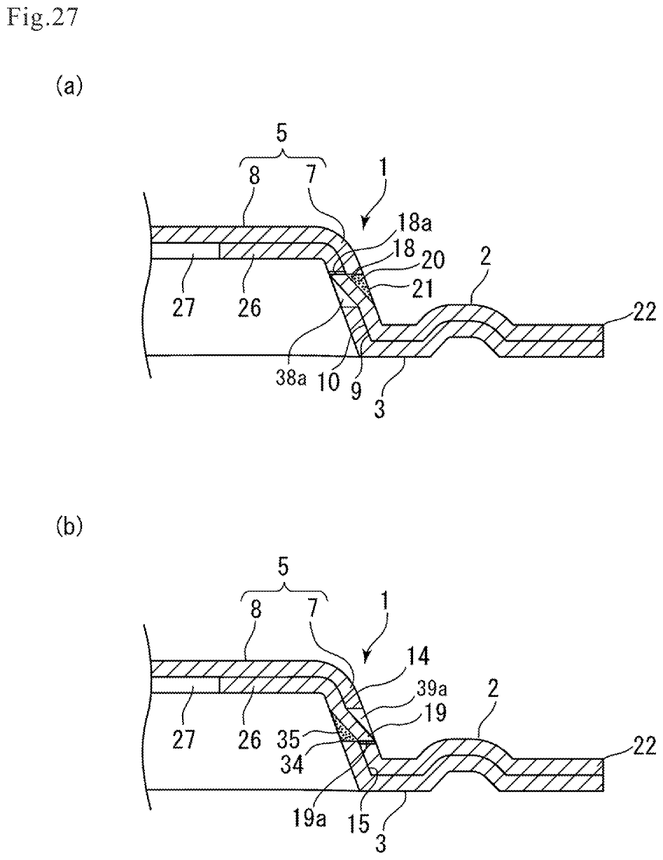

In the embodiment shown in FIG. 27(a), a protrusion piece 18a protruding in the direction of the surrounding wall 13 is formed on the side wall part 7 of the swell part 5 of the lid part 2, and a hole 38a which engages with the first protrusion part 18 is formed on the surrounding wall 13. The protrusion piece 18a fits in the hole 38a and engages with it. When a reinforcement member 21 is provided in the recess part 20a on the surface of the protrusion piece 18a, the engagement between the protrusion piece 18a and the hole 38a can be done with certainty even when the thickness of the paper material is small. In the embodiment shown in FIG. 27(b), as opposed to the embodiment of FIG. 27(a), a protrusion piece 19a protruding towards the outside of the surrounding wall 13 is provided, and a hole 39a is provided on the side wall 7 of the swell part 5. The protrusion piece 19a is arranged to engage with the hole 39a by fitting in the hole 39a. Reference sign 35 in FIG. 27(a) indicates a reinforcement member provided for the purpose of the reinforcement of the protrusion piece 19a on the recess part 20b of the protrusion piece 19a by methods such as application, according to needs.

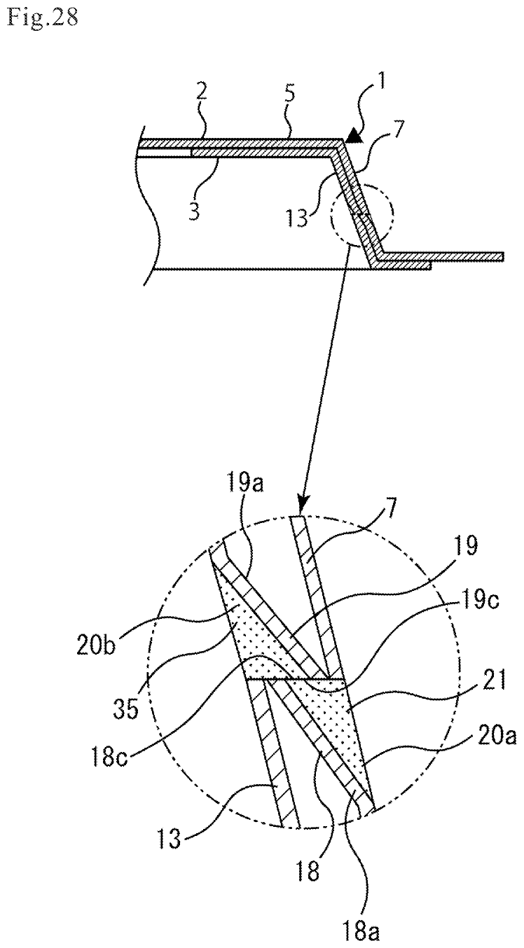

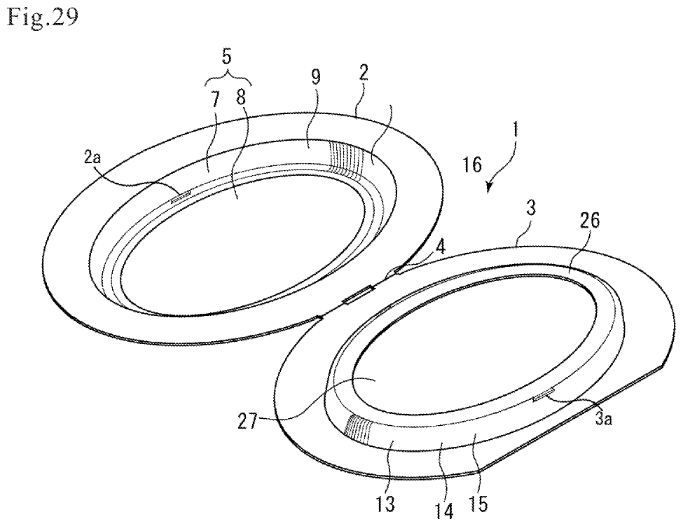

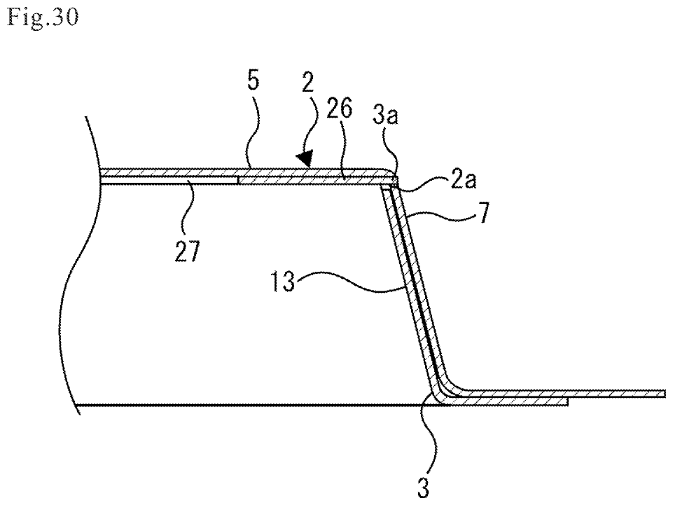

The embodiment shown in FIG. 28 is an example in which further changes have been made to the embodiment shown in FIG. 27. In this lid member 1, a protrusion piece 18a protruding in the direction of the surrounding wall 13 is formed on the side wall part 7 of the swell part 5 of the lid part 2, and a protrusion piece 19a protruding in the direction of the side wall part 7 is formed on the surrounding wall 13 of the substrate part 3. The closed lid state between the lid part 2 and the substrate part 3 is arranged to be maintained by the engagement between the protrusion piece 18a and the protrusion piece 19a. A reinforcement member 21 is provided by a method such as application on the recess part 20a formed on the surface side of the protrusion piece 18a, and a reinforcement member 35 is provided by a method such as application on the recess part 20b formed on the back side of the protrusion piece 19a. The reinforcement member 21 and the reinforcement member 35 are for reinforcing the protrusion piece 18a and the protrusion piece 19a, respectively. As the reinforcement member 21 and the reinforcement member 35, it is preferred to use, aside from the adhesives etc. as mentioned above, adhesives in which various types of fillers are mixed. As shown in FIG. 28, the protrusion piece 18a is arranged such that a gap is formed between the upper end part 18c as the end part and the side wall part 7, and the protrusion piece 19a is arranged such that a gap is formed between the lower end part 19c as the end part and the surrounding wall 13. The reinforcement members 21, 35 are exposed from this gap, and when the first protrusion part 18 and the second protrusion part 19 engage with each other when the lid is closed, the closed lid state is maintained in a state where the reinforcement member 21 and the reinforcement member 35 contact each other. Regarding the part of the first protrusion part 18 where the reinforcement member 21 is exposed and the part of the second protrusion part 19 where the reinforcement member 35 is exposed, these exposed surfaces of the reinforcement member 21 and the reinforcement member 35 tend to be a rough, textured surface in which small bumps and dents are present, instead of a smooth surface. Accordingly, when the reinforcement member 21 and the reinforcement member 35 engage with each other when the lid member 1 is closed, the friction resistance by the textured surfaces of the reinforcement member 21 and the reinforcement member 35 is increased, allowing to better maintain the closed lid state and increase the air tightness. FIG. 29 and FIG. 30 show another embodiment of the closing means of the lid member 1. In the lid member 1 in this embodiment, as the closing means, a hole part 2a is provided in the lid part 2 and a protrusion piece 3a is provided at a location where it can engage with the hole part 2a when the lid is closed. As shown in FIG. 30, the hole part 2a and the protrusion piece 3a engage with each other when the lid is closed and maintain the closed lid state. The hole part 2a and the protrusion piece 3a can be made by any known methods. However, it is preferred, in view of increasing the production efficiency of the lid part 1 and reducing the manufacturing costs, that they are formed during the process where the lid part 2 and the substrate part 3 etc. are formed when the lid member 1 is formed e.g. by press forming. In this case, it is preferred that the protrusion piece 3a is provided at the border part between the flange part 26 and the outer wall part 14 during the forming of the surrounding wall 13, and that the part where the protrusion piece 3a is to be formed is formed before the flange part 26 and the outer wall part 14 are formed by folding. As shown in FIG. 29, the outer wall 14 and the flange part 26 are bent with respect to each other. Accordingly, if the protrusion piece 3a is formed at the border part between the outer wall part 14 and the flange part 26, it becomes possible to form the protrusion piece 3a only by making the outer wall part 14 and the flange part 26. Preferably, the protrusion piece 3a and the vicinity of the protrusion piece 3a are treated to reduce the occurrence of e.g. peeling of the paper material constituting the protrusion piece 3a and to increase the durability, e.g. by applying a coating agent mentioned above.

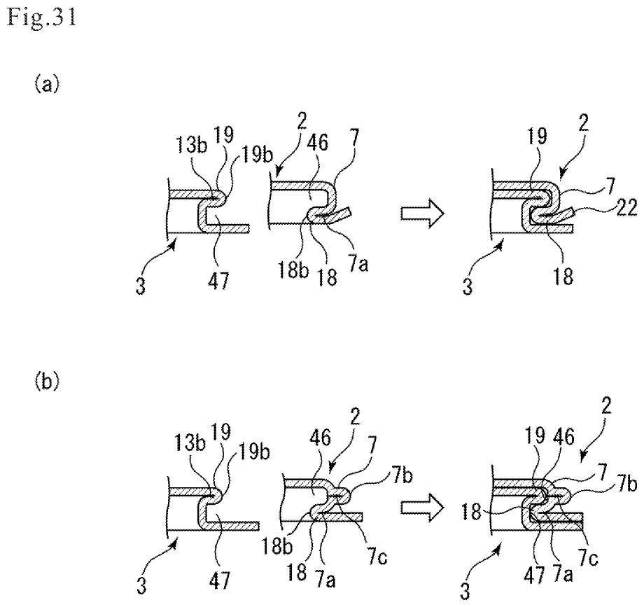

FIG. 31 shows an embodiment wherein a part of the side wall part 7 of the swell part 5 and a part of the surrounding wall 13 are folded to form a protrusion and a recess which engage each other. On the side wall 7 of the swell part 5, a first protrusion part 18 is provided by folding a part thereof inwardly. On the upper end of the surrounding wall 13, a second protrusion part 19 is provided by folding thereof outwardly. The first protrusion part 18 and the second protrusion part 19 may be provided by folding e.g. by pinching and compressing the parts where these are to be formed.

The embodiment shown in FIG. 31(a) is an example where a first protrusion part 18 and a first engaging part 46 are formed on the side wall part 7 of the lid part 2 and a second protrusion part 19 and a second engaging part 47 are formed on the surrounding wall 13 of the substrate part 3. The first protrusion part 18 comprises an inner end part 18b. The inner end part 18b is an end part of the side wall part 7 formed by folding inwardly and subsequently folding outwardly. By the provision of the inner end part 18b, the side wall part 7 is provided with a folded part 7a formed by folding the paper material constituting said side wall part 7. In this folded part 7a, a plurality of papers is stacked by the folding. These stacked paper materials may be used as is, but it is preferred that the stacked paper materials are adhered and fixed to each other by e.g. adhesives in order to increase the strength of the folded part 7a and the first protrusion part 18 and the durability against the repeated opening and closing actions. The first engaging part 46 is provided at a location different from the location at which the first protrusion part 18 is provided. In this embodiment, the first engaging part 46 is provided at a higher location than the first protrusion part 18 and the first engaging part 46 is arranged such that the second protrusion part 19 can be inserted therein and engage with it.

The surrounding wall 13 is provided with a second protrusion part 19 protruding outwardly from the surrounding wall 13. This second protrusion part 19 is formed as an outwardly protruding protrusion. This second protrusion part 19 comprises an outer end part 19b. The outer end part 19b is formed at the location continuing from the top wall 11 to the surrounding wall 13 by folding such that it protrudes outwardly. By the provision of the outer end part 19b, the surrounding wall part 13 is provided with a folded part 13b formed by folding the paper material constituting said side wall part 13 (paper material for making the substrate part 3). In this folded part 13b, a plurality of papers is stacked by the folding. These stacked paper materials may be used as is, but preferably, as mentioned above, they are compressed by applying a force which integrates the plurality of paper materials or they are adhered and fixed to each other by e.g. adhesives, in order to increase the strength of the folded part 13b and the second protrusion part 19 and the durability against the repeated opening and closing actions. A second engaging part 47 is provided at a location different from the location at which the second protrusion part 19 is provided. In this embodiment, the second engaging part 47 is provided at a lower location than the second protrusion part 19 and the second engaging part 47 is arranged such that the first protrusion part 18 can be inserted therein and engage with it.

The embodiment shown in FIG. 31(b) is a different embodiment of the example wherein a first protrusion part 18 and a first engaging part 46 are provided on the side wall part 7 of the lid part 2 and a second protrusion part 19 and a second engaging part 47 are provided on the surrounding wall 13 of the substrate part 3. In this embodiment, a first protrusion part 18 protruding more inwardly than the side wall part 7 is provided e.g. by folding a part of the side wall part 7 and an outer folded part 7b is provided e.g. by folding a part of the side wall 7, thereby providing a first engaging part 46. The first protrusion part 18 is formed as an inwardly protruding protrusion. The inner end part 18b provided on the first protrusion part 18 is provided e.g. by folding the side wall part 7 as described above. By the provision of the inner end part 18b, the folded part 7a described above is formed. Regarding this folded part 7a, as described above, the plurality of paper materials may be used as is, or the plurality of paper materials may be firmly compressed until they are integrated. The plurality of paper materials may be adhered and fixed to each other by adhesives. The first engaging part 46 is provided at a higher location than the first protrusion part 18 and as described above, is formed by forming the outer folded part 7b in the side wall part 7. Also regarding this outer folded part 7b, in the similar manner as the folded part 7a, the plurality of paper materials may be used as is, or the plurality of paper materials may be firmly compressed until they are integrated, as described above. In the folded part 7a and the outer folded part 7b, the plurality of paper materials may be adhered and fixed to each other by adhesives. It is preferred that the plurality of paper materials are compressed to be integrated or they are joined to each other by e.g. adhesives from the viewpoint of increasing the overall strength and increasing the durability against the repeated opening and closing actions.

The first protrusion part 18 and the second protrusion part 19 as the closing means may be provided by folding the upwardly protruding closing part sideways or be directly formed sideways. The direction in which the first protrusion part 18 and the second protrusion part 19 as the closing means are formed may be decided in any way, and it can be in any direction as long as the lid part 2 can close with respect to the substrate part 3. When the lid is closed, the closed lid state can be maintained by the engagement of each of the first protrusion part 18 provided on the lid part 2 and the second protrusion part 19 provided on the substrate part 3. In this case, it is preferred that the first protrusion part 18 provided on the lid part 2 is positioned lower than the second protrusion part 19 provided on the substrate part 3 and the locking is achieved by the engagement at the first protrusion part 18 and the engagement of the second protrusion part 19.

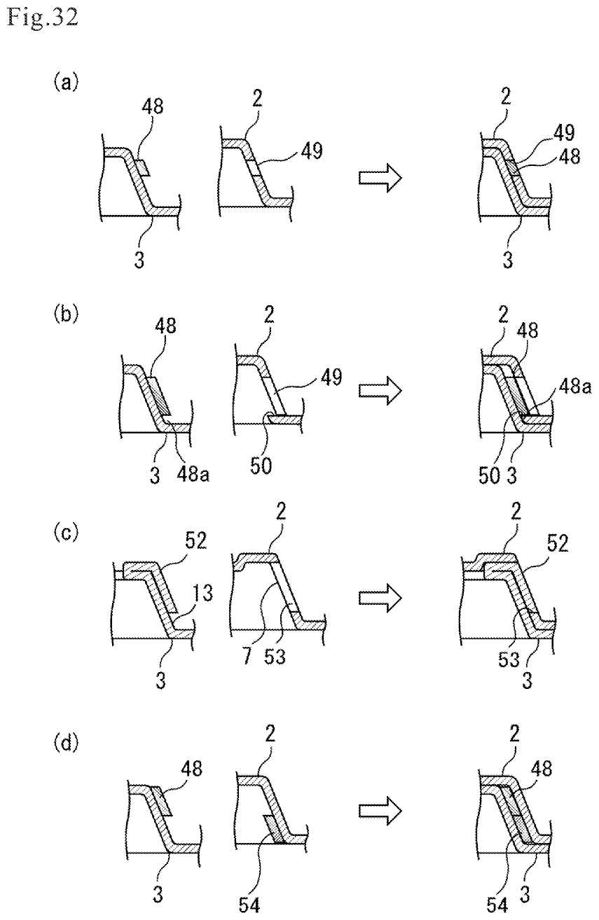

FIG. 32 shows a different embodiment of the closing means, which is an embodiment wherein the closing means is made by attaching a piece member on the lid part 2 and/or the substrate part 3. In FIG. 32(a), the lid part 2 is provided with an engagement hole 49 and the substrate part 3 is provided with a first piece member 48. When the lid closes, the first piece member 48 fits in and engages with the engagement hole 49, thereby maintaining the closed lid state of the lid part 2. In this embodiment, the lid part may be provided with a piece member corresponding to the first piece member 48 and the substrate part 3 may be provided with an engagement hole corresponding to the engagement hole 49. In FIG. 32(b), the lid part 2 is provided with an engagement hole 49 and an engagement piece part 50 is formed at the lower end part of this engagement hole 49. This engagement piece part 50 may be formed as one piece when the engagement hole 49 is formed on the side wall part 7, or the engagement piece part 50 may be attached afterwards. However, from the viewpoint of maintaining the durability against the repeated opening and closing, it is preferably formed as one piece. The substrate part 3 is provided with a first piece member 48. Below this first piece member 48, a space 48a is formed into which the above-described engagement piece part 50 is able to enter. In this embodiment, when the lid is closed, the engagement piece part 50 enters the space 48a formed below the first piece member 48 and the lower end of the first piece member 48 engages with the engagement piece part 50. The lid part 2 can thereby maintain its closed lid state. In FIG. 32(c), the lid part 2 is provided with an engagement hole 53 and the substrate part 3 is provided with a pawl member 52 made into a claw shape by folding a part of the paper material forming the substrate part 3. This pawl member 52 is folded to cover a part of the surrounding wall 13 and the flange part 26 in the substrate part 3. The location at which the folded part is formed in the surrounding wall 13 as well as the shape and the size thereof correspond to the engagement hole 53. When the lid is closed, the pawl member 52 fits in and engages with the engagement hole 53 of the lid part 2, thereby maintaining the closed lid state of the lid part 2. In FIG. 32(d), the lid part 2 is provided with a second piece member 54 and the substrate part 3 is provided with a first piece member 48. The first piece member 48 is provided at a location which would be higher than the second piece member 54 when the lid is closed. When the lid member 2 is closed, the lower end of the first piece member 48 and the upper end of the second piece member 54 engage, thereby maintaining the closed lid state of the lid part 2.

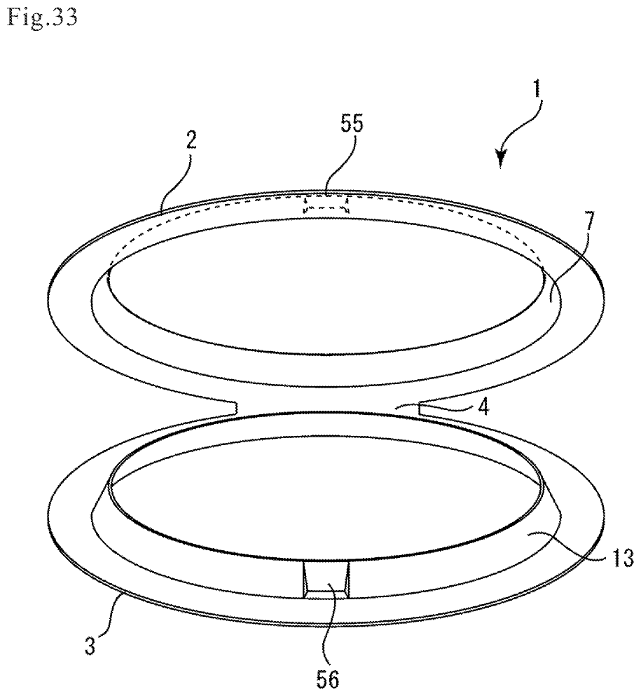

FIG. 33 shows an example of the lid member 1 comprising a different example of the closing means. In this lid member 1, as the closing means, the swell part 5 of the lid part 2 is provided with a locking part 55 and the surrounding wall 13 is provided with a lock receiving part 56. The locking part 55 is provided on the side wall part 7 of the swell part 5 and is tapered in the opposite direction from the taper of this side wall part 7. In other words, while the taper of the side wall part 7 is tapered upwardly the taper of the engaging part 55 is tapered downwardly. Since the locking part 55 is tapered at a different angle from the taper of the side wall part 7 in this way, it protrudes towards the inner wall 9 of the side wall part 7.

The surrounding wall 13 of the substrate part 3 is provided with a lock receiving part 56 at the location which, when the lid part 2 is closed, corresponds to the location at which the above-described locking part 55 is provided. The shape of the lock receiving part 56 is a shape which corresponds to the inward protrusion from the inner wall 9 of the side wall part 7. By the locking member 55 and the lock receiving part 56 engaging with each other when the lid is closed, they function as the closing means, i.e. when the lid part 2 is closed this closed lid state can be maintained.

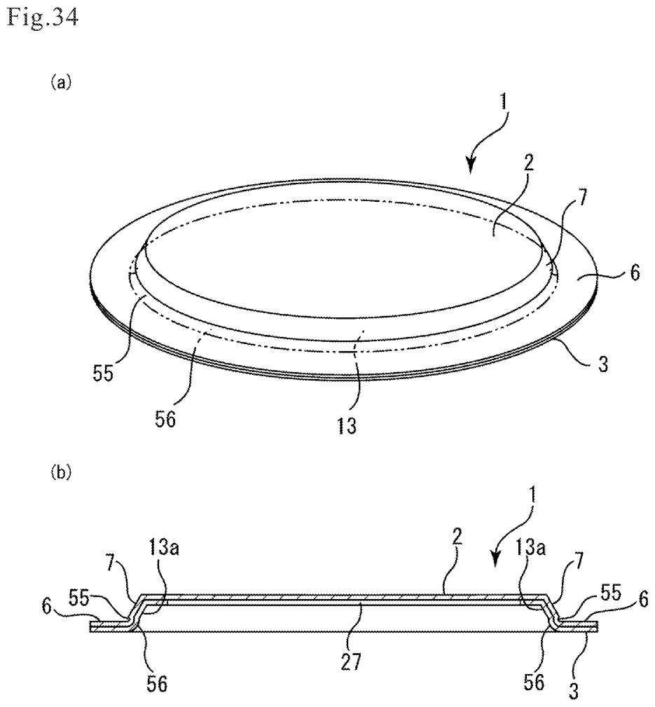

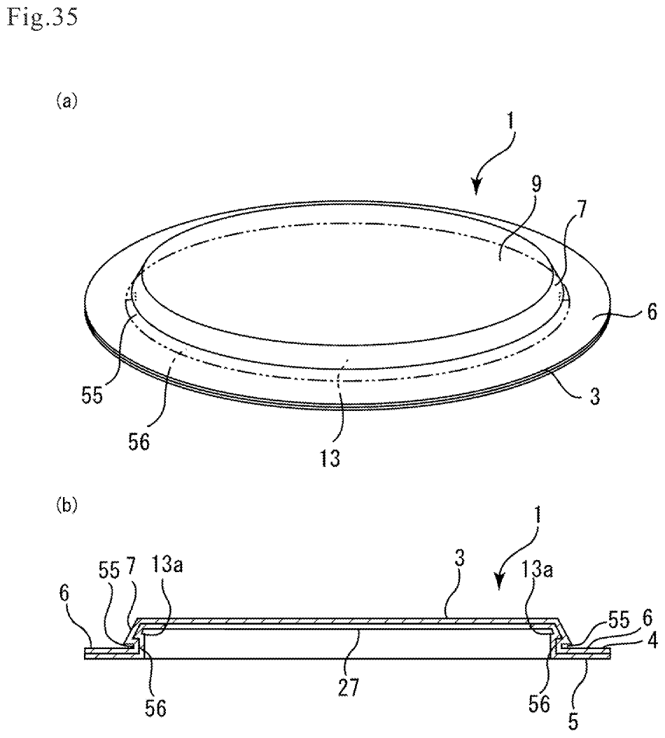

In the lid part 1 shown in FIG. 34 and FIG. 35, the closing means is made around its circumference. In the lid member 1 shown in FIG. 34 and FIG. 35, as the closing means, a locking member 55 is provided around the circumference of the side wall part 7 of the swell part 5 of the lid part 2 and a lock receiving part 56 is provided around the circumference of the surrounding wall 13 of the substrate part 3. The closed lid state is maintained by the locking part 55 engaging with the lock receiving part 56. The shape and the location of the locking part 55 and the lock receiving part 56 described in relation to FIG. 34 and FIG. 35 are merely an example. As long as the locking part 55 and the lock receiving part 56 engage with each other to be locked and the lid part 2 can maintain the closed lid state to the substrate part 3, it is not limited to the structure described above. The locking part 55 and the lock receiving part 56 may be formed when the lid member forming body 42 is e.g. pressed or at another timing such as after the swell part 5 and the surrounding wall 13 are formed. They can be formed at other timings of choice. The locking part 55 and the lock receiving part 56 are not limited to those formed continuously, and they can be intermittent such as at both left and right sides, or the locking parts 55 and the lock receiving parts 56 may be provided at a predetermined interval.

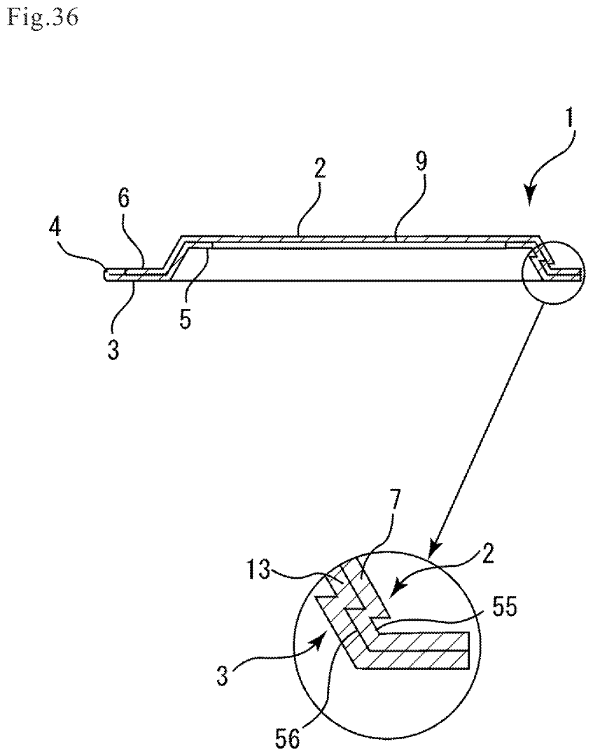

FIG. 36 shows a diagram representing the cross section of another example of the lid member 1 comprising a closing means. In this lid member 1, a locking part 55 and a lock receiving part 56 are provided at a part of the lid part 2 and the substrate part 3. In other words, in the closing means shown in FIG. 36, the locking part 55 and the lock receiving part 56 are provided at the location opposite the location at which the folding part 33 of the hinge part 4 is provided in the lid part 2 and the substrate part 3. The locking part 55 is provided to protrude inwardly from a location of the swell part 5 closer to the outer circumference part 6, and the lock receiving part 56 is provided as a recess at the location of the surrounding wall 13 closer to the attaching part 25, where it corresponds with the locking part 55 when the lid is closed. In FIG. 36, an example is shown in which the locking part 55 and the lock receiving part 56 are rectangular, but the shapes of the locking part 55 and the lock receiving part 56 are not limited thereto. As long as the lid part 2 and the substrate part 3 are locked by the locking part 55 and the lock receiving part 56 engaging with each other such that the state in which the lid part 2 is closed with respect to the substrate part 3 is maintained, they can have other shapes.

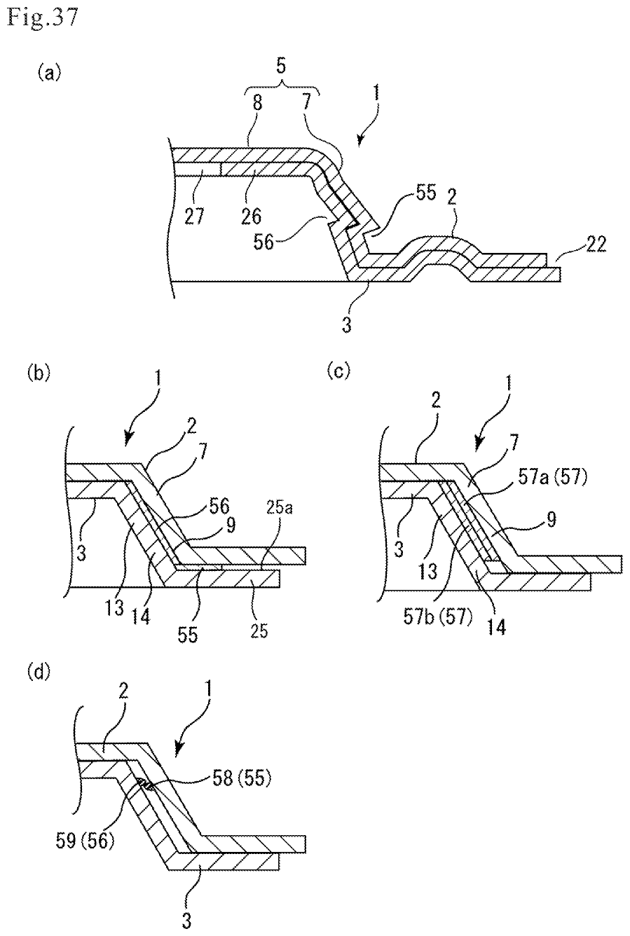

FIG. 37(a) shows another example of the closing means formed between the side wall part 7 of the swell part 5 of the lid part 2 and the outer wall 14 of the surrounding wall 13 of the substrate part 3 of the lid member 1. The side wall part 7 is provided with a locking part 55 which protrudes inwardly and the outer wall 14 is provided with a lock receiving part 56 in the form of a recess. In the example shown in FIG. 37(a), the locking part 55 and the lock receiving part 56 have a so-called wedge shape. In this way, the closing means by the engagement of the wedge-shaped locking part 55 and lock receiving part 56 can maintain the closed state of the lid part with more certainty.

FIG. 37(b) shows another example of the closing means of the lid member 1. In the closing means shown in FIG. 37(b), one of the lid part 2 and the substrate part 3 (the lid part 2 in FIG. 37(b)) is provided with a locking part 55 and one of the lid part 2 and the substrate part 3 (the substrate part 3 in FIG. 37(b)) is provided with a lock receiving part 56. The locking member 55 is provided with an edge part which protrudes more inwardly than the inner wall 9 of the side wall part 7, the lock receiving part 56 is positioned higher than the upper surface 25a of the attaching part 25 of the substrate part 3, and a gap having a width which allows the locking part 55 to enter is formed between the lock receiving part 56 and the upper surface 25a of the attaching part 25. When the closed lid state is maintained in the lid member 1, the end part of the locking part 55 enters the gap formed between the lock receiving part 56 and the upper surface 25a of the attaching part 25, and by the locking of the locking part 55 and the lock receiving part 56, the state in which the lid part 2 is closed with respect to the substrate part 3 can be maintained.

In this case, the locking part 55 and the lock receiving part 56 may be formed using the same material as the lid member 1 or may be formed using a different material. The material different from the lid member 1 is preferably one which can lock with each other when the locking part 55 and the lock receiving part 56 are formed, which has a certain durability and which can be joined with the lid part 2 and the substrate part 3. As long as they are such materials, publicly known ones may be freely selected and used without being particularly limited.

Examples of the materials used as the locking part 55 and the lock receiving part 56 which are different from the material of the lid member 1 include various plastic materials such as polyimide resin, fluororesin, polyamide resin, polyaramide resin, polyether sulfone resin, polyether ketone resin, polyether ether ketone resin, polyethylene naphthalate resin, and polyester resin, polyolefin resin, polyethylene terephthalate (PET) or the like may be used. Materials with natural degradability as exemplified above may also be freely selected and used.

In this way, by providing the locking part 55 and the lock receiving part 56 and locking the locking part 55 and the lock receiving part 56, the state in which the lid part 2 is closed with respect to the substrate part 3 with certainty can be strongly maintained. Also, since the locking part 55 and the lock receiving part 56 are highly durable, it becomes also possible to provide a lid member 1 which can withstand a repeated opening and closing action of the lid part 2 of the lid member 1.

In this example, explanations have been given using an example in which the locking part 55 is provided on the inner side of the lid part 2 and the lock receiving part 56 is provided on the outer wall surface 15 of the surrounding wall 13 of the substrate part 3. However, this is not limiting and the lid part 2 may be provided with the lock receiving part 56 and the substrate part 3 may be provided with the locking part 55, and the locking part 55 and the lock receiving part 56 may be provided by other methods.

FIG. 37(c) shows another example of the closing means of the lid member 1. In the lid member 1, a hook-and-loop fastener 57 (also called Magic Tape (registered trademark)) as a sealing member are joined to the lid part 2 and the substrate part 3. As the method of joining, conventionally known joining methods can be freely selected and applied such as heat sealing; ultrasonic bonding; low frequency bonding; high frequency bonding; joining by various adhesives such as hot melt. In FIG. 37(c), this hook-and-loop fastener 57 is made of a hook-and-loop fastener 57a joined to the inner wall 9 of the side wall part 7 of the lid part 2 and a hook-and-loop fastener 57b also joined to the outer wall 14 of the surrounding wall 13 of the substrate part 3. As these hook-and-loop fasteners 57a, 57b, typically there are a seal part having a male shape and a seal part having a female shape, and typically a seal part having a male shape and a seal part having a female shape are joined to each other. However, in the lid member 1 here, as the hook-and-loop fasteners 57a, 57b used, it is preferred to use the same shape such as joining the male-shape and the male-shape or joining the female-shape and the female-shape. By using the hook-and-loop fasteners 57a, 57b of the same shapes like this, in the joining between the inner wall 9 of the side wall part 7 and the outer wall 14 of the surrounding wall 13 of the substrate part 2 in the lid member 1, the hook-and-loop fasteners 57a, 57b are easier to join with each other when the lid is closed, and the closed lid state of the lid member 1 becomes easier to maintain. In this lid member 1, an example is used wherein hook-and-loop fasteners 57a and 57b are respectively joined to the inner wall 9 of the side wall part 7 of the swell part 5 and the outer wall 14 of the surrounding wall 13. However, as long as the state in which the lid member 2 is closed with respect to the substrate 3 can be maintained, other examples may be used. As mentioned above, the hook-and loop fasteners 57a, 57b do not have to be joined to both sides as mentioned above. The hook-and loop fastener 57 may be joined only to either the lid part 2 or the substrate part 3. The hook-and loop fastener 57 may be joined to one of the lid part 2 and the substrate part 3 and a component different from a hook-and loop fastener 57 may be joined to the other one of the lid part 2 and the substrate part 3.

As the example shown in FIG. 37(c), a component different from the hook-and-loop fastener 57 may be used. For example, a component having a predetermined thickness may be provided on the inner wall 9 of the side wall part 7 of the lid part 2 and the outer wall 14 of the surrounding wall 13 of the substrate part, e.g. using a board member, a film agent or a film of various materials as described above or various types of coating agent (application agent) or ink. Furthermore, various types of resin materials may be used. As the board member, film agent, film, coat agent (coating agent) and various resin materials, those already mentioned in the present specification may be suitably used. When various types of a resin material are used as the above-mentioned member having a predetermined thickness, those that are liquid upon application and are cured under predetermined conditions (e.g. temperature and UV radiation) are preferred. For example, in this case, it is preferred to use a UV coating agent which is liquid upon application and which is cured by irradiating a UV ray. Since a UV coating agent is cured by irradiating a UV ray, it is easily joined to the paper material constituting the lid part 2 and the substrate part 3 and it can be made to have a predetermined film thickness after curing, hence the production efficiency can be increased. As it can be cured by UV irradiation, it can be cured in a state where the influence to the lid member 1 as a whole is relatively small. Furthermore, by forming a member having a predetermined thickness, the inner wall 9 of the side wall part 7 of the swell part 5 and/or the outer wall 14 of the surrounding wall 13 may be partially reinforced. In the lid member 1, opening and closing actions between the lid part 2 and the substrate part 3 are generally often repeated, and thus the parts where the locking part 55 and the lock receiving part 56 are formed in particular may require strength. In this case, by applying and curing the above-mentioned UV coating agent on the parts where the locking part 55 and the lock receiving part 56 are formed, the strength of these parts can be substantially increased, and the durability against the repeated use, in particular the repeated use of the opening and closing actions, can be substantially increased.

In the above-mentioned example, explanations were given using an example wherein a UV coating agent was used as the component having a predetermined thickness and wherein the UV coating agent was applied and cured on both the inner wall 9 of the side wall part 7 of the swell part 5 and the outer wall 14 of the surrounding wall 13 of the substrate part 3. However, this is not limiting. For example, the UV coating agent may be applied and cured on only one of the inner wall 9 and the outer wall 14, and the coating agent to be used is not limited to a UV coating agent and the various types of coating agent mentioned above in the present specification may be freely used. In the above explanation, explanations were given using an example wherein the various types of coating agent mentioned above are used at positions where the locking part 55 and the lock receiving part 56 as the closing means are provided, but this is not limiting. For example, in the lid member 1, as the reinforcement of the parts which require a certain level of strength, various types of coating agent may be used for reinforcement in the manner as described above. The thickness of the various types of coating agent may be freely determined depending on the degree of strength to be reinforced. By setting the thickness freely in this manner, the degree of the friction resistance between the lid part 2 and the substrate part 3 may be adjusted or increased or decreased. Accordingly, it becomes possible to easily adjust how strongly the lid part 2 closes.

Aside from the examples mentioned above, various coating agents such as UV coating agent and various types of adhesives may be used. As the adhesive, any known one may be used but it is preferred to use e.g. a hot melt adhesive. A hot melt adhesive is an adhesive to be adhered to the subject by being heated and melted when adhered, and is a solid at room temperature. As the hot melt adhesive, there are for example ethylene vinyl acetate (EVA) hot melt, olefin hot melt, rubber hot melt, polyamide (nylon) hot melt, polyester hot melt, polyurethane hot melt, etc., and they can be suitably used depending on the intended usage and the properties (for example viscosity). Regarding the method of applying hot melt adhesive, there are for example spray application (for example, curtain spray, spiral spray, etc.), coat (for example, slot coat, E. coat, design coat, pattern coat, etc.), foaming melt, beat/dot, ZIP coat in which hot melt is applied in a Z-shaped pattern, WAVE coat in which hot melt is applied in a random pattern, and application with a comb gun. Also by applying and curing the hot melt adhesive in these ways, the friction resistance between the inner wall 9 of the side wall part 7 of the swell part 5 and the outer wall 14 of the surrounding wall 13 can be increased, and using the viscosity of the hot melt adhesive, the closed lid state of the lid part 2 can be more easily be maintained.

For the viscosity etc. of the hot melt adhesive, known ones may be freely used as mentioned above. For example, by using the above-mentioned high viscosity ones, the closed lid state of the lid part 2 with respect to the substrate part 3 in the lid member 1 may be maintained, or the closed lid state of the lid part 2 may be maintained using a hot melt adhesive having a repeelable, readhesible property.

FIG. 37(d) shows another example of the closing means of the lid member 1. In this lid member 1, a locking part 55 and a lock receiving part 56 as a closing means are formed in the lid part 2 and the substrate part 3. The locking part 55 and the lock receiving part 56 in this example are formed as locking pieces and the locking part 55 and the lock receiving part 56 are provided at locations where they can lock with each other when the lid is closed. Specifically, the locking piece 59 which is to be the lock receiving part 56 is configured to be located higher than the locking piece 58 which is to be the locking part 55. The locking piece 58 as the locking part 55 and the locking piece 59 as the lock receiving piece 56 may be provided using e.g. a board material or a coating agent described above, and also may be formed by applying various adhesives such as hot melt adhesive followed by curing. In this way, by using various types of adhesives, it becomes easy to use a naturally degradable material and to give the function as a closing means. Also, by forming a locking piece 58 as the locking part 55 and a locking piece 59 as the lock receiving part 56, the friction resistance between the lid part 2 and the substrate part 3 can be increased. Accordingly, it becomes possible to provide a lid member 1 wherein the closed lid state of the lid part 2 can be maintained with more certainty and which has a good sealability.

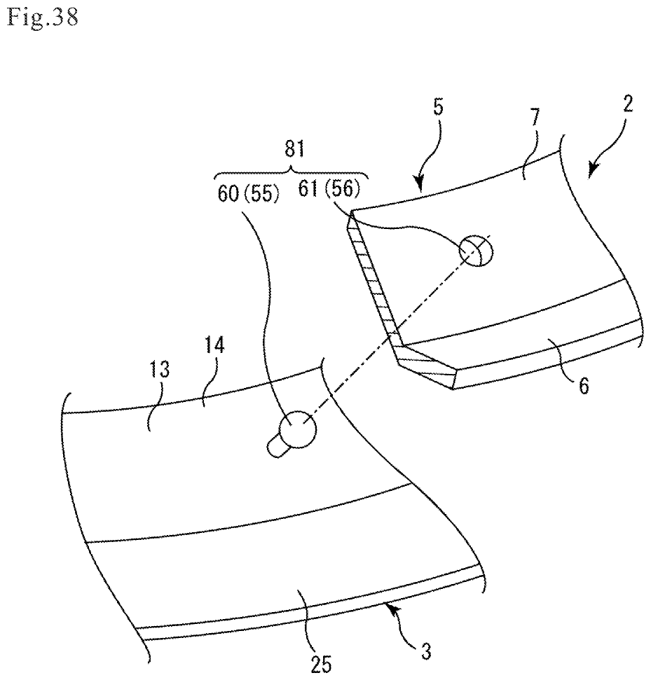

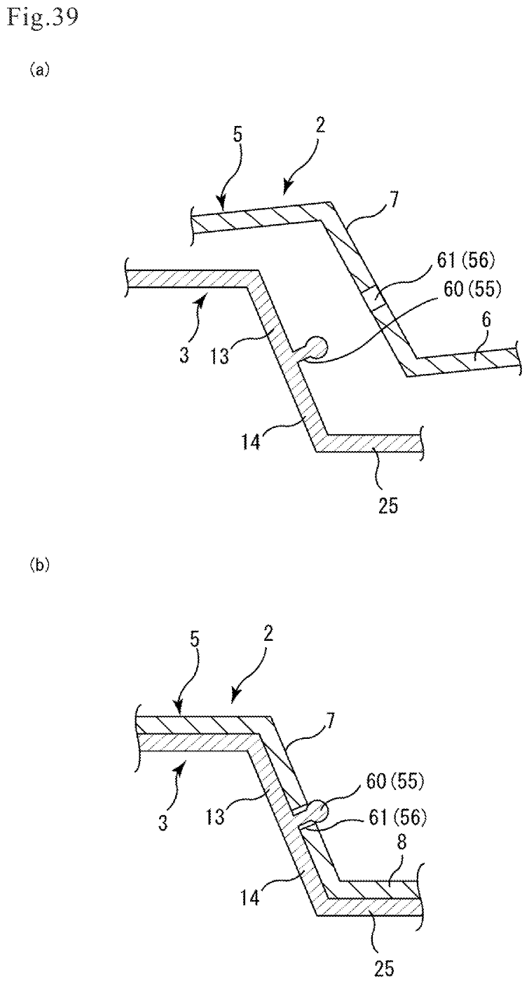

FIG. 38 shows yet another example of the closing means of the lid member 1 and is a schematic diagram of an example of the closing means wherein the lid part 2 and the substrate 3 are closed (enlarged perspective view with a part cut out). FIG. 39 shows a schematic diagram of the lid member 1 of this example representing the state of the closing means wherein the lid part 2 and the substrate part 3 are open and FIG. 39(b) shows the state of the closing means when the lid part 2 and the substrate part 3 are closed. The closing means in this example is made of a protruded part 60 as the locking part 55 provided on the outer wall 14 of the swell part 13 and a through hole 61 as the lock receiving part 56 provided on the side wall part 7. When the lid is closed, this protruded part 60 is inserted in the through hole 61 and the inserted state can be maintained by the tip of the protruded part 60. Also by this example, it becomes possible to maintain the closed lid state of the lid part 2 and the substrate part 3 by the closing means. In FIG. 38 and FIG. 39, explanations are given using an example wherein the closing means are provided on the side wall part 7 of the swell part 5 of the lid part 2 and the outer wall 14 of the surrounding wall 13 of the substrate part 3, but the locations where the closing means are provided are not limited to the example explained. For example, it is possible to provide a protruded part 60 on either one of the outer circumference part 6 of the lid part 2 and the attaching part 25 of the substrate part 3 and provide a through hole 60 on the other one of the outer circumference part 6 and the attaching part 25, or they can be provided at locations other than those mentioned above. The closing means herein may be provided on the side wall part 6 or the outer wall 14 integrally therewith, or a separately formed entity may be fixed thereto by e.g. suitable adhesion.

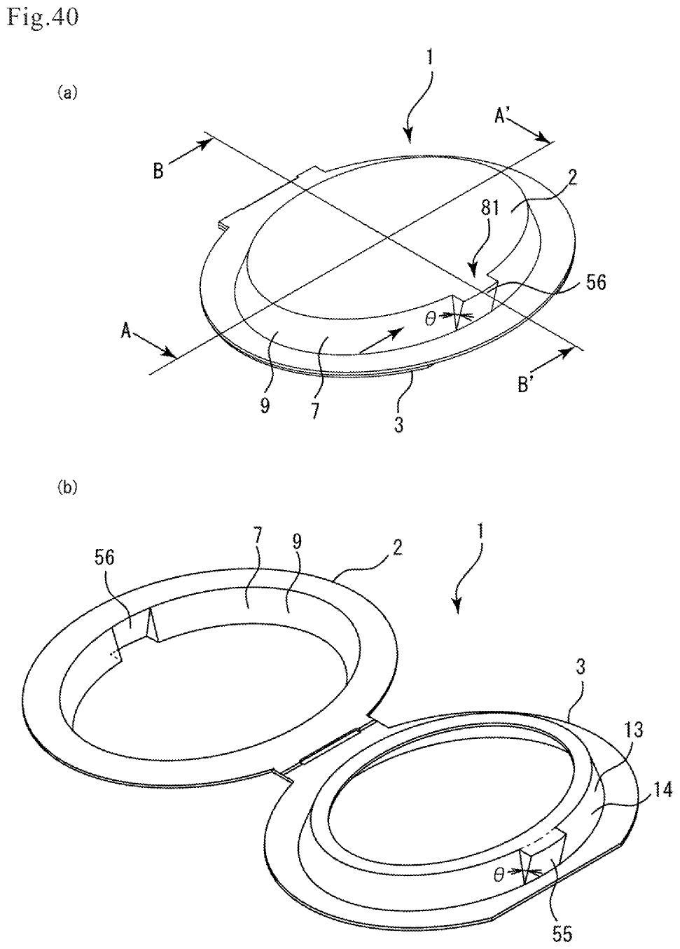

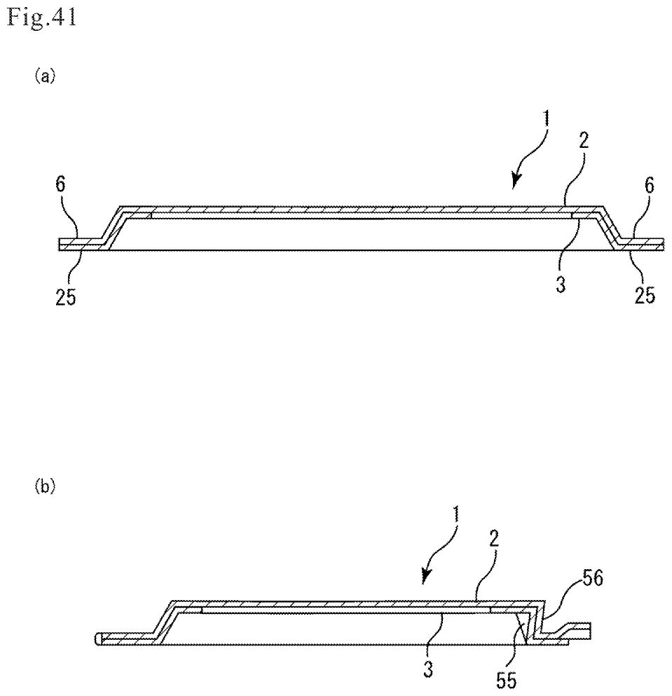

FIG. 40 to FIG. 42 show an yet further example of the closing means of the lid member 1. As shown in FIGS. 40 to 42, in the lid member 1, the lid part 2 is provided with a lock receiving part 56 and the substrate part 3 is provided with a locking part 55 as the closing means. The locking part 55 and the lock receiving part 56 are arranged to protrude towards the front. In other words, the locking part 55 is arranged to protrude towards the front further than the surrounding wall 13 of the substrate part 3, and similarly, the lock receiving part 56 is arranged to protrude towards the front further than the swell part 5 of the lid part 3. The locking part 55 and the lock receiving part 56 are arranged such that the locking part 55 and the lock receiving part 56 fit to each other when the lid is closed and the locking part 55 and the lock receiving part 56 maintain the closed lid state. In the lid member 1, the fitting of the locking part 55 and the lock receiving part 56 is disengaged when the lid is open.

As described above, the closing means is provided on the surrounding wall 13 of the substrate part 3 and the swell part 5 of the lid part 2. In the surrounding wall 13 and the swell part 5, the rising angle θ at the locations at which the locking part 55 and the lock receiving part 56 as the closing means are formed is different from the taper angle (this angle may also be referred as the rising angle when necessary) of the outer wall 14 of the surrounding wall 13 and the inner wall 9 of the side wall part 7 of the swell part 5. The predetermined rising angle in this case is preferably different from the taper angle of the inner wall 9 of the side wall part 7 and the outer wall 14 of the surrounding wall 13. Also, preferably, this rising angle θ is different from the taper angle of the inner wall 9 and the outer wall 14 and is equal to or less than the angle perpendicular to said taper angle.

The parts of the surrounding wall 13 and the swell part 5 at which the locking part 55 and the lock receiving part 56 as the closing means are formed are preferably formed such that their thicknesses decrease downwardly, i.e. towards the part of the surrounding wall 13 where the attaching part 25 is formed and towards the part of the swell part 5 where the outer circumference part 6 is formed, and more preferably are tapered. They may include tapered parts at least partially, and the locking part 55 and the lock receiving part 56 as this closing means may be provided at a plurality of locations. When the closing means is provided at a plurality of locations, the number thereof is not particularly limited.

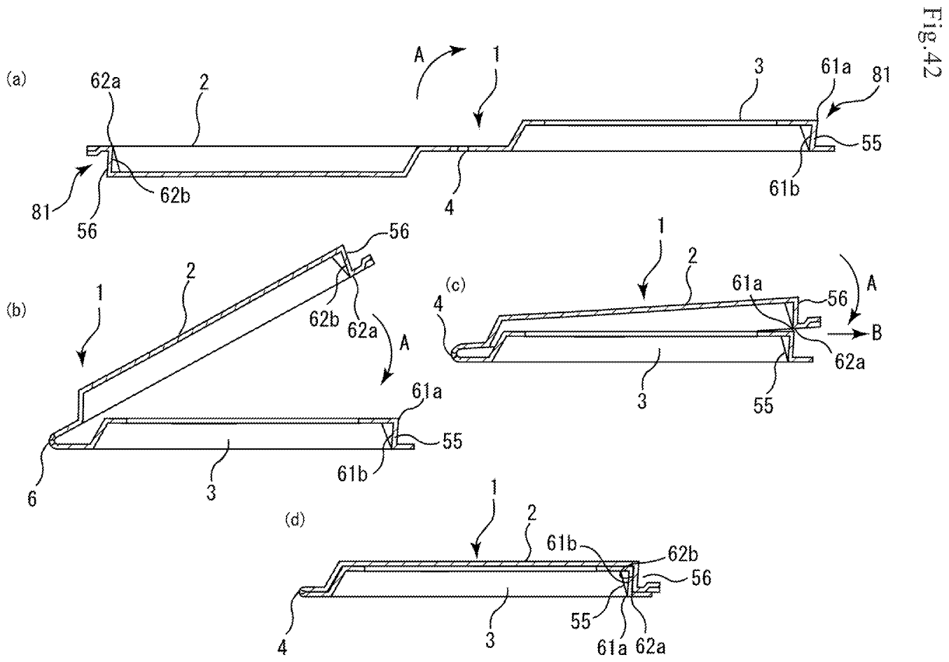

The actions wherein the lid part 2 of the lid member 1 is closed with respect to the substrate part 3 are explained based on FIG. 42. FIG. 42(a) shows a state of the lid member 1 in which the lid part 2 is open with respect to the substrate part 3. From this state, when the lid part 2 is rotated in the A direction shown in this figure around the hinge part 4, the lid part 2 rotates in the direction where the lid part 2 comes closer to the substrate part 3 as shown in FIG. 42(b). Then, as shown in FIG. 42(c), the lower end part 62a of the lock receiving part 56 of the lid part 2 abuts against the upper end part 61a of the locking part 55 of the substrate part 3. In this way, when a force is further applied in the A direction in the figure while the upper end part 61a of the locking part 55 and the lower end part 62a of the lock receiving part 56 abut against each other, the lock receiving part 56 deforms elastically and deforms in the B direction in the figure. Then, the lower end part 62a of the lock receiving part 56 results in being located at the outer circumference side of the upper end part 61a of the locking part 55, and when it is further rotated in the A direction in the figure, the lid is closed as shown in FIG. 42(d).

In the lid part 2 which closed after such actions, a part is formed wherein the inner surface 62b of the lock receiving part 56 and the outer surface 61b of the engaging part 55 contact each other, and a state is achieved wherein the outer surface 61b and the inner surface 62b contact each other. In this state, unless the user tries to rotate it in the direction opposite from A direction at a predetermined force, the lid part 2 does not rotate in the direction wherein the lid part 2 opens, and thus the closed lid state becomes more easily maintained and the sealability etc. of the lid member 1 is further improved.

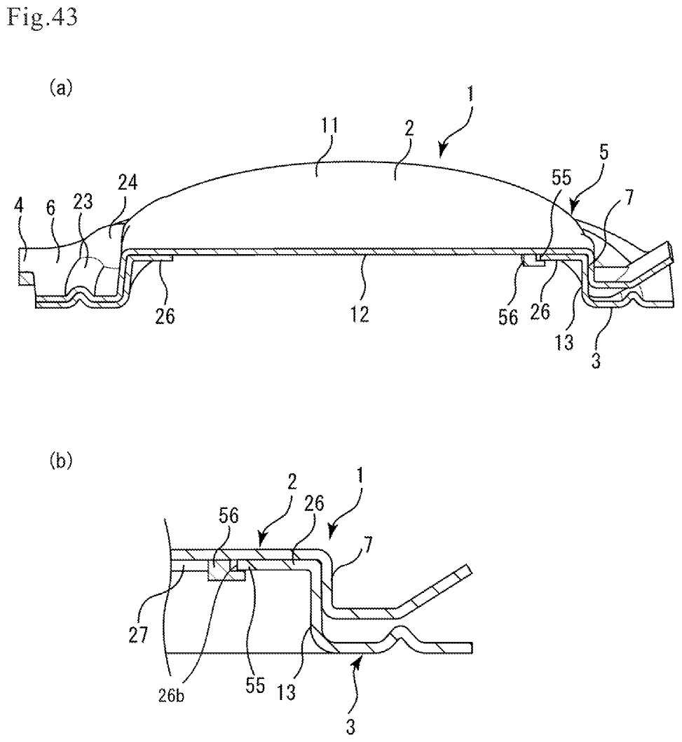

FIG. 43 shows a different example of the closing means of the lid member 1. FIG. 43(a) shows the overall cross section of the lid member 1 comprising the closing means of the present example, and FIG. 43(b) is a figure in which the part of the lid member 1 provided with the closing means is enlarged. In this lid member 1, the top surface 12 of the top wall 11 of the lid part 2 is provided with a lock receiving part 56. This lock receiving part 56 may be formed integrally when the top wall 11 is formed, or it may be formed as a separate element from the top wall 11 and may be fixed to the top wall 11. The lock receiving member 56 is arranged such that it can lock with the vicinity of the inner circumference 26b of the flange part 26 formed on the substrate part 3 when the lid is closed. In other words, in the lid member 1 of this example, the flange part 26 locks with the lock receiving part 56 and the inner circumference 26b of the flange part 26 functions also as a locking part 55. In this example, the lock receiving part 56 is formed to have a cross section having the shape of letter L and is arranged to be able to lock with the inner circumference 26b of the outer circumference part 6. However, as long as the closed lid state of the lid part 2 can be maintained, the location, the size and the shape etc. of the lock receiving part 56 are not limited. The lid member 1 of such example allows maintaining the closed lid state of the lid part 2 with certainty. Further, when the lid part 2 is opened or the lid part 2 is closed, the lock receiving part 56 engages with the locking part 5. Accordingly, when they are locked, the feeling of the opening and closing is maintained, and the feeling when they are locked and when the locking is disengaged can be felt by the user.

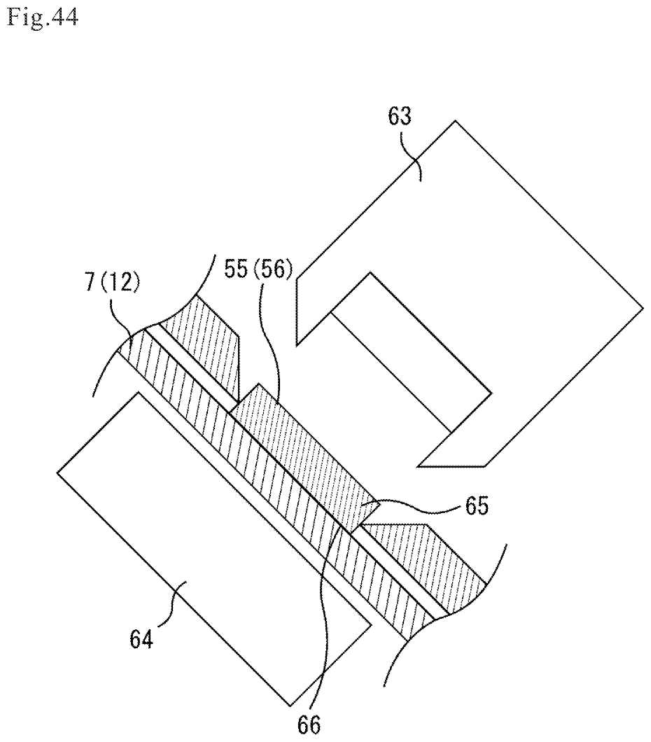

FIG. 44 shows a diagram showing an embodiment wherein a locking piece is used as the locking part 55 and/or the lock receiving part 56 provided for maintaining the closed lid state of the lid part 2, to explain how this locking piece is attached and fixed to the side wall part 7 of the lid part 2 and/or the surrounding wall 13 of the substrate part 3. As shown in FIG. 44, in this example, the piece member 65 which is to be the locking piece as the locking part 55 and/or the lock receiving part 56 is joined by ultrasonic bonding. In this case, the piece member 65 is made by cutting by e.g. diamond cutter, and a horn 63 or an anvil 64 is located at the back side of the lid part 2 and/or the substrate part 3 and an anvil 64 or a horn 63 is located at the front surface of the substrate part 3. The anvil 64 or horn 63 located on the front surface of the lid part 2 and/or the substrate part 3 is provided with a small hole 66 which is just enough for the piece member 65 to enter. The piece member 65 is positioned in this small hole 66 and is fused by ultrasound using the horn 63 and the anvil 64 to join the piece member 65.

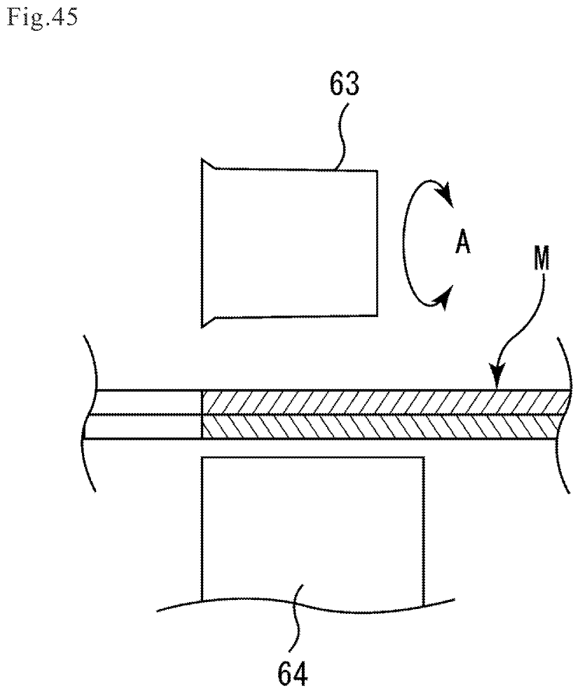

The horn 63 and the anvil 64 are not limited to the example described above. For example, it may, as shown in FIG. 45, comprise a horn 63 which is formed as a rotatable body which rotates in the A direction in the figure and which comprises a junction part 67 protruding like flange and an anvil formed as a stationary body, wherein the subject M to be bonded by ultrasonic is continuously bonded.

When making the lid member 1, it is preferred that linear grooves are provided before press forming since the press forming becomes easier. It is more preferable that, in the cases where the lid part 2 and the substrate part 3 are locked by the locking part 55 and the lock receiving part 56, the locking part 55 and the lock receiving part 56 are colored with a predetermined color and these colored parts are visible to the user when the lid part 2 and the substrate part 3 are locked. This allows the user to visibly determine that the locking part 55 and the lock receiving part 56 are locked and the lid part 2 and the substrate part 3 are closed.

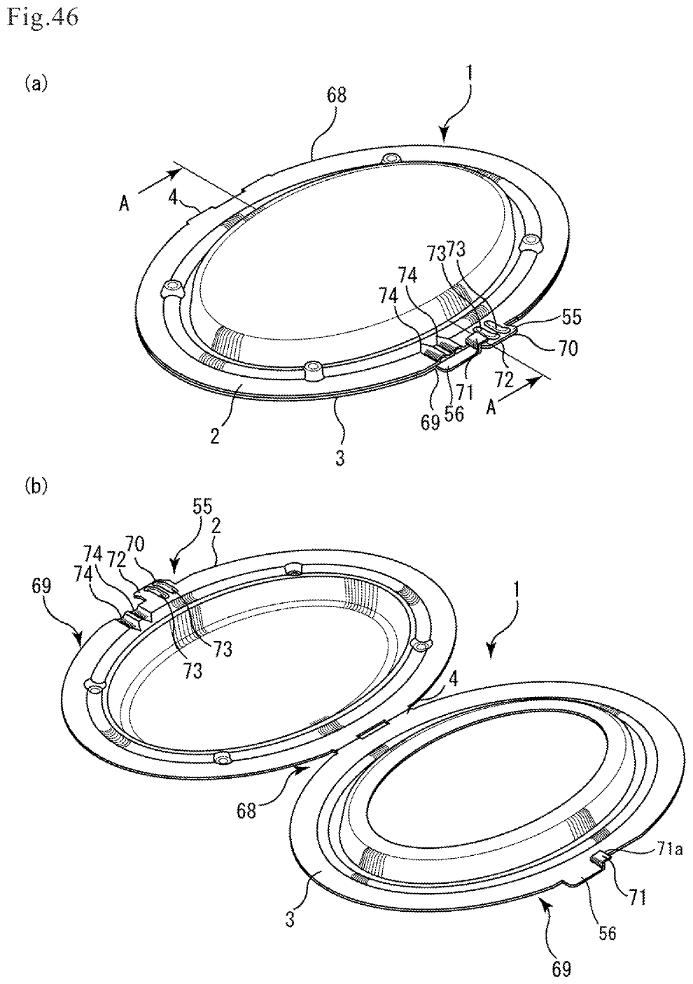

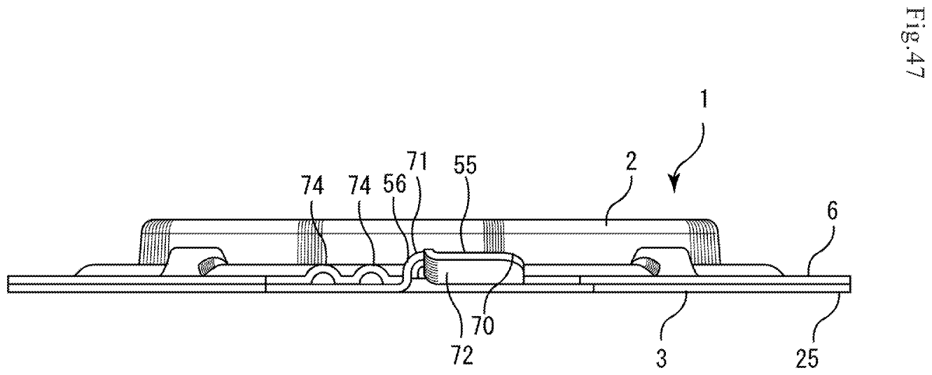

FIG. 46 and FIG. 47 show another example of the closing means of the lid member 1. In this lid member 1, at the edge part (hereinafter this edge part is referred as the tip part 69) on the opposite side from the side provided with the hinge part 4 (hereinafter the edge part provided with the hinge part 4 is referred as the base edge part 68) of the lid part 2 and the substrate part 3 is provided with a locking part 55 and a lock receiving part 56 as the closing means. In FIG. 46, one of the lid part 2 and the substrate part 3 (for example lid part 2) is provided with the locking part 55 and the other one of the lid part 2 and the substrate part 3 (for example substrate part 3) is provided with the lock receiving part 56. The locking part 55 is provided in the outer circumference part 6 of the lid part 2 at the tip part 69 of the lid part 2. The locking part 55 is formed as a piece which extends outwardly further than the outer circumference part 6 and the tip edge part 70 is provided with a tilted part 72. This tilted part 72 is for the purpose of preventing the protrusion for locking 71 provided in the lock receiving part 56 to come off when the locking part 55 is locked with the lock receiving part 56, and of making it easier to maintain the closed state of the lid part 2 and the substrate part 3. In this locking part 55, a plurality of (two in FIG. 46) ribs 73 are provided, and a plurality of ribs 74 are provided also at the location in the outer circumference part 6 in the vicinity of these ribs 73. These ribs 73, 74 can increase the strength of the locking part 55 and increase the durability when its locking and unlocking with the lock receiving part 56 are repeatedly performed.

The lock receiving part 56 is provided in the substrate part 3 at the location which can lock with the locking part 55 of the lid part 2 when the lid is closed. This locking part 56 is formed as a piece which extends outwardly further than the attaching part 25 and is provided with a protrusion for locking 71 to lock with the locking part 55 when the lid is closed. This protrusion for locking 71 is formed by bending in the shape of the letter L and the tip part 71 formed by bending is to be located higher than the locking part 55 when the lid is closed, thereby maintaining the closed lid state of the lid part 2. For opening the lid part 2, the locked state between the protrusion for locking 71 of the lock receiving part 56 and the locking part 55 is disengaged.

When a closing means of the example shown in FIG. 46 and FIG. 47 is formed, the closed state between the lid part 2 and the substrate part 3 is maintained at the edge part at the tip of the lid member 1, so it becomes possible to increase the air tightness of the lid part 1 when the lid is closed. In this example, the sizes of the locking part 55 and the lock receiving part 56 may be relatively freely selected, so strength can be easily imparted to the locking part 55 and the lock receiving part 56. Furthermore, in this embodiment, the closing means is provided at the tip part of the lid part 2 and the substrate part 3, so it improves the operability by the user and reduces the complication during the opening and closing actions.

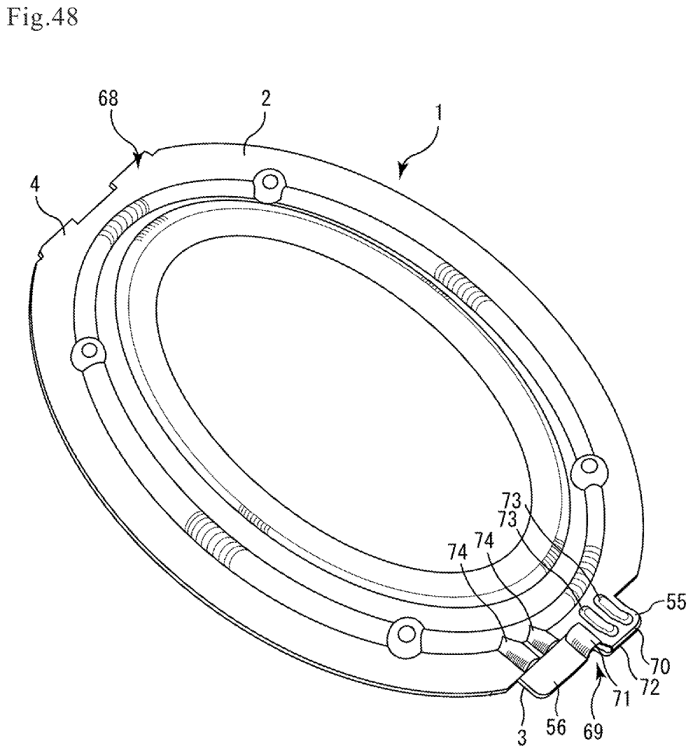

FIG. 48 shows another example of the closing means of the lid member 1. This example is provided with a locking part 55 and a lock receiving part 56 as the closing means having the same construction as those described previously based on FIG. 46 and FIG. 47, and in that sense the structure is similar to these. On the other hand, in the example previously explained, the oval shaped lid member 1 has the base edge part 68 at one end of the minor axis and the tip part 69 at the other end of the minor axis. In contrast, in this example, the oval shaped lid member 1 has the base edge part 68 at one end of the major axis and the tip part 69 at the other end of the major axis. The constructions are different in this respect. In the same way as in the example previously explained, the base end part 68 is provided with a hinge part 4 and the tip part 69 is provided with a locking part 55 and a lock receiving part 56 as the closing means.

By forming the hinge part 4 and the closing means in this manner, the state can be maintained in which the opening and closing actions of the lid part 2 of the lid member 1 are performed nicely while allowing to have a large size of the minor axis. In other words, also as explained in FIG. 1, also when the size of the bag body 102 in the package 101 is fixed, the size of the outlet 27 may be made larger compared to the lid member of the example explained previously within said fixed size, allowing to make it easier for the user to take out the laminate 103.

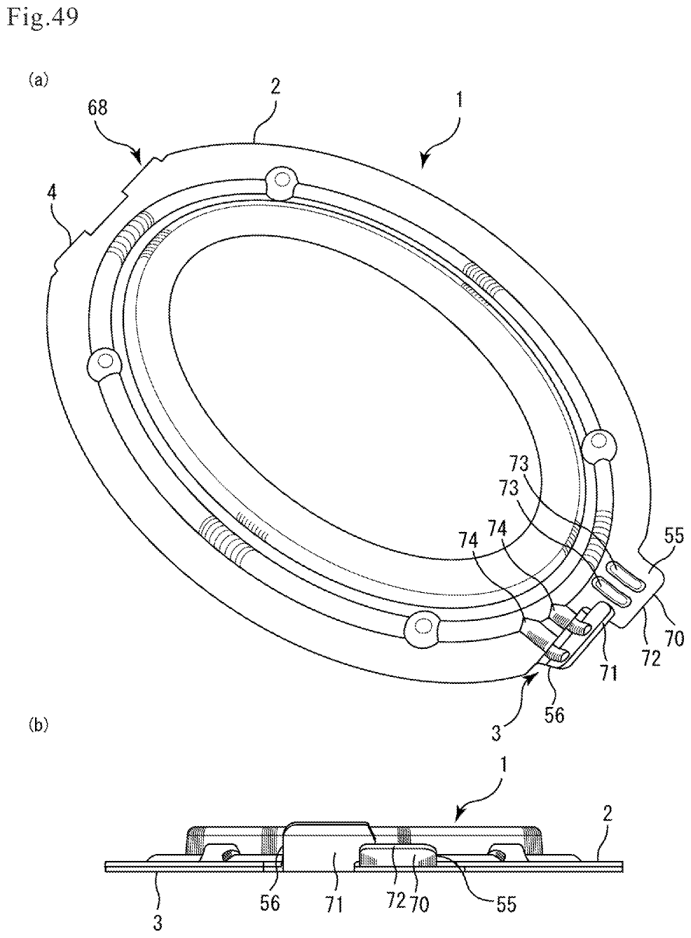

FIG. 49 shows another example of the closing means of the lid member 1 and is a variation of the examples shown in FIG. 46 to FIG. 48. This example is similar to the previous examples in that it has the locking part 55 and the lock receiving part 56 as the closing means, but the lid member 1 of this example is different in the shape of the protrusion for locking 71 in the lock receiving part 56. Namely, whereas the protrusion for locking 71 of the example explained in FIG. 46 to FIG. 48 has a cross section which has a shape of letter L, the protrusion for locking 71 in the example shown in FIG. 49 has a tip part which is tilted and is to be located higher than the locking part 55 of the lid member 2 for locking when the lid is closed. Also by this arrangement, it is possible to maintain the closed lid state of the lid part 2 and shows the effects previously described.

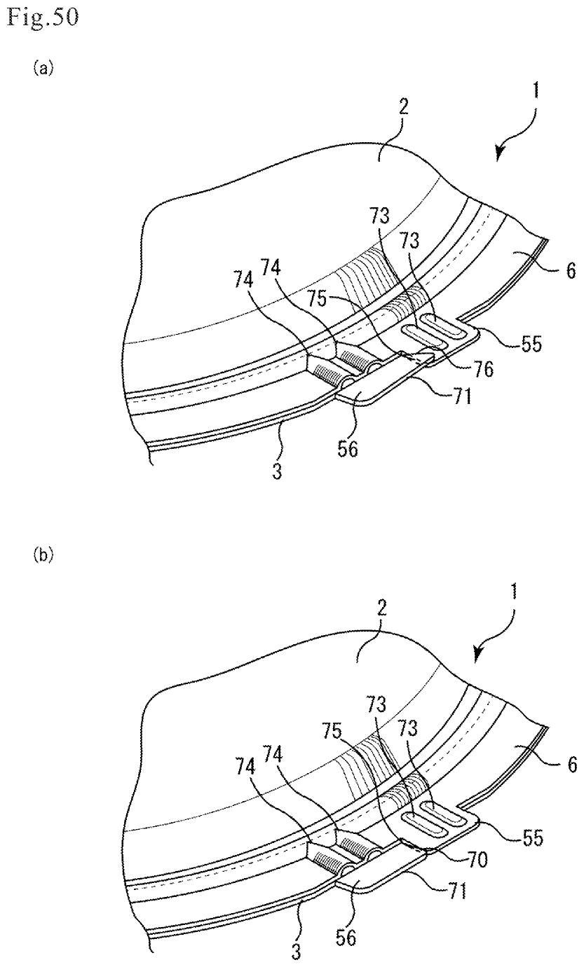

FIG. 50 shows another example of the closing means of the lid member 1 and is a variation of the examples shown in FIG. 46 to FIG. 49. In this example, the lid part 2 is provided with a locking part 55 and the substrate part 3 is provided with a lock receiving part 56. The locking part 55 and the lock receiving part 56 can maintain the closed lid state of the lid part 2 by the contact between the side edge part 75 of the locking part 55 and the side edge part 76 of the lock receiving part 56 which is opposed to and is in contact with the side edge part 75 of the locking part 55. By arranging the locking part 55 and the lock receiving part 56 in this way, the operability of the user is improved while the durability of the lid part 2 against the opening and closing can be imparted.

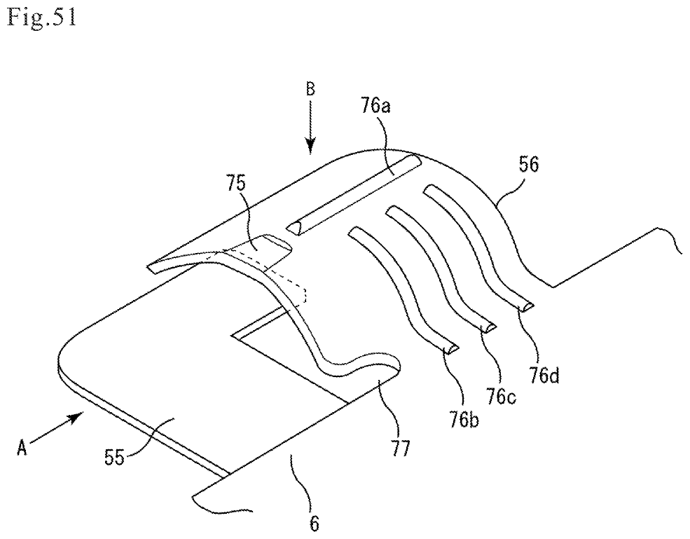

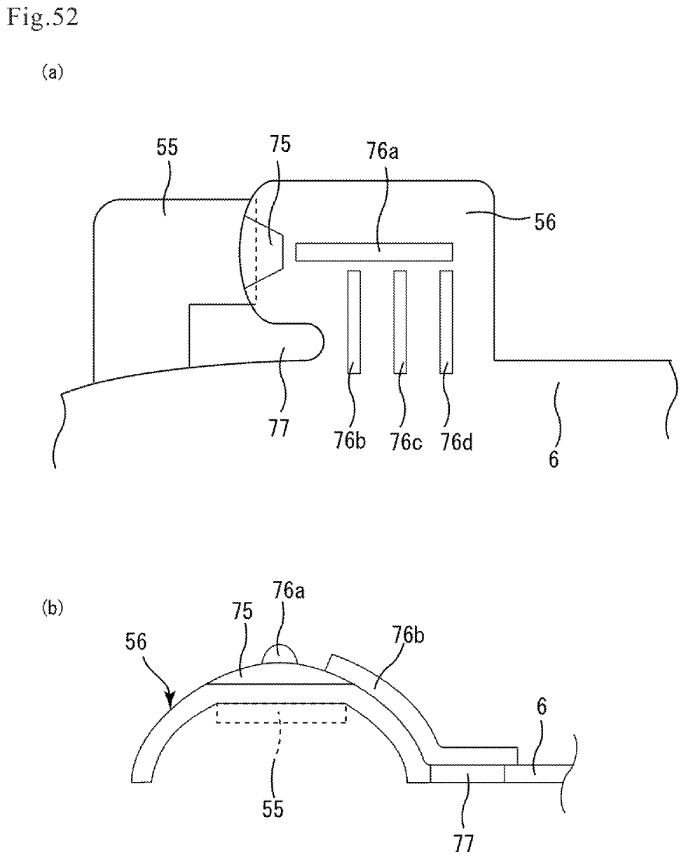

FIG. 51 and FIG. 52 show another example of the closing means of the lid member 1. In this embodiment, the lid part 2 is provided with the locking part 55 and the substrate part 3 is provided with the lock receiving part 56. This lock receiving part 56 extends outwardly from the outer circumference part 6. This extended part has a shape in which the shape seen from the A direction in FIG. 51 (shape shown in FIG. 52(b)) is arch shaped and the shape seen from the B direction in FIG. 51 (shape shown in FIG. 52(a)) is curved only at the tip part. The curved part has an upper part which is a planar part 75. This lock receiving part 56 comprises a recess part 77 formed in the outer circumference part 6 in the form of a bay and the arch-shape part is provided with a plurality of reinforcement ribs 76a, 76b, 76c, 76d. Among these reinforcement ribs, the reinforcement rib 76a is provided for the purpose of reinforcing against the force from the locking part 55 when the lock receiving part 56 is locked with the locking part 55. Since the lock receiving part 56 is curved, the reinforcement ribs 76b, 76c, 76d are provided in order to increase the strength of the part extending from the outer circumference part 6. By providing these reinforcement ribs, the strength of the lock receiving part 56 can be substantially increased and the durability against the repeated opening and closing of the lid part 2 can also be substantially increased. The planar part 75 is provided in order to make it easier to lock by making a surface contact with the locking part 55 when it locks with the locking part 55. In this embodiment, the locking part 55 is formed as a piece member having the shape of letter L, but the shape of the locking part 55 may be freely selected. In the embodiments shown in FIG. 46 to FIG. 52, just by pushing the lid part 2 in the direction of the substrate part 3 to close it, the engagement between the locking part 55 and the lock receiving part 56 may easily occur, and just by pulling the edge of the locking part 55, it can be easily opened.

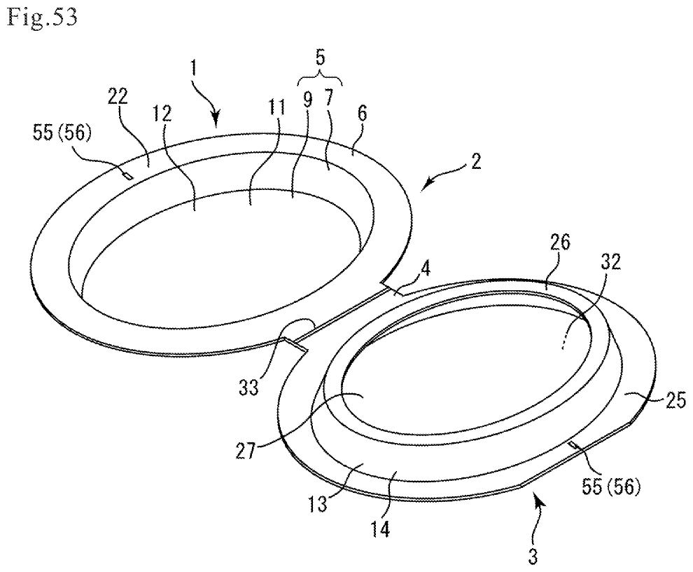

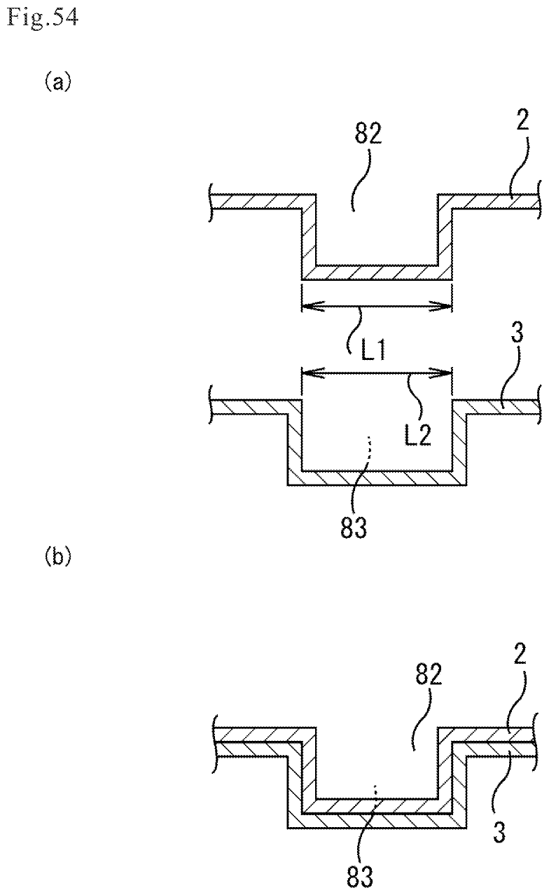

FIG. 53 is a perspective view for explaining another variation of the lid member 1. In this lid member 1, the locking member 55 and the lock receiving member 56 as the closing means are provided on the back side of the outer circumference part 6 of the lid part 2 and the front side of the attaching part 25 of the substrate part 3. Regarding the locking part 55 and the lock receiving part 56, there are e.g. an embodiment wherein the lid part 2 is provided with the locking part 55 and the attaching part 25 of the substrate part 3 is provided with the lock receiving part 56 and an embodiment wherein the back side of the outer circumference part 6 of the lid part 2 is provided with the lock receiving part 56 and the attaching part 25 of the substrate part 3 is provided with the locking part 55. An yet another example of this closing means is described in FIG. 54 and later. diagram representing the closing means in the state where the lid part 2 and the substrate part 3 are open and FIG. 54(b) is a diagram representing the closing means in the state where the lid part 2 and the substrate part 3 are closed. The closing means in the example of FIG. 54 comprises a locking protrusion part 82 provided on the lid part 2 and a locking recess part 83 provided on the substrate part 3, wherein the outer dimension L1 of the locking protrusion part 82 is equal to or greater than the inner dimension L2 of the locking recess part 83, i.e. L1≥L2. By this configuration, when the lid part 2 and the substrate part 3 are closed as shown in FIG. 54(b), when the locking protrusion part 82 of the closing means fits in the locking recess part 83, the locking protrusion part 82 fits in the locking recess part 83 while the locking protrusion part 82 undergoes an elastic deformation in the shrinking direction of the locking protrusion part 82. Hence the locking protrusion part 82 applies force in the direction for expanding the locking recess part 83 by the elastic force when the locking protrusion part 82 is fitted in the locking recess part 83. Accordingly, when the lid is closed, the state in which the locking protrusion part 82 and the locking recess part 83 are fitted to each other can be maintained more easily.

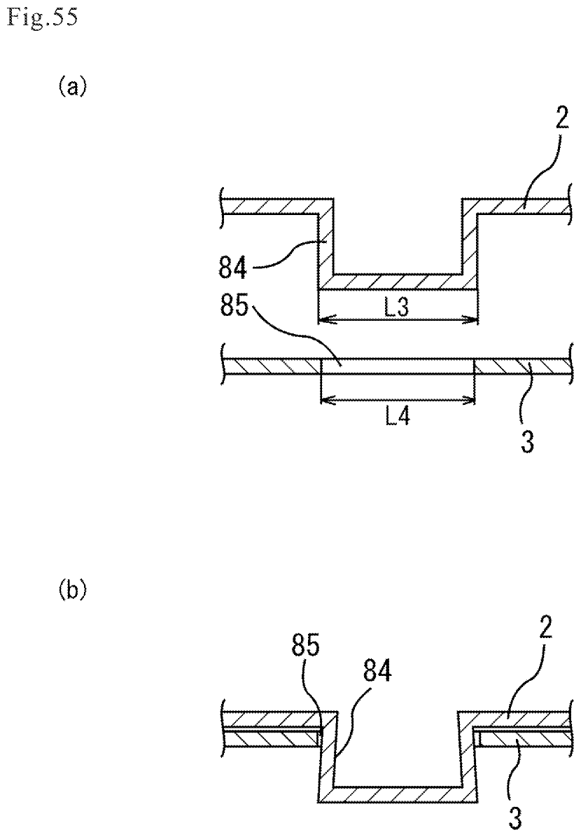

FIG. 55 shows an yet another variation of the lid member. FIG. 55(a) is a diagram representing the closing means in the state where the lid part 2 and the substrate part 3 are open and FIG. 55(b) is a diagram representing the closing means in the state where the lid part 2 and the substrate part 3 are closed. The closing means in the example of FIG. 55 comprises a fitting protrusion part 84 provided on the lid part 2 and a fitting hole part 85 provided on the substrate part 3, wherein the outer dimension L3 of the lower end part of the fitting protrusion part 84 is equal to or greater than the inner dimension L4 of the fitting hole part 85, i.e. L3≥L4. By this configuration, when the lid part 2 and the substrate part 3 are closed as shown in FIG. 55(b), when the fitting protrusion part 84 of the closing means fits in the fitting hole part 85, the fitting protrusion part 84 fits in the fitting hole part 85 while the fitting protrusion part 84 undergoes an elastic deformation in the shrinking direction of the fitting protrusion part 84. Hence the fitting protrusion part 84 applies force in the direction for expanding the fitting hole part 85 by the elastic force when the fitting protrusion part 84 of the closing means is fitted in the fitting hole part 85. Accordingly, when the lid is closed, the state in which the fitting protrusion part 84 and the fitting hole part 85 are fitted to each other can be maintained more easily. The fitting protrusion part 84 may have an outer dimension at the upper end part which is the same as the outer dimension L3 at the lower end part or which is smaller than L3. By this configuration, the fitting into the fitting hole part 85 becomes easier.

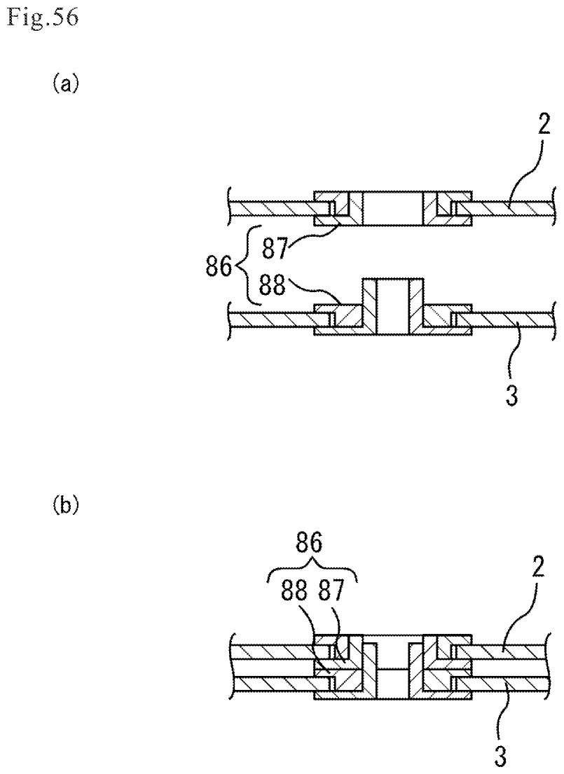

FIG. 56 shows an yet another variation of the lid member 1. FIG. 56(a) is a diagram representing the closing means in the state where the lid part 2 and the substrate part 3 are open and FIG. 56(b) is a diagram representing the closing means in the state where the lid part 2 and the substrate part 3 are closed. In the example of FIG. 56, a hook 86 is used as the closing means. A fixed piece 87 which is one part of the hook 86 is fixed to the lid part 2 and a fixed piece 88 which is the other part of the hook 86 is fixed to the substrate part 3. In FIG. 56, a hook is used wherein the protrusion part provided on the fixed piece 88 is inserted in the hole part provided on the fixed piece 87. However, as long as the state wherein the lid part 2 and the substrate part 3 are closed can be maintained when the lid is closed, the hock is not limited to the example described above. In this way, it is also possible to maintain the state in which the lid part 2 and the substrate part 3 are closed by using a hook 86.

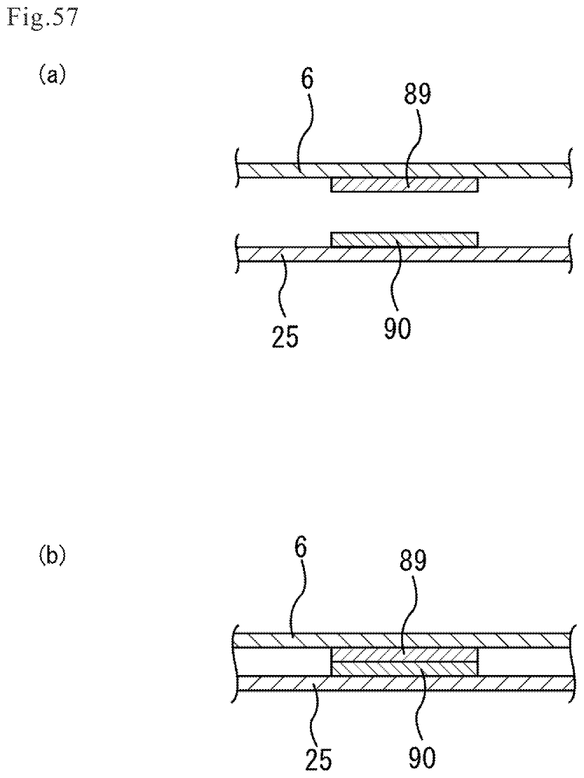

FIG. 57 shows an yet another variation of the lid member 1. FIG. 57(a) is a diagram representing the closing means in the state where the lid part 2 and the substrate part 3 are open and FIG. 57(b) is a diagram representing the closing means in the state where the lid part 2 and the substrate part 3 are closed. In FIG. 57, a hook-and-loop fastener is used as the closing means. A hook-and-loop fastener 89 is fixed to the back side of the outer circumference part 6 of the lid part 2. A hook-and-loop fastener 90 having a structure which can engage with the hook-and-loop fastener 89 is fixed to the location of the front surface of the attaching part 25 of the substrate part 3 which corresponds to the location at which the hook-and-loop fastener 89 is fixed when the lid is closed (predetermined location of the attaching part 25 which opposes the hook-and-loop fastener 89 when the lid is closed). When the lid is closed as shown in FIG. 57(b), the hook-and-loop fastener 89 and the hook-and-loop fastener 90 are joined with each other and can maintain the closed lid state.

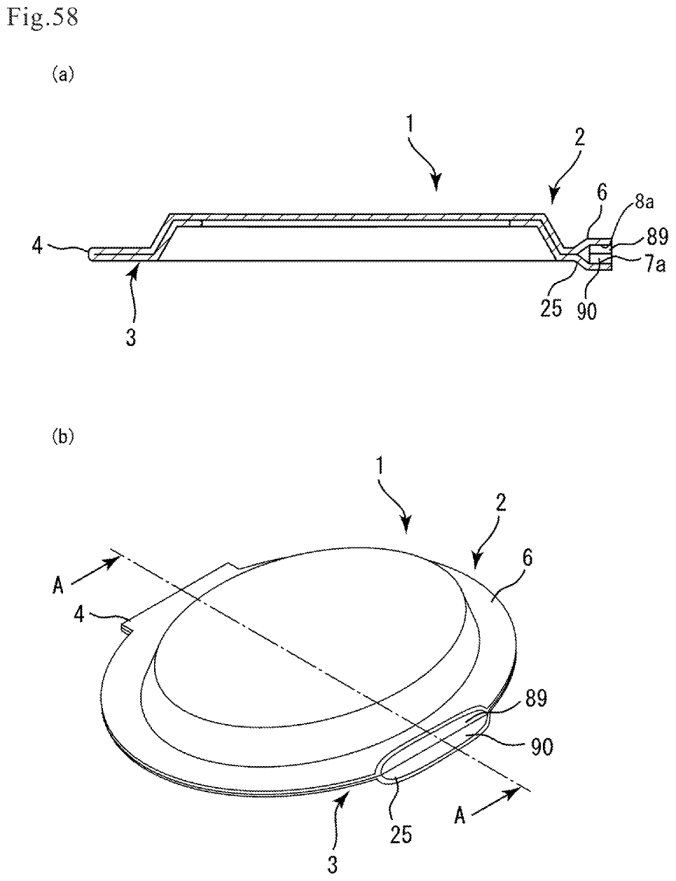

When the hook-and-loop fasteners are used as the closing means, it is possible that only the location in the outer circumference part 6 to which the hook-and-loop fastener 89 is attached is formed as a chevron protruding upwardly and only the location in the attaching part 25 to which the hook-and-loop fastener 90 is attached is formed as a recess denting downwardly, as shown in FIG. 58. By fixing the hook-and-loop fastener 89 to the chevron location (chevron part 91) and fixing the hook-and-loop fasteners 90 to the recessed location (recessed part 92), the hook-and-loop fasteners 89 and the hook-and-loop fasteners 90 may be joined while the front surface 7a of the attaching part 25 and the back surface 8a of the outer circumference part 6 contact each other. In other words, by configuring the attaching part 25 and the outer circumference part 6 as described above, the back surface 8a of the outer circumference part 6 and the back surface of the hook-and-loop fasteners 89 (joining surface) may be arranged to be flush and the back surface 7a of the attaching part 25 and the front surface of the hook-and-loop fasteners 90 (joining surface) may be arranged to be flush, and the hook-and-loop fasteners 89 and the hook-and-loop fasteners 90 may be joined to bring the lid part 2 and the substrate part 3 in the closed state. The location at which the hook-and-loop fastener 89 and the hook-and-loop fastener 90 are joined may take a form in which the joining is easier.

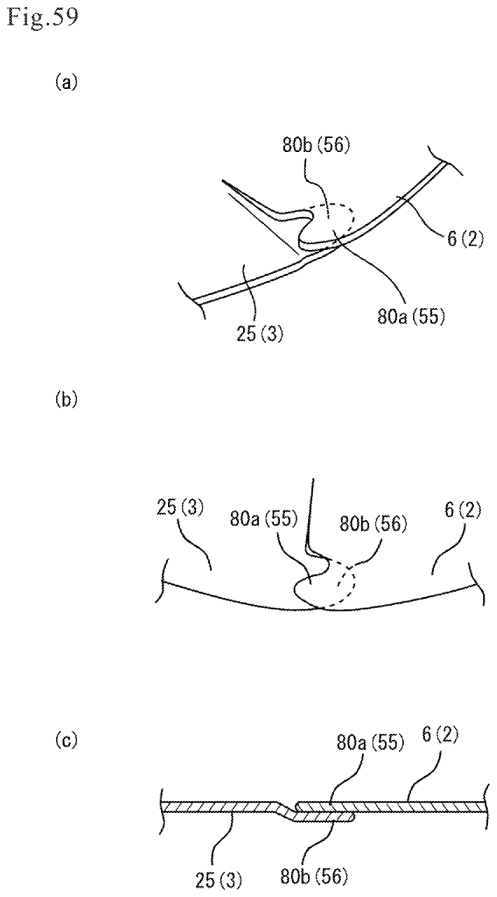

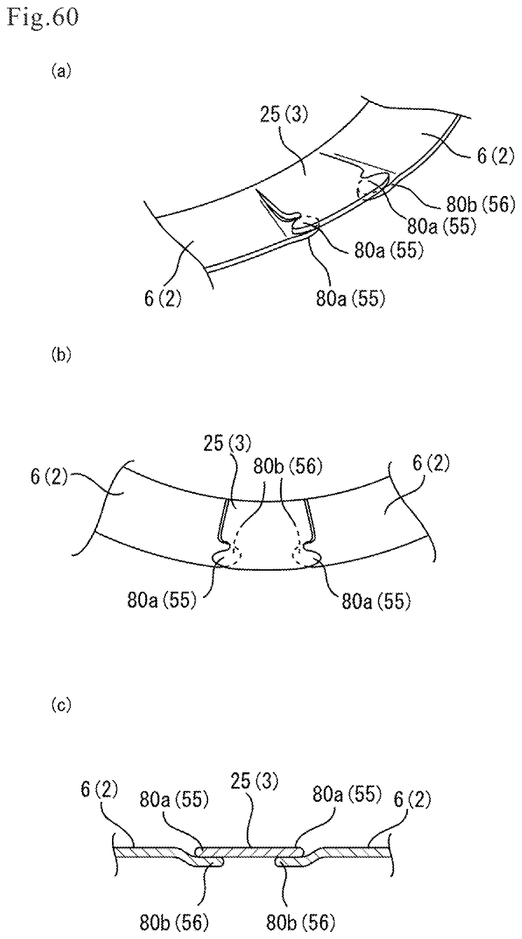

FIG. 59 and FIG. 60 show an example wherein the outer circumference area 6 of the lid part 2 and the attachment part 25 of the substrate part 3 are provided with a locking part 55 and a lock receiving part 56, respectively. In this example, the locking part 55 comprises a locking piece 80a and the lock receiving part 56 comprises a lock receiving piece 80b, wherein the locking piece 80a and the lock receiving piece 80b engage each other so that the function as a closing means can be obtained. The locking piece 80a and the lock receiving piece 80b may be in one location as shown in FIG. 59, or in two locations (plurality of locations) as shown in FIG. 60. Accordingly, in the lid member 1 according to the invention, the closing means is not limited to being provided in the swell part 5 and the surrounding wall 13, but it may be provided in the outer circumference area 6 and the attaching part 25.

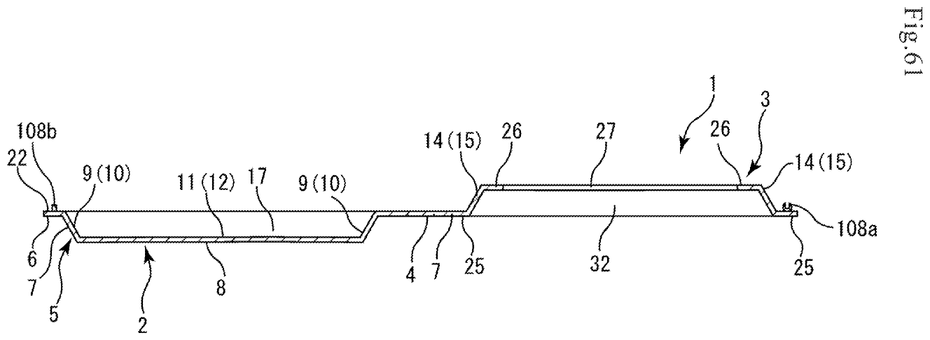

Next, an yet further example of the closing means is described. FIG. 61 is a diagram illustrating the structure of the cross section of another example of the lid member 1 of the present invention. In this example, explanations are given using a first engagement member 108a and a second engagement member 108b as examples of the locking part 55 and the lock receiving part 56. It is noted that the first engagement member 108a and the second engagement member 108b may sometimes be collectively mentioned as an engagement member 108. As shown in FIG. 61, the lid member 1 is provided with the engagement member 108a provided in the lid part 2 and the second engagement member 108b provided at the location which would correspond to the first engagement member 108a in the lid part 2 when the lid is closed. By the engagement of the first engagement member 108a and the second engagement member 108b, the lid part 2 can be fixed and held to the substrate part 3 when the lid is closed.

The engagement member 108 is formed as a structural part in which a plurality of engagement members engage with each other. The structural parts which engage with each other constituting the engagement member 108 is constituted of a combination of parts in which the above-described first engagement member 108a and the second engagement member 108b engage with each other. The first engagement member 180a and the second engagement member 180b may form a structural part wherein the first engagement member 180a and the second engagement member 180b engage with each other or a structural part wherein a part thereof engages with each other. Preferably, the shapes of the first engagement member 180a and the second engagement member 180b are respectively a linear structure like the shape described later. Accordingly, the engagement members 180a, 180b being made of parts constituting a groove engagement part 108d and a ridge engagement part 108c (the definitions of the groove engagement part 108d and the ridge engagement part 108c are given later) is not the only preferred option. It is also preferred that a groove engagement part 108d and a ridge engagement part 108c are respectively provided onto the respective scaffolds which function as the attaching end to the lid part 2 and the substrate part 3, and other structures which include a structure in which the groove engagement part 108d and the ridge engagement part 108c are attached are also preferred. The engagement of the groove engagement part and the ridge engagement part allows maintaining the closed lid state with certainty using a relatively inexpensive material.

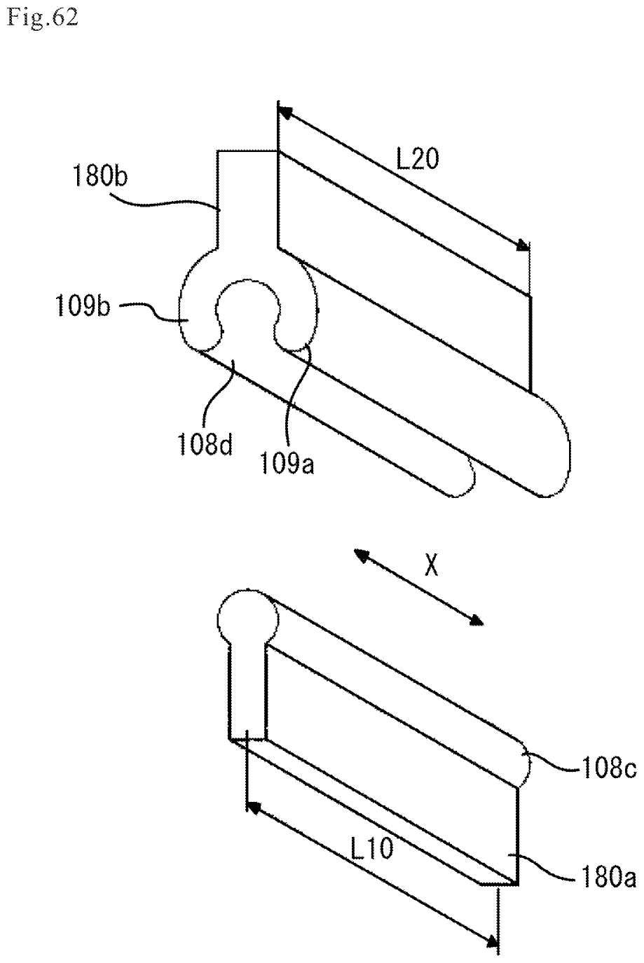

In this way, it is preferable that the engaging members 180a, 180b form a ridge engagement member and a groove engagement part. One engagement member (in the present example the first engagement member 180a) is fixed to the lid part 2 and the other engagement member (in the present example the second engagement member 180b) is fixed to the substrate part 3. The locations at which the first engagement member 180a and the second engagement member 180b are respectively fixed are selected to be the locations at which, when the lid part 2 and the substrate part 3 are closed, the first engagement member 180a and the second engagement member 180b make a linear engagement to fix the lid part 2 and the substrate part 3 to each other. Herein, a linear engagement means an engagement state by the linear engagement parts provided respectively in the first engagement member 180a and the second engagement member 180b. In the example of FIG. 62, the first engagement member 180a is provided with an engagement part formed by the ridge swell part formed at the tip (this engagement part is referred as a ridge engagement part 108c) and the second engagement member 180b is provided with an engagement part formed by the groove part formed at the tip (this engagement part is referred as a groove engagement part 108d). By the engagement of the ridge engagement part 108c and the groove engagement part 108d, a linear engagement of the first engagement member 180a and the second engagement member 180b is formed.

It is preferable that the engaging parts of the first engaging member 180a and the second engaging member 180b have structures which allow sliding with respect to each other. Specifically, in the example of FIG. 62, it is preferable that the ridge engagement part 108c and the groove engagement part 108d have structures which allow sliding with respect to each other. In the cases where the ridge engagement part 108c and the groove engagement part 108d have structures which allow sliding with respect to each other, when the first engaging member 180a and the second engaging member 180b are made to form a linear engagement, the engagement with each other becomes easier. Even when there is a small misalignment in the attaching locations of the engaging members, some warping of the lid part 2 and the substrate part 3 or some warping between the lid part 2 and the substrate part 3, the ridge engagement part 108c and the groove engagement part 108d can suitably slide to compensate for these warping and misalignment and allow the first engaging member 180a and the second engaging member 180b to easily engage with each other, and allow easy opening of the lid part 2.

In this way, by the ridge engagement part 108c and the groove engagement part 108d having a structure in which they can slide with respect to each other, even though the lid member 1 is made of paper material etc. which is less durable than plastic materials etc., even when there is a small misalignment in the engagement position of the first engaging member 180a and the second engaging member 180b, the engagement of the first engaging member 180a and the second engaging member 180b can be realized without the load applied to the lid part 2 and the substrate part 3 upon opening and closure of the lid part 2 becoming too much. Accordingly, the risk of e.g. the lid part 2 and the hinge part 4 being damaged is small even when the opening and closing of the lid part 2 is repeated, and the durability of the lid member 1 becomes high.

The ridge length (length in the longitudinal direction of the ridge) of the ridge engagement part 108c: L10 and the groove length (length in the of the longitudinal direction of the groove) of the groove engagement part 108d: L20 may be the same or different, but these lengths are preferably set to be slidable with respect to each other in the linear direction X of FIG. 62 (longitudinal direction of the ridge and the groove).

Specifically, it is preferable that the ridge length L10 of the ridge engagement part 108c is the same as the groove length L20 of the groove engagement part 108d: L20, or when it is longer, both ends of the groove engagement part 108d are open as shown in FIG. 62.

When the ridge length of the ridge engagement part 108c is smaller than the groove length of the groove engagement part 108d, both ends of the groove engagement part 108d may be open or closed. In both cases, the ridge engagement part 108c and the groove engagement part 108d can slide with respect to each other.

Regarding the degree of the engagement between the ridge engagement part 108c and the groove engagement part 108d, the ridge engagement part 108c and the groove engagement part 108d may be wholly engaged or the ridge engagement part 108c and the groove engagement part 108d may be partly engaged. For example, the ridge engagement part 108c and the groove engagement part 108d may be respectively positioned at different locations in the X direction of FIG. 62 wherein a part of the ridge engagement part 108c engages with the groove engagement part 108d and another part thereof does not engages with the groove engagement part 108d. In this case, the engagement length which a part of the ridge engagement part 108c engages with the groove engagement part 108d may be freely selected. By freely selecting the engagement length, the engagement strength at the engagement part 108, in other words the closing strength when the lid part 2 is closed, can be freely selected.

The second engagement member 108b comprising the ridge engagement part 108c and the first engagement member 108a comprising the groove engagement part 108d may be formed from a continuous strip of a fastener member cut to predetermined lengths. A continuous strip of a fastener member can be easily manufactured by extrusion into a shape corresponding to the ridge engagement part 108c and a shape corresponding to the groove engagement part 108d. The first engagement member 108a and the second engagement member 108b may be attached to the lid part 2 and the substrate part 3 by e.g. heat seal, ultrasonic bonding and hot melt adhesion. If the first engagement member 108a and the second engagement member 108b or parts corresponding to these can be formed as one piece with the lid part 2 and the substrate part 3, they do not have to be formed as separate entities.

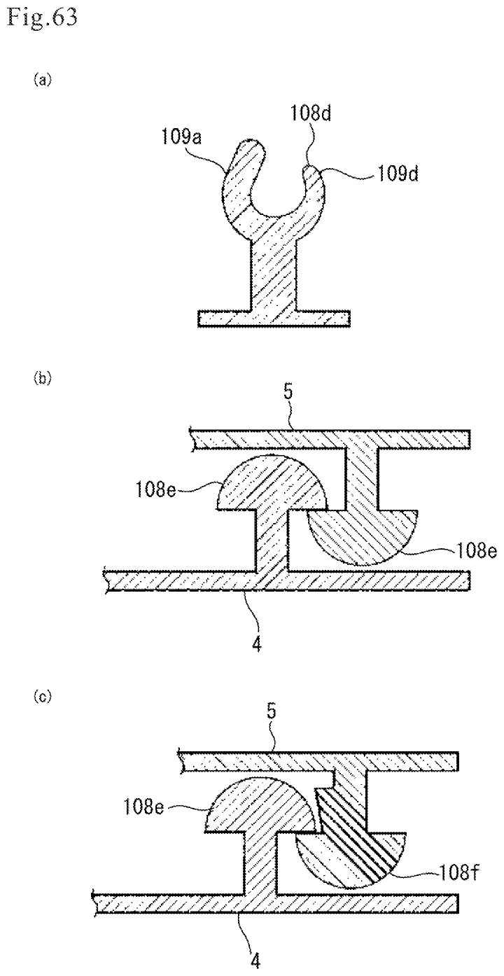

In this example, the first engagement member 180a and the second engagement member 180b are attached such that their linear direction is parallel to the opening and closing axis of the lid part 2. In this case, by configuring the side walls 109a, 109b constituting the groove of the groove engagement part 108d such that, compared to the side wall closer to the hinge part 4 (for example side wall 109a) the other side wall 109b is thinner to make it have a low strength or by configuring the height of the side wall 109b to be lower than the height of the side wall 109a closer to the hinge part 4 as shown in FIG. 63, the engagement between the first engagement member 180a and the second engagement member 180b when the lid is closed and the releasing of the engagement when the lid is opened become easy and thus the opening and closing of the lid part 2 become easy.

Preferably, locations around the part of the lid part 2 to which the first engagement member 180a is attached and around the part of the substrate part 3 to which the second engagement member 180b is attached have been subjected to compression. When such compression has been performed, the risk of the parts to which the first engagement member 180a and the second engagement member 180b are attached being damaged can be reduced.

Preferably, the first engagement member 180a and the second engagement member 180b have a different color from the color of the parts around them, respectively. In this case, the first engagement member 180a and the second engagement member 180b can be made to visually stand out, which allows the user to open the lid part 2 of the lid member 1 easily. Further, when a misalignment occurs at the engagement position between the first engagement member 180a and the second engagement member 180b, it becomes possible to visually determine the correct engagement position.

The first engagement member 180a and the second engagement member 180b may be colored by one color or different colors. Each of the first engagement member 180a and the second engagement member 180b may be colored by one color or two or more colors. For example, the ridge engagement part 108c of the first engagement member 180a and the attaching base (not shown) of the first engagement member 180a to the lid part 2 may be colored with different colors or the groove engagement part 108d of the second engagement member 180b and the attaching base (not shown) of the second engagement member 180b to the substrate part 3 may be colored with different colors.

It is preferred that a sunken part (not shown) is provided on at least one of the locations around the attaching part of the first engagement member 180a and the locations around the attaching part of the second engagement member 180b. When the sunken part is formed on the substrate part 3, it is formed more outwardly than the surrounding wall 16. When the sunken part is formed on the lid part 2, it is formed more outwardly than the swell part 5. The sunken part is arranged such that a gap is formed between the lid part 2 and the substrate part 3 when the lid is closed. By the formation of such sunken part, a risk of the first engagement member 180a and the second engagement member 180b becoming a physical hindrance to restrict the closing of the lid part 2 of the lid member 1 can be prevented.

In this example, explanations have been given for an embodiment wherein the first engagement member 180a and the second engagement member 180b are attached such that the linear direction (X direction in FIG. 62) is parallel to the direction of the opening and closing axis (hinge part 4) of the lid part 2. However, the first engagement member 180a and the second engagement member 180b may be attached such that the linear direction (X direction in FIG. 62) is perpendicular to the direction of the opening and closing axis (hinge part 4) of the lid part 2. By attaching in this way, the lid part 2 can be prevented from twisting sideways when the lid is closed and the sealability when the lid is closed can be improved.

In the example described above, explanations have been given for a lid member 1 wherein a first engagement member 180a comprising a groove engagement part 108d is provided on the lid part 2 and a second engagement member 180b comprising a ridge engagement part 108c is provided on the substrate part 3. However, the second engagement member 180b comprising a ridge engagement part 108c may be provided on the lid part 2 and the first engagement member 180a comprising a groove engagement part 108d may be provided on the substrate part 3. The first engagement member 108a and the second engagement member 108b are not limited to one pair but a plurality of pairs may also be provided. In this case, the lid part 2 may be provided with a first engagement member 180a comprising a ridge engagement part 108c and a second engagement member 180b comprising a groove engagement part 108d and the substrate part 3 may be provided with a second engagement member 180b comprising a groove engagement part 108d and a first engagement member 180a comprising a ridge engagement part 108c at locations where they respectively engage with them. Further, the combination of the first engagement member 180a and the second engagement member 180b is not limited to the combination of the ridge engagement part 108c and the groove engagement part 108d, but an engagement member comprising an anchor-shaped ridge engagement part 108e as shown in FIG. 63 may be combined. By arranging the anchor-shaped ridge engagement parts 108e, 108e to engage with each other instead of the first engagement member 180a and the second engagement member 180b, the engaged state of the respective engagement members is achieved. Also, as shown in FIG. 63, the engagement member comprising an anchor-shaped ridge engagement part 108e may be combined with an engagement member comprising a ridge engagement part 108f having a different shape from the ridge engagement part 108e.

As the method for attaching the various types of engagement members to the lid part 2 and the substrate part 3, when a continuous strip of a fastener member is used to attach the first engagement member 180a to the lid part 2 and the second engagement member 180b to the substrate part 3, the method may involve e.g. holding the lid member between an anvil and a horn not shown and attaching the first engagement member 180a and the second engagement member 180b using the continuous strip of a fastener member. The anvil is provided with grooves through which the continuous strip of a fastener member can be inserted at the attaching location at which the second engagement member 180b is attached to the substrate part 3 and at the attaching location at which the first engagement member 180a is attached to the lid part 2.

The continuous strip of a fastener member is inserted in the groove and cut into a predetermined length by a cutting tool. The engagement member which has been cut is pressed against the lid member and is joined to the lid member 1 by an ultrasonic wave supplied via the horn. In this way, by joining the first engagement member 180a and the second engagement member 180b by ultrasonic wave, the continuous strip of a fastener member may be attached to the lid part 2 and the substrate part 3 while the continuous zipper member is cut, allowing the engagement members to be attached to the lid part 2 and the substrate part 3 efficiently.

In this example, explanations have been given wherein a continuous strip of a fastener member is used as the engagement member for fixing the lid part 2 and the substrate part 3 in a lid member 1 in which the lid part 2 is arranged to be openable and closable with respect to the substrate part 3 via the hinge part 4. However, the continuous strip of a fastener member may be used not only as an engagement member for the lid member 1 but also as a fixing member for fixing to each other a plurality of members which can retain their shapes such as members made of paper materials. In this case, the plurality of members may be connected by the hinge part 4 or may not comprise the hinge part 4.

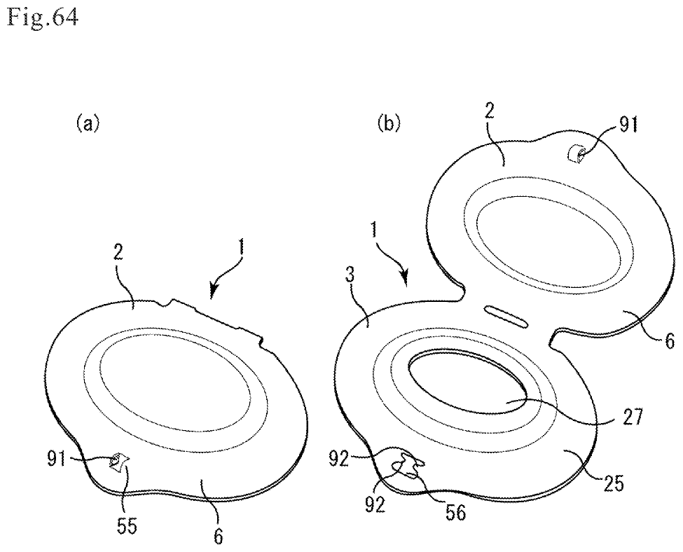

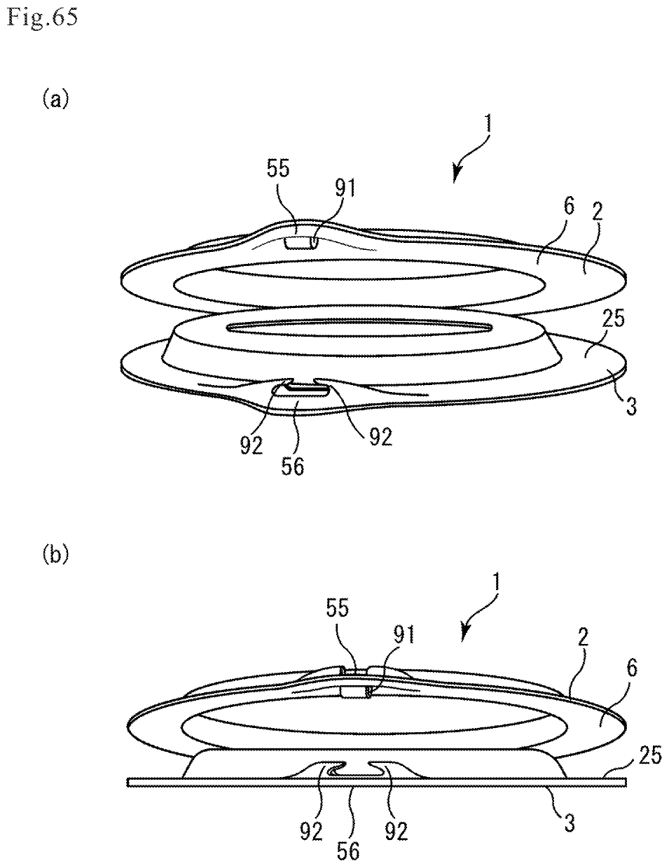

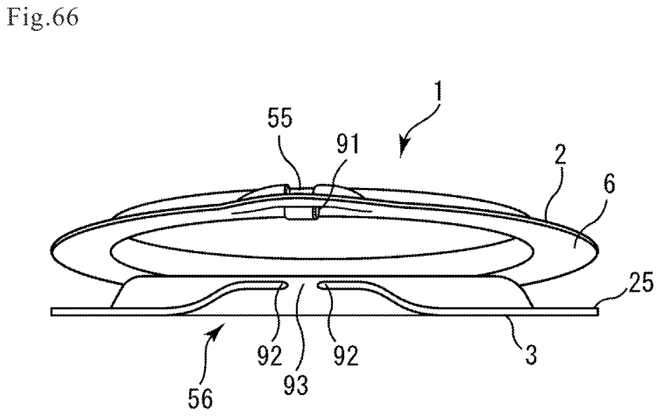

FIG. 64 to FIG. 67 show another embodiment of the closing means in the lid member 1. In this closing means, the lid part is provided with an engagement part 55 and the substrate part 3 is provided with an engagement receiving part 56. The engagement part 55 is provided in the outer circumference part 6 of the lid part 2 to protrude to the back side of the outer circumference part 6, and locking holes 91 are provided at the respective locations opposing these protruded pieces. These locking holes 91 are formed to have such a size that the engagement receiving pieces 92 of the engagement receiving part 56 can enter therein for locking. The substrate part 3 is provided with a engagement receiving part 56. In this embodiment, the location at which the engagement receiving part 56 is formed is arranged such that the attaching part 25 generally rises and at the top part of which is provided with a hole 93. By the formation of the hole, the engagement receiving piece 92 described above is formed.

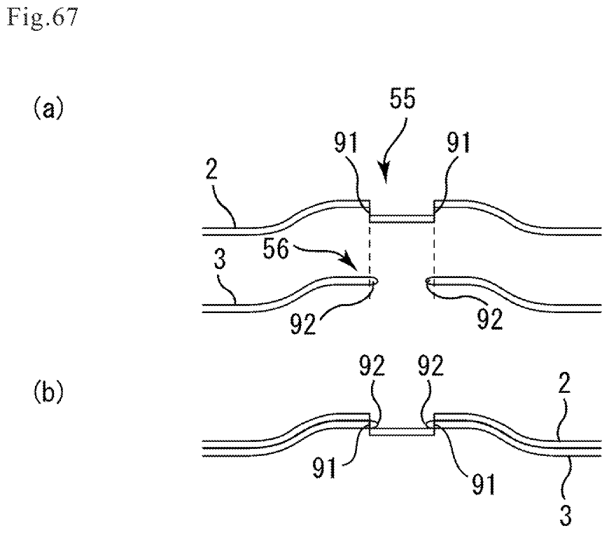

In this construction, when the lid part 2 rotates in the direction of closing the lid, as also shown in FIG. 67(a), the gap between the opposing lock receiving pieces 92 in the engagement receiving part 56 becomes wider than the width of the engagement part 55 in which the locking holes 91 are formed. Accordingly, when the lid part 2 is closed with respect to the substrate part 3, the lock receiving part 92 enters the locking hole 91 and the locking part 55 and the lock receiving part 56 are engaged, resulting in the locked state as shown in FIG. 67(b). By arranging the closing means in this way, it can be easily formed when the lid member 1 is produced and it can be produced at a low cost. Also, regarding the operation of the lid member 1, the opening and closing of the lid part 2 can be performed by an easy operation and the operability is improved.

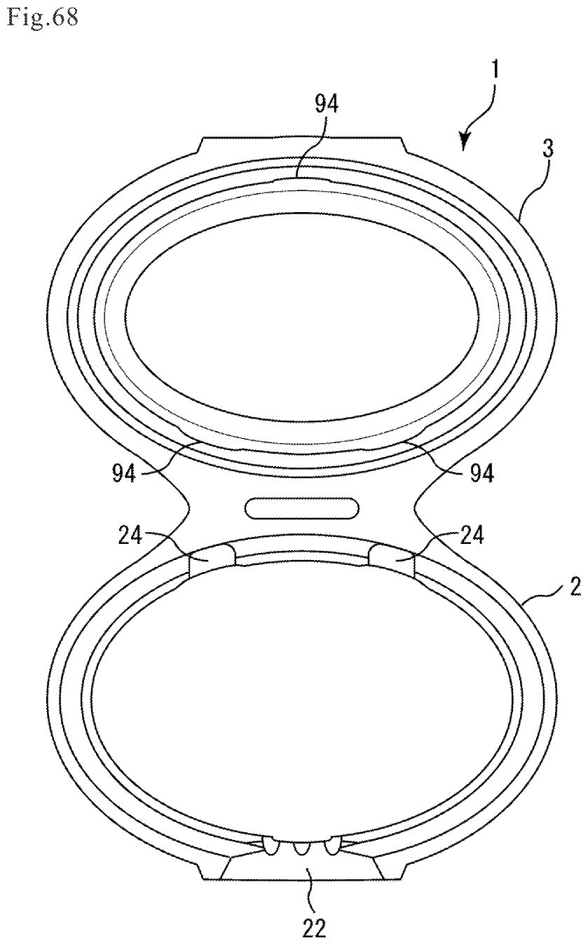

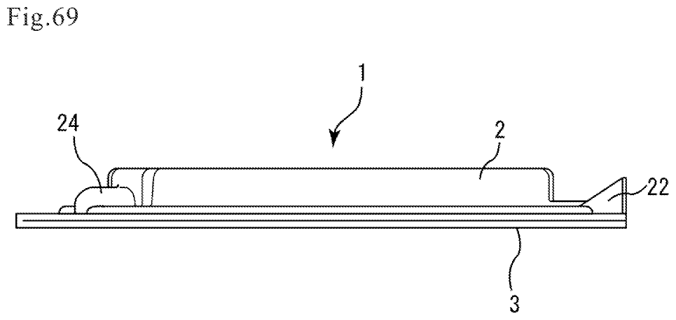

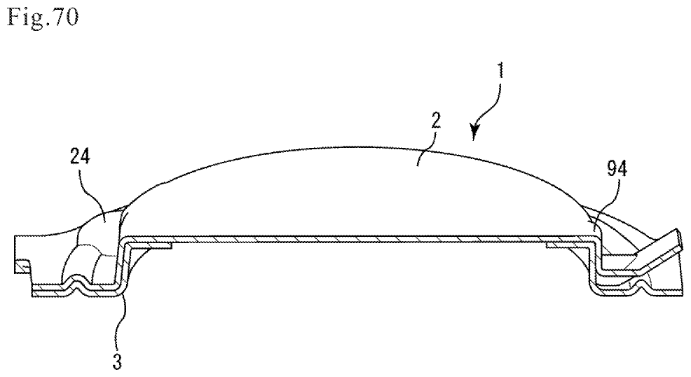

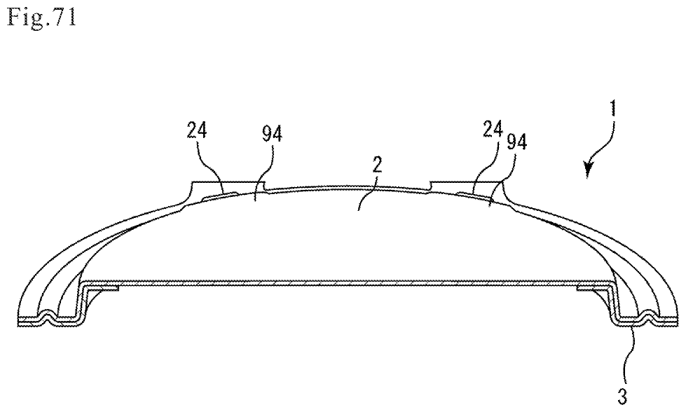

FIG. 68 to FIG. 71 show another embodiment of the lid member. This lid member 1 is provided with protruded parts 94 protruding outwardly from three locations of the substrate part 3. Two of these protruded parts 94 are provided close to the hinge part 4 and one is provided far from the hinge part 4, but their number and locations are not particularly limited. By forming these protruded parts 94 close to the hinge part 4, slipping in the depth direction between the swell part 5 and the surrounding wall 13 (direction between the substrate edge provided with the hinge part and the tip provided with the operating part 22) can be prevented when the lid part 2 is closed. The protruded parts 24 provided in the lid part 2 has a function as a support when stacking the lid members 1.

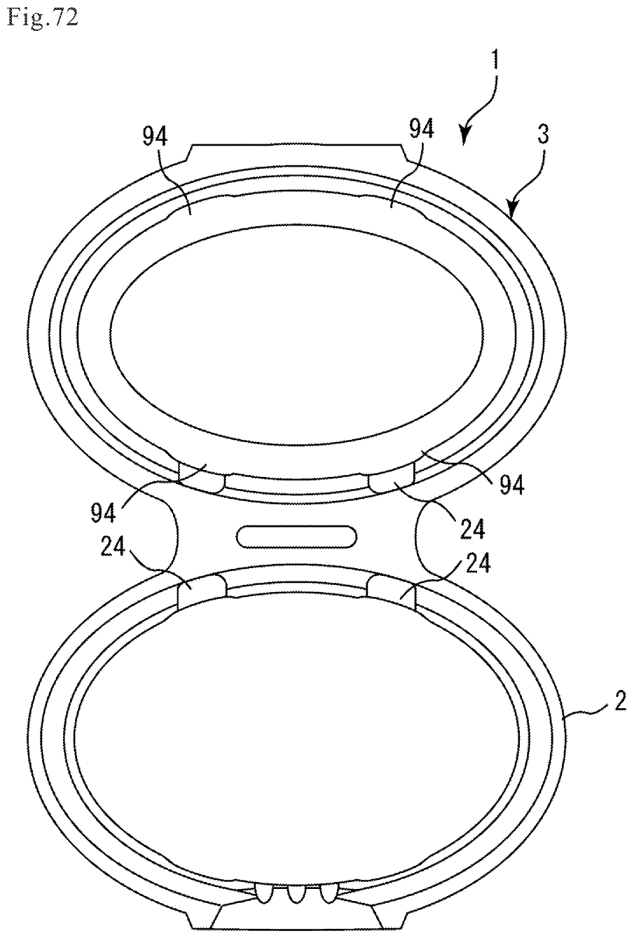

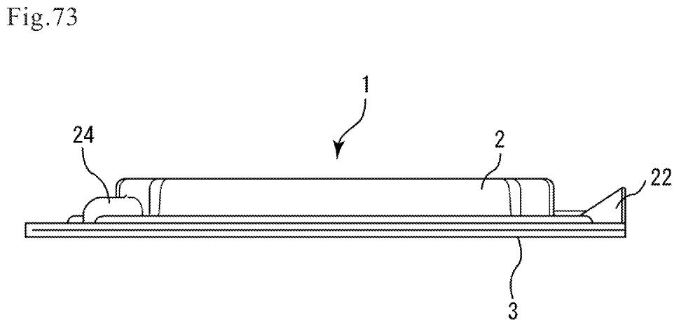

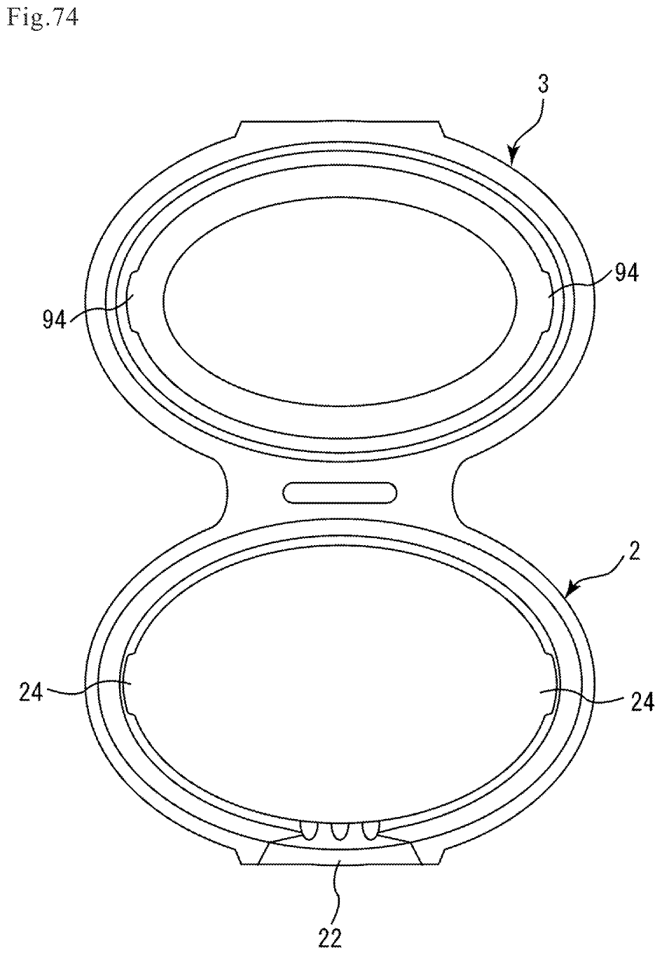

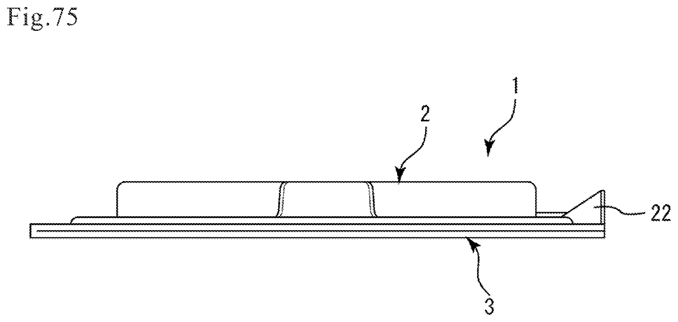

FIG. 72 and FIG. 73 show another embodiment of the lid member. This lid member 1 is provided with protruded parts 94 protruding from four locations of the substrate part 3. Two of these protruded parts 94 are provided close to the hinge part 4 and two are provided far from the hinge part 4. This can prevent with more certainty the above-mentioned slipping problem in the depth direction between the swell part 5 of the lid part 2 and the surrounding wall 13 when the lid part 2 is closed and the sealability when the lid is closed can be further improved. The locations of the protruded parts 94 can be freely selected. For example, the protruded parts 94 can be positioned in an opposing manner at locations in the lid member 1 where the opposing distance is the largest. The above-mentioned slipping problem can be solved also by forming them in such locations.

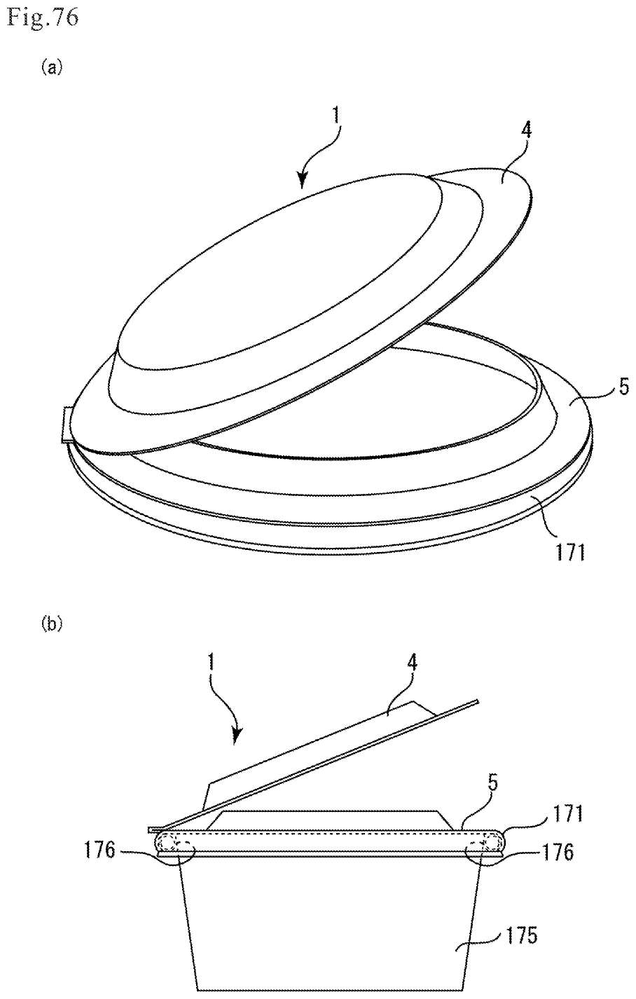

Next, another example of the lid member of the present invention is illustrated using FIG. 76. The lid member 1 shown in FIG. 76 is arranged to be used by attaching to the opening part of the container 175, and the substrate part 3 is provided with a receiving part 171. This receiving part 171 extends below the attaching part 25 and can be used as the lid member of the container 175. When the lid member 1 is used as the lid member of the container 175, the inner part 176 formed inside the receiving part 171 may be shaped such that it engages with the upper end part of the container 175, for example a curled part, such that it can be used as the lid member of the container 175.

As mentioned above, the above description in the present specification shows examples of the lid member according to the present invention. Accordingly, they can be freely modified within the scope which does not depart from the gist of the invention.

### REFERENCE SIGNS LIST

1 lid member
2 lid part
3 substrate part
4 hinge part
5 swell part
6 outer circumference part
7 side wall part
13 surrounding wall
14 outer wall
16 contact part
18 first protrusion part
19 second protrusion part
25 attaching part
26 flange part
27 outlet
33 folding part
37 self adhesion layer

1. A lid member to be provided at an opening part of a package for preventing drying of contents accommodated in the package, wherein
the lid member comprises a substrate part and a lid part configured to be openable and closable with respect to the substrate part, made of a paper material, wherein the substrate part comprises
an attaching part for attaching to the package,
a standing wall standing from the attaching part and
an outlet comprising an opening surrounded by the standing wall, arranged for the contents to be taken out via the opening part,
wherein the lid part is configured such that, when the lid is closed, a contact part is formed between an inner wall of the lid part and an outer wall of the standing wall to close the outlet.

2. A lid member to be provided at an opening part of a package for preventing drying of contents accommodated in the package, wherein
the lid member comprises a substrate part and a lid part configured to be openable and closable with respect to the substrate part, made of a paper material,
wherein the substrate part comprises
an attaching part for attaching to the package,
a standing wall standing from the attaching part,
an outlet comprising an opening surrounded by the standing wall, located at a higher location than the opening part and
a part to be pressed positioned at an upper edge of the standing wall, arranged such that, when the lid is closed, the part to be pressed abuts against and is pressed by an inner surface of the lid part,
wherein when the lid is closed, the lid part is in contact with the part to be pressed,
while the closed lid state is maintained, the lid part covers and closes the outlet while applying a pressing force onto the part to be pressed,
when the retention of the closed state is removed, the pressing force by the lid part to the part to be pressed is removed and a force to open the lid part is applied from the part to be pressed onto the lid part

3. The lid member according to claim 2, wherein a contact part is formed between an inner wall of the lid part and an outer wall of the standing wall, such that the lid part closes the outlet.

4. The lid member according claim 1, wherein the lid part comprises a swell part swelling outwardly from the lid part and
a contact part is formed between an inner surface of a side wall of the swell part and an outer surface of the standing wall, such that the lid part closes the outlet.

5. The lid member according to claim 4, wherein the inner surface of the side wall of the swell part has a form which corresponds to the outer surface of the standing wall when the lid is closed.

6. The lid member according to claim 4, wherein the standing wall and the side wall of the swell part are tapered towards the upper direction.

7. The lid member according to claim 2, wherein the part to be pressed comprises a projecting part made of an upper end of the standing wall curved towards the outlet.

8. The lid member according to claim 2, wherein the part to be pressed comprises a flange part projecting from an upper end part of the standing wall towards the outlet.

9. The lid member according to claim 8, wherein the flange part is tilted.

10. The lid member according to claim 4, wherein the swell part comprises a top wall connected to the standing side wall part and
the top wall is recessed from the peripheral part connected to the side wall part towards the inner direction.

11. The lid member according to claim 1, comprising a closing means for maintaining the closed lid state between the lid part and the substrate part.

12. The lid member according to claim 11, wherein the closing means is provided between an outer wall of the standing wall and an inner wall of the swell part.

13. The lid member according to claim 1, comprising a closing means by a friction stress of the contact part between the lid part and the standing wall, for maintaining the closed lid state between the substrate part and the lid part.

14. A method for manufacturing a lid member to be provided at an opening part of a package for preventing drying of contents accommodated in the package, comprising a substrate part and a lid part which is openable and closable with respect to the substrate part, made of a paper material, wherein the process comprises:
step of punching, from a raw material comprising a paper material, a lid member forming body for making at least the lid part and the substrate part,
a pressing step of press-forming at least one of a lid part forming part which is to become the lid part and a substrate forming part which is to become the substrate part in the lid member,
wherein the pressing step involves deep draw forming the part of the lid member forming body located more inwardly than the peripheral part of the lid member forming body in a state in which the peripheral part of the lid member forming body is supported in a state in which it can be held but cannot be fixed.

15. The method for manufacturing the lid member according to claim 14, wherein the lid member forming body comprises a hinge part forming body between the lid part forming part and the substrate forming part,
wherein the pressing step is performed after a folding part is formed in the hinge part forming body.

16. The method for manufacturing the lid member according to claim 14, wherein the pressing step is performed after a moisturizing treatment is performed on the raw material.

17. The method for manufacturing the lid member according to claim 14, wherein a closing means for maintaining a state in which the lid part is closed with respect to the substrate part is formed before the pressing step.

18. The method for manufacturing the lid member according to claim 14, wherein after a lid member forming body provided with an opening as an outlet is formed, waterproofing treatment is performed on at least the edge part of the outlet of the lid member forming body in a state in which a plurality of said forming body are stacked.
